(19) United States
(12) Patent Application Publication
(10) Pub. No.: US 2026/0290100 A1
(43) Pub. Date: Sep. 24, 2026

(54) SYSTEM AND METHOD FOR PROVISIONING A FACIAL RECOGNITION-BASED SYSTEM HAVING VISIBLE LIGHT AND INFRARED DETECTION

(71) Applicant: Alcatraz AI, Inc., Cupertino, CA (US)

(72) Inventors: Pavel Zlatanov, Sofia (BG); Maxim Taralov, Sofia (BG); Robert Englin, Redwood City, CA (US); Ventseslav Gaydarzhiev, Bell Canyon, CA (US)

(21) Appl. No.: 19/365,795

(22) Filed: Oct. 22, 2025

Related U.S. Application Data
(63) Continuation-in-part of application No. 18/947,693, filed on Nov. 14, 2024.
Application No. 18/947,693 is a continuation of application No. 18/787,743, filed on Jul. 29, 2024, now abandoned.
Application No. 18/787,743 is a continuation of application No. 18/634,759, filed on Apr. 12, 2024, now abandoned.
Application No. 18/634,759 is a continuation of application No. 18/415,355, filed on Jan. 17, 2024, now abandoned.
Application No. 18/415,355 is a continuation of application No. 18/196,729, filed on May 12, 2023, now abandoned.
Application No. 18/196,729 is a continuation of application No. 18/101,296, filed on Jan. 25, 2023, now abandoned.
Application No. 18/101,296 is a continuation of application No. 17/948,067, filed on Sep. 19, 2022, now abandoned.
Application No. 17/948,067 is a continuation of application No. 16/815,841, filed on Mar. 11, 2020, now abandoned.

(51) Int. Cl. G07C 9/25; G06F 21/32; G06V 40/16

(52) U.S. Cl. CPC G07C 9/257; G06F 21/32; G06V 40/169; G06V 40/172

(57) ABSTRACT

Systems and methods are provided for controlling access to a building or other restricted physical spaces using at least a facial recognition module. The facial recognition module comprises visible light and infrared detection. In some embodiments, methods are provided for permitting potential entrants to choose whether or not to authorize facial recognition to be performed on them, without compromising overall security.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

Controlling access to buildings is an old problem. Castles once had drawbridges and moats. Guards, armed or otherwise, have been posted at doors for centuries. These approaches can be effective, but come at a significant cost. As with most other forms of security, there were tradeoffs between efficiency (ease of ingress and egress) and security.

In the context of a modern business that may have thousands of employees, more sophisticated tools are required. For several decades, many businesses have used badge-based access control systems. The least sophisticated of these still rely on a human to check for and make decisions about whether to admit or deny based on a visual appraisal of basic badge, generally by checking the “headshot” photograph on the badge against the physical appearance of the person wearing it. This approach obviously requires a human guard at each entrance.

More technically sophisticated access control systems use electronically lockable doors, and some form of machine-readable coding on the badges carried by employees, each of which generally contains a unique identifier for each badge. Such coding may take the form of a magnetic strip, a chip, or another form of RFID or other technique for encoding a unique identifier. When an employee (or other person with an ID) attempts to enter a controlled-access building (or a limited-access area within a building), the coding on the badge is read by the appropriate equipment (such as a “swipeable” card slot, or an antenna), and the unique identifier associated with the badge is generally transmitted to an access control panel that contains, at minimum, a database of badge identifiers. If the badge being used is associated with permission to access the space controlled by the electronic lock, the access control panel sends an “unlock” signal to that door to enable to badge holder to enter; if not, the door does not unlock. (Additional steps might also be taken, such as triggering an alert.)

Badge-based systems are widely used, but have a number of drawbacks. When used alone (an approach widely characterized as single-factor authentication), they can be compromised by cards that have been stolen, borrowed or counterfeited. They also create the opportunity for a security risk known as “tailgating”. People tend to reflexively make polite gestures like holding a door open for those walking behind them. Bad actors may use such instincts as a means to circumvent security systems. Such exploits are so common that they have a name: deception to manipulate individuals into giving others access to or divulging confidential or personal information that may be used for fraudulent purposes is generally known as “social engineering.” Tailgating, a specific and physical form of social engineering, is difficult to prevent with such access control systems. (Tailgating may also include the situation in which an unauthorized entrant follows a permitted entrant into a space without the permitted entrant even noticing.) Posting a human guard at each access point reduces, but does not eliminate the risk. It also substantially increases the cost of the security regime—in terms of the financial cost of the guards, of course, but also the frictional effects of forcing each potential building entrant to interact with the guards. That requirement slows the process, and can cause significant queuing at peak times of day, resulting in annoyed workers and lost productivity.

An alternative approach that has been used to a limited extent is biometric verification. Technologies like fingerprint readers and iris scanners have been deployed in high-security environments such as data centers, secret government facilities, etc. Even where such technologies offer strong security, they have significant drawbacks that generally make them undesirable for broader applications. In addition to the costs of the hardware required to scan eyeballs and/or read fingerprints, the hardware to enroll people in the system and the computer systems necessary to store, process and make decisions based on the collected biometric information, both systems require that each person seeking entrance to the access-controlled area have a significant, time-consuming interaction with that system, including the first enrollment phase, which may be very long. This may be an acceptable tradeoff for a highly secure facility accessible to a small number of people. But the costs are likely too high for higher-volume applications.

An increasingly prevalent form of biometric verification is facial recognition. Facial recognition generally uses one or more digital cameras or sensors to capture one or more images, which are used to generate a digital file containing data about a person's face. Image processing software uses this data to perform analysis to detect facial features and to determine attributes such as distances between different facial features, description of those facial features and the shape of the head. Algorithms running on one or more processors then use this data to compare the captured face to one or more faces that have been previously analyzed to estimate the probability that they are the same person.

Facial recognition is now being used as a security method for some smartphones.

The quality of cameras or sensors and the speed of the processors deployed in phones have rapidly improved, enabling early forms of image recognition. However, many early approaches could be fooled by, for example, holding a photograph of a person in front of the camera. In an attempt to compensate, some newer smartphone-based recognition systems require the user to perform a task such as change facial expression or move or change orientation to provide evidence that what is being observed is a living person and not just a picture.

Another form of facial recognition is to generate a depth map based on stereoscopic vision, relying on the differences in two simultaneous images captured by two different cameras or sensors separated by a distance.

Some more recent devices employ a more sophisticated approach called “structured light”. Structured light is the process of projecting a known pattern, such as a grid of lines or dots onto the object, such as a face, to be analyzed. Such patterns may be projected with a laser, which could use visible light, infrared light, or another signal. A camera or sensor in turn records the shape of the grid as seen on the surface of the object. When such a grid is projected onto a flat surface perpendicular to the projector, the grid is unaltered. But when such a grid is projected onto more complex shapes, the deformations in the grid created by the uneven surfaces allow machine vision systems to calculate the distance of those grid points from each other in 3 dimensions, and thus to model the shape of the object.

Measuring the time of flight is another way to generate a depth image with a projector and sensor. This technology is based on the fact that the speed of light is a constant. The emitted light travels to an object and is reflected back to the sensor. Measuring the time in between the projector emission and reception of the light back on the sensor allow an estimate of the traveled distance.

Thus, for example, one popular smartphone that uses this approach, the iPhone X from Apple, may both measure time of flight for some purposes, and project thousands of points using an infrared laser projector, allowing it to read the resulting grid as overlaid on a face using an infrared sensor.

This is a relatively simple use case for facial recognition in several ways. First, high-end smartphones now have high-resolution cameras built in, as well as processing power and memory that only expensive computer workstations featured only a few years ago. A few smartphones even include infrared emitters and sensors. Users also tend to help the process by holding the phone fairly close to their faces, with the camera and/or other sensors pointed in the proper direction. And perhaps most important, in the ordinary case, the number of entries in the database of faces authorized, and thus stored for comparison purposes, is one. Together, these factors simplify and speed up the task.

There have been attempts to apply facial recognition to access control. However, there are a number of challenges in this context. The library of faces of approved people can number in the thousands or more. Matching a new image to the correct identity can require significant processing power and system memory. Determining a reasonable degree of certainty that the new image of a person seeking entry is not a match with one of the people already in the database is also computationally expensive. Because those resources have until recently been quite expensive, such systems have generally required that the sensing units located at access points be networked to a central computer. Such topologies can be expensive to install and maintain. They also have tended to introduce sufficient lag time that queuing can become in issue.

Existing systems also tend to require that a person seeking admittance stand still in a specific location and look directly toward a specific location, usually at one or more cameras or sensors. They also tend to work only under controlled lighting conditions.

Current solutions in the secure access control industry can be spoofed or require human interaction. Many methods are currently available, including, but not limited to badging, iris scan, fingerprint scan, PIN code or phone access using Bluetooth or NFC. Some of those solutions are very secure but require additional interactions from the user, while other lacks security at its core.

In contrast, what is proposed below enables instantly secure, spoof-free authentication based on 3D facial reconstruction and AI. The tech is envisioned to replace the ubiquitous badge readers by the doors and eventually make its place to other areas like integrating into medical devices or ATM one/two factor authentication. It is a fast and frictionless method of identifying securely a user with no additional interaction. In some embodiments, Deep learning is used to train for each new user so the experience is transparent.

Thus there is a need for a building security system that maximizes security (by preventing or substantially reducing the risk of improper entry), while minimizing cost (by reducing the need for expensive human guards and reducing friction and waiting for those who are desired entrants to the building). Ideally, such a system would be easily integrated into an existing building security system.

With the widespread adoption of facial recognition systems, some people have concerns about the potential loss of privacy such systems can enable. There is therefore value in providing systems that can generally enhance security through the use of facial recognition while affording sensitive users with alternate methods of authentication that do not require facial recognition.

### SUMMARY OF THE INVENTION

In one embodiment, the invention comprises a compact module that includes a visible light (RGB) camera, a plurality of infrared sensors, an infrared projector, a processor, and memory. It also includes means for communicating with an access control panel.

In another embodiment, the invention also comprises means for directly controlling access by transmitting a signal to lock or unlock a door.

In another embodiment, the invention also comprises means for autonomous operation of a module without communication with a remote server.

In another embodiment the invention also comprises a badge reader or wireless means of reading a badge or token, such as by using Bluetooth.

In another embodiment, the invention enables single or multiple-factor authentication.

In another embodiment, the invention comprises methods for connecting and communicating between multiple modules and entry points.

In another embodiment, the invention comprises additional components that can detect tampering with the system.

In another embodiment, the invention also comprises systems and methods for re-configuring hardware interfaces with other access control systems.

In another embodiment, the invention also comprises methods for recognizing authorized entrants without requiring them to alter the normal process of entering a space as if access was not controlled.

In another embodiment, the invention also comprises methods for associating a user's face with an alternate identifier such as a badge number.

In another embodiment, the invention also comprises methods for detecting and preventing unauthorized persons from entering a controlled space by following an authorized person.

In another embodiment, the invention comprises techniques for recognizing a face when captured images of that face are partially blocked or occluded.

In another embodiment, the invention also comprises methods for using related interactions with the system to improve accuracy.

In another embodiment, the invention also comprises using a combination of RGB image data and 3-dimensional imaging data to detect spoofing.

In another embodiment, the invention comprises methods for identifying people who attempt to enter a controlled space using an improper badge.

In another embodiment, the invention comprises methods for enabling guest access under certain conditions.

In another embodiment, the invention comprises methods for determining the number of occupants in a building and enabling coordination of those determinations with emergency systems.

In another embodiment, the invention also comprises systems and methods for coordinating and sharing data regarding authorized entrants across multiple devices and multiple entry points.

In another embodiment, the invention also comprises systems and methods for detecting whether a person in the vicinity of an entry point intends to enter.

In another embodiment, the invention also comprises systems and methods for determining, in the case of a location with a plurality of separately controlled entry points, which of those entry points a user seeks to enter.

In another embodiment, the invention comprises a method for provisioning networked devices equipped with cameras by presenting configuration information to the devices in the form of barcodes or another coded graphic format.

In another embodiment, the invention also comprises systems and methods for increasing efficiency of identifying authorized persons.

In another embodiment, the invention also comprises systems and methods for clustering similar facial images in order to improve matching accuracy.

In another embodiment, the invention also comprises systems and methods for improving the acceptance of the system by gamifying the machine-human interaction

In another embodiment, the invention offers the ability, through a “slider” control or similar user-adjustable method of representing levels of certainty in a user interface, to make the system either more accurate by lowering false positives and false negatives, or moving to less friction by sticking with single-factor facial recognition with slightly lower accuracy.

In another embodiment, the invention also comprises a method to semi-automate an annotation process.

In another embodiment, the invention offers a recognition method which does not request preliminary enrolment of the user.

In another embodiment, the invention comprises a facial recognition module comprising a visual light sensor, at least an infrared sensor and an infrared emitter and at least a microprocessor, with the at least a visual light sensor, at least an infrared sensor and an infrared emitter mounted proximately to the front face and so the front face and said rear face each roughly define a plane, and so the rough plane defined by the front face and the rough plane defined by the rear face are not parallel, such that the included angle between the two planes defines an angle of between 15 and 70 degrees.

In another embodiment, the invention comprises a facial recognition module in which the field of view of its visual light sensor is greater than the field of view of its infrared sensor or sensors.

In another embodiment, the invention comprises a facial recognition module in which a visual light sensor one or more infrared sensors are mounted to a common imaging carrier.

In another embodiment, the invention comprises a facial recognition module which also comprises a motion sensor.

In another embodiment, the invention comprises a facial recognition module which also comprises an accelerometer.

In another embodiment, the invention comprises a facial recognition module which automatically determines its orientation relative to a surface to which it is mounted.

In another embodiment, the invention comprises a facial recognition module which automatically corrects the orientation of images captured by its imaging sensors based at least in part on information provided by an accelerometer.

In another embodiment, the invention comprises a facial recognition module that is capable of operating when connected to a power source supplying approximately 48 volts of direct current.

In another embodiment, the invention comprises a facial recognition module that is capable of operating when connected to a power source supplying approximately 12 volts of direct current or 48 volts of direct current.

In another embodiment, the invention comprises a method for controlling access to a controlled space using two facial recognition modules at an entry point, in which one facial recognition module is mounted on one side of an entry point and another facial recognition module is mounted on the other side of the entry point, and in which the controlled entry point will not unlock if either facial recognition module detects an unauthorized person on either side of the entry point.

In another embodiment, the invention comprises a method for controlling access to a controlled space using two facial recognition modules that records who passes through the doorway.

In another embodiment, the invention comprises a method for controlling access to a controlled space using two facial recognition modules that also includes a badge reader.

In another embodiment, the invention comprises a method for controlling access to a controlled space using two facial recognition modules that include accelerometers.

In another embodiment, the invention comprises a method for controlling access to a controlled space using two facial recognition modules that include motion sensors.

In another embodiment, the invention comprises a method for controlling access to a controlled space using two facial recognition modules that are capable of operating when connected to a power source supplying approximately 48 volts of direct current.

In another embodiment, the invention comprises a method for controlling access to a controlled space using two facial recognition modules that are capable of operating when connected to a power source supplying approximately 48 volts of direct current or when connected to a power source supplying approximately 12 volts of direct current.

In another embodiment, the invention comprises a method for controlling access to a controlled space using two facial recognition modules that includes one or more externally visible LEDs that change their state of illumination to indicate a change of state in the progress of authentication of a user.

In another embodiment, the invention comprises a system for permitting potential entrants into at least a building or other physical space at a controlled access point that comprises a facial recognition module to permit or reject the use of facial recognition on said user that includes a facial recognition module which includes at least a visible light sensor, at least an infrared sensor and an infrared emitter and at least a microprocessor, with the at least a visual light sensor, at least an infrared sensor and an infrared emitter are mounted proximately to the front face of the facial recognition module, such that said at least a visual light sensor, at least an infrared sensor are capable of recording images from an area beyond the front face of the facial recognition module, and the infrared emitter is capable of projecting infrared light to an area beyond said front face of the facial recognition module and at least an additional entrant identifier device that determines the identity of a potential entrant, including but not limited to a badge reader, one or more microphones or means of entering alphanumeric characters such as a key pad or touchpad, and an enrollment process by which permitted entrants to the building or other physical space at a controlled access point are registered with the system and at least a database of permitted entrants into at least the building or other physical space, the database comprising one or more records regarding each permitted entrant, wherein the database is stored on at least a server, and transmitting an alphanumeric code to a digital device controlled by the potential enrollee, receiving from the digital device the proper alphanumeric code, transmitting to the digital device a digital form that permits the potential enrollee to permit or deny permission for the system to perform facial recognition on the potential enrollee; and the enrollee choosing to either allow facial recognition to be performed on the enrollee or to deny permission for facial recognition to be performed on the enrollee.

In another embodiment, the invention includes a plurality of visible light sensors.

In another embodiment, the invention includes records regarding at least some permitted entrants wherein such records comprise at least a mathematical representation of features of the face of at least some of said permitted entrants.

In another embodiment, the invention includes a badge reader connected to the facial recognition module by a plurality of wires.

In another embodiment, the invention includes a plurality of microphones.

In another embodiment, the invention includes a touchpad.

In another embodiment, the invention includes an enrollment process that includes transmitting information from the facial recognition module to a mobile device associated with a potential entrant.

In another embodiment, the invention enables verification of the identity of an enrollee who has denied permission for facial recognition to be performed when the enrollee enters an alphanumeric code into a keypad or touchpad and/or the enrollee presents a badge to a badge reader.

In another embodiment, the invention enables verification of the identity of an enrollee who has denied permission for facial recognition to be performed when the enrollee speaks an alphanumeric code into a keypad or touchpad and/or the enrollee presents a badge to a badge reader.

In another embodiment, the invention includes a method for controlling access to a building or other area that includes a potential entrant to a building or other area approaching an entry point controlled by a facial recognition module, prompting the potential entrant to perform a specific physical gesture, such as waving a hand, determining whether the potential entrant has performed the specific gesture, and then performing facial recognition on the potential entrant if the potential entrant has performed the specific gesture, but not performing facial recognition if the potential entrant if the potential entrant has not performed the specific gesture.

In another embodiment, the invention includes a process in which the controlled entry point includes an entrant identifier device comprising a badge reader, and if a potential entrant does not perform a required specific physical gesture, entry is denied unless the potential entrant scans a badge comprising a unique identifier into the badge reader.

In another embodiment, the invention includes a process in which the controlled entry point includes an entrant identifier device with at least a microphone and a badge reader, and if a potential entrant does not perform a required specific physical gesture, entry is denied unless the potential entrant both scans a badge comprising a unique identifier in the badge reader and speaks a required phrase such that it is received by a microphone.

In another embodiment, the invention includes a microphone, and if a potential entrant does not perform a required specific physical gesture, entry is denied unless the potential entrant speaks a required phrase such that it is received by the microphone.

In another embodiment, the invention includes more than one microphone.

In another embodiment, the invention includes a process that performs facial recognition if a potential entrant performs a required specific physical gesture, and if the potential entrant is recognized as a permitted entrant, entry of the potential entrant is permitted without requiring the potential entrant to scan a badge.

In another embodiment, the invention includes a process that performs facial recognition if a potential entrant performs a required specific physical gesture, and if the potential entrant is recognized as a permitted entrant, entry of the potential entrant is permitted without requiring the potential entrant to provide an additional form of identification.

In another embodiment, the invention includes a keypad or touchpad, and if a potential entrant does not perform a required specific physical gesture, access is denied unless the potential entrant enters a specific alphanumeric code into the keypad or touchpad.

In another embodiment, the invention includes a method for controlling access to a building or other area that includes a potential entrant to a building or other area approaching a controlled entry point of the building or area, where the entry point includes a facial recognition module and a badge reader or device capable of receiving alphanumeric input, prompting the potential entrant to scan a badge comprising a unique identifier, looking up the badge in a database stored on a server connected to the badge reader and/or device capable of receiving alphanumeric input, and to the facial recognition module, determining based upon the database whether the badge is associated with a user who has previously opted into the use of facial recognition for control of entry to the building or other area, performing facial recognition on the potential entrant if the database confirms that the potential entrant has opted into the use of facial recognition for entry to the building or other area, not performing facial recognition on the potential entrant if the database confirms that the potential entrant has opted out of the use of facial recognition for entry to said building or other area, and prompting the potential entrant to provide an alternate form of identification.

In another embodiment, the invention includes a method for enrolling authorized entrants into an access control system for controlling access to a building or other area that includes at least a facial recognition module and at least one of a badge reader, voice recognition, speech recognition, or a touchpad or keypad for entering alphanumeric inputs. The method includes sending a message containing an alphanumeric code to a mobile device comprising at least a camera capable of capturing an image of the face of a user and believed to be associated with a specific user, receiving from the mobile device the same alphanumeric code, transmitting to the mobile device a consent form giving the user the option of agreeing or not agreeing to the use of facial recognition for purposes of determining whether to admit the user to the building or other area for which the access control system controls access receiving from the user the consent form denying or granting consent to the use of facial recognition for purposes of determining whether to admit the user to the building or other area for which the access control system controls access, receiving from the user at least an image of the face of the user if the user has consented to use of facial recognition for purposes of determining whether to admit the user to the building or other area for which the access control system controls access, using facial recognition for purposes of determining whether to admit the user to the building or other area for which the access control system controls access if the user has consented, not using facial recognition and using at least one of a badge reader, voice recognition, speech recognition or a touchpad or keypad for entering alphanumeric inputs for purposes of determining whether to admit the user to the building or other area for which the access control system controls access if the user has not consented.

In another embodiment, the the access control system communicates with the mobile device of the potential entrant using either or both of WiFi and a cellular network.

### BRIEF DESCRIPTION OF THE DRAWINGS

FIG. 1 illustrates a system of controlling access to a building or other restricted area using technology common in the prior art.

FIG. 2 is a flowchart illustrating the steps involved in validating and admitting an approved badge holder in the prior art.

FIG. 3 shows multiple images of a possible embodiment of a facial recognition module according to the present invention.

FIG. 4 is a high-level block diagram of a facial recognition module according to the present invention.

FIG. 5 is a more detailed block diagram of a facial recognition module according to the present invention.

FIG. 6 illustrates a system of controlling access to a building or other restricted area using an aspect of the present invention.

FIG. 7a is a high-level diagram of an access control system using an aspect of the present invention.

FIG. 7b is another high-level diagram of an access control system using an aspect of the present invention.

FIG. 8 illustrates a system of controlling access to a building or other restricted area using an aspect of the present invention.

FIG. 9 illustrates how facial features recognized in an RGB image may be projected onto an IR image.

FIG. 10 illustrates how structured light may be used to create a depth map of a face.

FIG. 11 illustrates mapping of facial landmarks using RGB and depth images.

FIG. 12 illustrates how depth images may be used to detect spoofing.

FIG. 13 is a flowchart illustrating how a neural net can be used to detect spoofing.

FIG. 14 illustrates how facial angles can be used to identify faces.

FIG. 15 is a flowchart illustrating how visible light and depth-sensing systems such as structured light may be incorporated in a facial recognition system.

FIG. 16 is another flowchart illustrating how visible light and depth-sensing systems such as structured light may be incorporated in a facial recognition system.

FIG. 17 is a flowchart illustrating an exemplary method for combining badge readers and facial recognition in an access control system.

FIG. 18 is a flowchart illustrating another exemplary method for combining badge readers and facial recognition in an access control system.

FIG. 19 illustrates an exemplary method by which an access control system can learn with the assistance of badge information.

FIG. 20 is a flowchart illustrating an exemplary method by which an access control system can learn with the assistance of badge information.

FIG. 21a is a flowchart illustrating an exemplary method by which an access control system can learn using only image recognition.

FIG. 21b is a flowchart illustrating an exemplary method by which an access control system can learn using both badge information and image recognition.

FIG. 22 is an illustration of how a facial recognition module can capture images of a person approaching a door controlled by the subject invention.

FIG. 23 is another illustration of how a facial recognition module can capture images of a person approaching a door controlled by the subject invention.

FIG. 24 provides high-level illustrations of the steps involved in an exemplary embodiment in recognizing a person approaching a controlled access point.

FIG. 25 is a high-level flowchart illustrating steps involved in an exemplary efficient facial recognition process.

FIG. 26 is an illustration of how an exemplary version of the invention can be used to define a region of interest in a captured image.

FIG. 27 is an illustration of how an exemplary version of the invention can be used to define multiple region of interest in a captured image.

FIG. 28 is a flowchart illustrating steps involved in an exemplary process of preventing tailgating.

FIG. 29 is an illustration of steps that can be taken to act on a detected instance of tailgating.

FIG. 30 is an illustration of how multiple captured images may be used to increase the likelihood of correct facial identifications.

FIG. 31 is a flowchart illustrating an exemplary method for sharing recognized faces among multiple entry points.

FIG. 32 is a flowchart illustrating an exemplary method for determining which of a plurality of doors to open based upon the actions of a person approaching those doors.

FIG. 33 is a flowchart illustrating an exemplary method for determining whether a person observed near a controlled access point intends to enter.

FIG. 34 is a flowchart illustrating an exemplary process for detecting whether a person is presenting a badge assigned to another person.

FIG. 35 illustrates how pictures of people approaching a controlled access point can be grouped into similar clusters.

FIG. 36 illustrates another aspect of how pictures of people approaching a controlled access point can be grouped into similar clusters.

FIG. 37 illustrates a high-level user interface that may be used to help teach a facial recognition module to recognize specific faces.

FIG. 38 illustrates messages that can be used to gamify the process of training an image recognition system.

FIG. 39 presents multiple views of a potential embodiment of a portable image recognition module.

FIG. 40 presents a potential visual representation of data that can be used to learn about the emotional state of entrants to abuilding over time.

FIG. 41 presents another potential visual representation of data that can be used to learn about the emotional state of entrants to abuilding over time.

FIG. 42 is an illustration of how an embodiment of the subject invention may be used to allow a user to execute commands on a facial recognition module using facial expressions.

FIG. 43 is an illustration of relative benefits of different technologies for building security.

FIG. 44a is an external perspective view of an embodiment of a facial recognition module according to the present invention.

FIG. 44b is an external perspective views of an embodiment of a facial recognition module according to the present invention.

FIG. 44c is an exploded drawing showing relationships between major structural components of an embodiment of a facial recognition module according to the present invention.

FIGS. 45a and 45b illustrate the field of view of facial recognition module according to the prior art and of an embodiment of a facial recognition module according to the present invention.

FIG. 46 illustrates an embodiment of an imaging component carrier and its relationship to the main chassis of an embodiment of a facial recognition module according to the present invention.

FIGS. 47a and 47b illustrate tamper-resistant features of an embodiment of a facial recognition module according to the present invention.

FIGS. 48a and 48b illustrate additional tamper-resistant features of an embodiment of a facial recognition module according to the present invention.

FIGS. 49a, 49b and 49c illustrate weather-proofing features of an embodiment of a facial recognition module according to the present invention.

FIG. 50 illustrates a man trap as is found in the prior art.

FIG. 51 illustrates an alternative form of a man trap based on an embodiment of a facial recognition module according to the present invention.

FIG. 52 illustrates a controlled entry point with two facial recognition modules, one on each side of the entry point.

FIG. 53 illustrates of an embodiment of a facial recognition module according to the present invention including LEDs to convey the progress of an authorization and entry process.

FIG. 54 illustrates an embodiment of a facial recognition module according to the present invention including an array of LEDs that can be illuminated to suggest various actions.

FIG. 55 illustrates a Receiver Operating Characteristic or ROC curve used to determine a desired level of false acceptance and false rejection rates.

FIG. 56 is a flow chart showing an exemplary process for establishing an ROC curve for an embodiment of a facial recognition module according to the present invention.

FIG. 57a through 57d illustrate exemplary methods for connecting embodiment of a facial recognition module according to the present invention into a legacy building security system.

FIG. 58 illustrates an exemplary method for configuring a facial recognition module to operate on both high and low voltage power supplies.

FIG. 59 is a flow chart that illustrates an exemplary method for enabling individual opt-in consent to the processing of facial images and information using each individual enrollee's smart phone.

FIG. 60 is a flow chart that illustrates an exemplary method for performing consent-based facial recognition.

FIG. 61 is a flow chart that illustrates an exemplary method operating a peer-to-peer access control system using a plurality of facial recognition modules.

FIG. 62 is a flow chart that illustrates an exemplary method for performing voice recognition in an access control system.

FIG. 63 is a flow chart illustrating an exemplary method for operating an access point to only permit entry if two authorized users present themselves for access together.

FIG. 64 is a flow chart illustrating an exemplary method for incorporating facial recognition opt-out into the operation of a multi-factor authentication system that includes facial recognition, a keypad or other device for entering a passcode, and a badge reader

FIG. 65 is a flow chart illustrating an exemplary process for using a facial recognition system to prevent tailgating.

FIG. 66 is a flow chart illustrating an exemplary method for implementing a wave-to-consent process in a facial recognition system

FIG. 67 is a flow chart illustrating a process for incorporating voice recognition into a three-factor access control system

FIG. 68 is a flow chart illustrating a method for setting up a user of an access control system with voice recognition.

FIG. 69 is a flow chart illustrating a method for multi-factor authentication including speech verification in an access control system.

### DETAILED DESCRIPTION OF THE PREFERRED EMBODIMENT

Common in the prior art are badge-based access control systems. Badges may include photographs of the associated user, or may be simple cards or other small portable tokens that contain only internal means for storing a unique identifier. Permitted users will generally each be issued a badge or token.

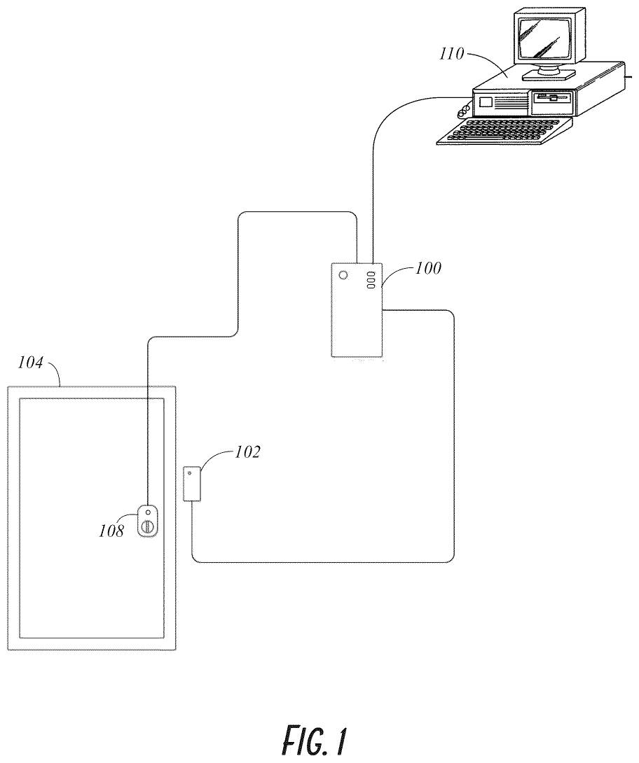

FIG. 1 illustrates the major elements of a representative system used to control access to a building or other secure area as commonly found in the prior art. A typical system includes an access control panel 100, and one or more badge readers 102, which are typically located at access points such as door 104. Access control panel 100 can also be connected to one or more turnstiles, as are sometime used in places like lobbies of buildings that control access and have large number of people entering and leaving. Doors 104 include electronic locks 108; turnstiles include remotely controlled means for locking and unlocking the turnstiles. Badges and badge readers can use a variety of technologies for encoding a unique identifier in each badge, including a number of proprietary protocols, and retrieving that identifier at the time the badge is presented.

The physical interface generally uses five or six wires: one that carries DC voltage to power the card reader, a common ground, one or two wires that transmit status to the green and red indicator LEDs on the badge reader, and two data transmission wires. It is a simple binary transmission system, changing states from high (some positive DC voltage, e.g. 5 volts) to low (zero). The original Wiegand format for badge reader encoding permits a total of 26 bits. Other systems have used the Wiegand hardware layer but different data formats, using many more bits, that enable more complex addressing. Different encoding formats are also available now, some of which are proprietary to one specific company. Those encoded badge numbers are transmitted to the access control panel using a communication protocol which may be Wiegand or other protocols deployed have included mono-directional, Clock and Data or bidirectional OSDP (RS 485), RS 232 or UART.

Badge readers 102 will generally include a means for providing visual feedback to the badge holder, such as green LED light 112 and red LED light 114. Green will generally indicate that the user has successfully badged in, and is allowed to enter; at all other times the red light will generally be illuminated to indicate that the system is operational. Blinking red or a third color, such as orange could indicate that an invalid card has been swiped.

The physical interface generally uses five or six wires: one that carries DC voltage to power the card reader, a common ground, one or two wires that transmit status to the green and red indicator LEDs on the badge reader, and two data transmission wires. It is a simple binary transmission system, changing states from high (some positive DC voltage, e.g. 5 volts) to low (zero). The original Wiegand format for badge reader encoding permits a total of 26 bits. Other systems have used the Wiegand hardware layer but different data formats, using many more bits, that enable more complex addressing. Different encoding formats are also available now, some of which are proprietary to one specific company. Those encoded badge numbers are transmitted to the access control panel using a communication protocol which may be Wiegand or other protocols deployed have included mono-directional, Clock and Data or bidirectional OSDP (RS 485), RS 232 or UART.

Badge readers 102 will generally include a means for providing visual feedback to the badge holder, such as green LED light 112 and red LED light 114. Green will generally indicate that the user has successfully badged in, and is allowed to enter; at all other times the red light will generally be illuminated to indicate that the system is operational. Blinking red or a third color, such as orange could indicate that an invalid card has been swiped.

The badge's unique ID can be coded into a magnetic stripe, or RFID (radio frequency identification), or (with less security) a visual indicator such as a barcode or QR code. In the case of a magnetic stripe system, a magnetic reader like those traditionally used for credit cards is included in the badge readers 102, and each user must swipe his/her badge through a dedicated slot in badge reader 102. In the case of RFID-based systems, either active or passive, reader 102 will include one or antennas that may detect or generate a field of interrogating radio waves. In some systems, physical contact between the token/badge and the enclosure of the reader is required; in others, a level of proximity may be sufficient.

When a badge is scanned, the scanning device 102 determines the unique identifier encoded in the badge 106 and transmits the identifier to access control panel 100. Historically, these signals have generally been transmitted over a simple wired connection using a serial bus protocol which may be a proprietary standard such as the previously Wiegand system, or may utilize a different, non-proprietary protocol. However, some systems have used other approaches, including wired technologies including Ethernet, Power of Ethernet (PoE), or wireless systems such as IEEE 802.11, also known as WiFi.

In one embodiment, access control panel 100 is a dedicated central point to which a number of badge readers 102 can be connected. Access control panel generally includes a simple means of connecting a number of wired connections to access point controls. It also generally includes a storage medium capable of maintaining a list of authorized entrants to the building(s) or area(s) where access is controlled by the system. Access control panel 100 may also include a means for providing backup power to the access control system in the event power is interrupted, either by a power failure or due to an attempt to break into the controlled area.

When a badge is presented at a badge reader 102, the encoded badge number is transmitted to access control panel 100. Access control panel 100 determines if that badge number is on the stored list of permitted entrants, and if so, sends an unlock signal to the appropriate electronic lock or turnstile.

Access control panel 100 may also include means by which it can be connected to a computer 110, though for security reasons, the exposure of access control panel 100 to external devices may be carefully controlled. Such connection may be accomplished via a common networking protocol such as Ethernet, or may use a serial protocol such as RS232 or RS422. Computer 110 may be one or more conventional computers that are equipped with communications hardware such as modem or a network interface card. The computers include processors such as those sold by Intel and AMD. Other processors may also be used, including general-purpose processors, multi-chip processors, embedded processors and the like.

Computer 110 can also be a microprocessor-controlled computer such as a dedicated embedded system. Computer 110 may utilize a conventional keyboard and display, or may provide an alternate interface such as a touch screen, or some other means of interaction. It may utilize a browser or other application configured to facilitate interaction with a user.

Computer 110 may incorporate one or more storage medium that may comprise any method of storing information. It may comprise random access memory (RAM), electronically erasable programmable read only memory (EEPROM), read only memory (ROM), hard disk, floppy disk, CD-ROM, optical memory, or other method of storing data.

Computer 110 may use an operating system such as Microsoft Windows, Apple Mac OS, Linux, Unix or the like, or may use dedicated operating system.

Computer 110 may include means for communication over a network such as a local area network or the Internet to permit remote observation or control over its functions.

Computer 110 may be used to permit adding and deleting authorized users from the system.

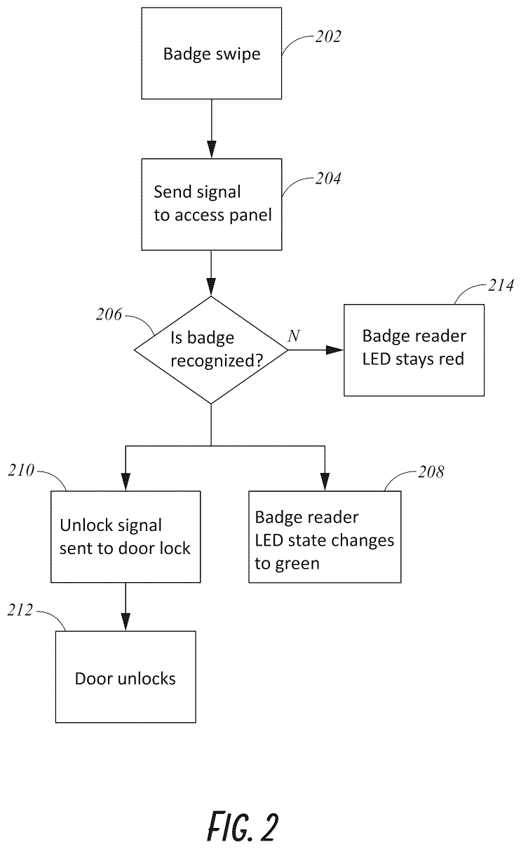

FIG. 2 presents a block diagram illustrating the steps taken by a system typical of the prior art when a badge is presented to the system. In step 202 the badgeholder presents his or her badge 106 to the badge reader 102. In step 204, the badge reader transmits the unique identifier read from the badge 106 to access control panel 100. In step 206 access control panel 100 evaluates the transmitted unique identifier to determine if access should be granted. This process may consist of looking up the unique identifier in a database. If the unique identifier is in the database of permitted entrants, then in step 208 green LED 112 is illuminated, and in step 210, access control panel 100 transmits a signal to the door lock 108 unlocking it 212 and permitting entry. If the unique identifier is not in the database of permitted entrants, then in step 214, there is no state change transmitted, and red LED 114 remains illuminated, and door lock 108 (or turnstile) remain locked. In other embodiments, the red LED may blink to indicate that access has been refused. In some implementations, different color LEDs or patterns of illumination may be used to signal admittance or rejection. The illumination of the “admit” LED and the unlocking of the door or turnstile may be simultaneous instead of sequential. Again, turnstiles may be substituted for doors.

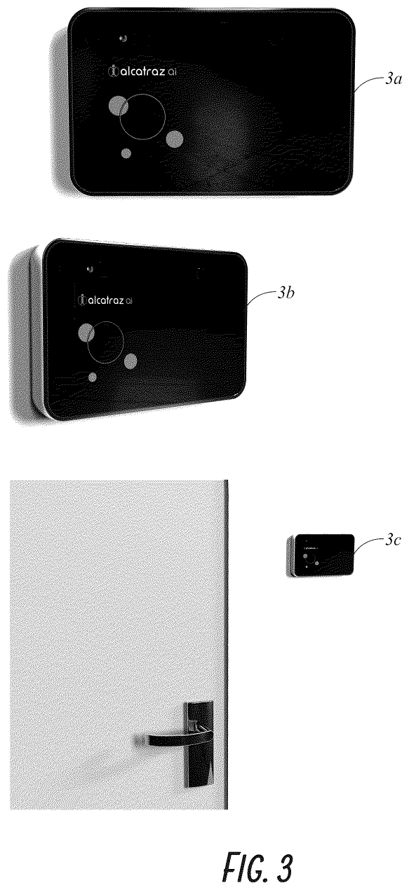

The accompanying hardware edge unit is designed to be placed on a wall or door next to the physical access point to be unlocked. This module includes several sensors protected by a non-transparent piece of glass (provided that it includes transparent areas in front of the IR laser projector and sensors), plastic or other transparent or non-transparent material that permits the sensors and IR laser projector enclosed therein to operate. The following renderings in FIG. 3 give an overview of the design of the unit. FIG. 3, module 3a shows an exemplary facial recognition module as viewed from the perspective of a person walking directly toward the unit. Module 3b shows the same facial recognition module in perspective. Module 3c shows the same facial recognition module in relationship with a door for which the facial recognition module controls access.

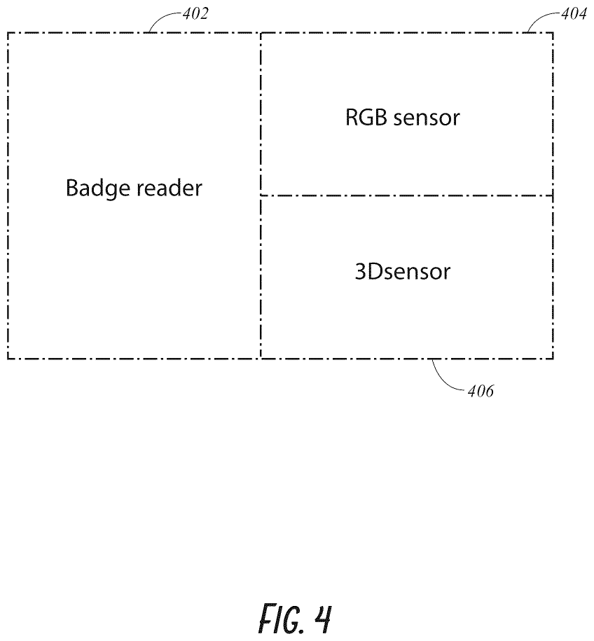

This face recognition module is mainly based on a badge reader associated with an RGB and depth sensors to be able to capture user's faces, as seen in FIG. 4. The edge unit also contains a processing unit and communication modules. It includes badge reader 402, RGB camera 404, and Infrared sensor 406. It may also include a small display to present messages, etc. to potential entrants.

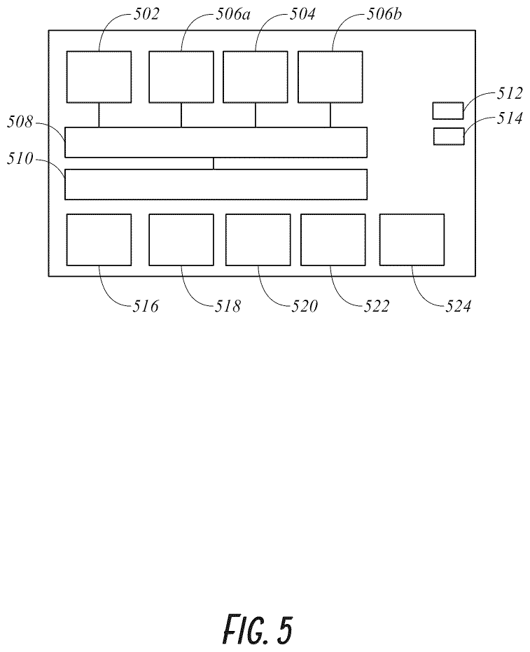

FIG. 5 is a more detailed illustration of an embodiment of a facial recognition access point module 500 according to one aspect of the subject invention. Facial recognition access point module 500 includes an RGB (red, green, blue) camera 502 to capture visible light images. Preferably, RGB camera 502 is capable of capturing high-definition (such as 1920 by 1080 pixel) images, though a variety of resolutions may be used. Facial recognition access point module 500 also includes infrared laser projector 504. IR laser projector 504 includes both an IR source, and means for projecting structured light. In an embodiment, the IR source could be a simple IR emitter that does not project structured light. Facial recognition access point module 500 also includes two infrared sensors 506a and 506b. Infrared sensors 506a and 506b are physically separated in order to enable stereoscopic IR viewing, much as the separation of eyes enables depth perception. Infrared sensors 506a and 506b are also preferably high-definition units (such as a resolution of 1280×720 pixels), though again a variety of resolutions may be suitable.

Each of RGB camera 502, IR laser projector 504, and IR sensors 506a and 506b are connected internally to I/O interface module 508, which is in turn connected to processor module 510. In some implementations, I/O interface module 508 may be integrated into CPU 510. processor module 510 may comprise multiple processors, memory, etc., and may comprise other components to enhance performance, such as one or more graphics processing units (GPUs).

Facial recognition access point module 500 may also include one or more status indicator lights. These may consist of red LED 512 and green LED 514. Alternatively, a combination of LEDs may used to generate a wide range of colors. These LEDs can be controlled by processor 510. Also included may be means for connecting facial recognition access point module 500 to other devices, including Wiegand-based systems. Thus facial recognition access point module 500 may also include a wire block 516 or other means for connecting appropriate wires to the unit. Facial recognition access point module 500 may also contain power supply-related components 518, such as transformers, voltage regulators, surge suppressors, capacitors, batteries, etc. Facial recognition access point module 500 may also contain one or more relays or solenoids 520 used to trigger an unlock signal to the connected door or turnstile. Facial recognition access point module 500 may also contain anti-tampering components 522, which may comprise accelerometers, light sensors, temperature sensors or other means for detecting movement, removal from a wall, etc.

Facial recognition access point module 500 may also contain a badge reader 524. This permits new installations without requiring separate badge readers, and also permits removal of old badge reading hardware when retrofitted in legacy buildings.

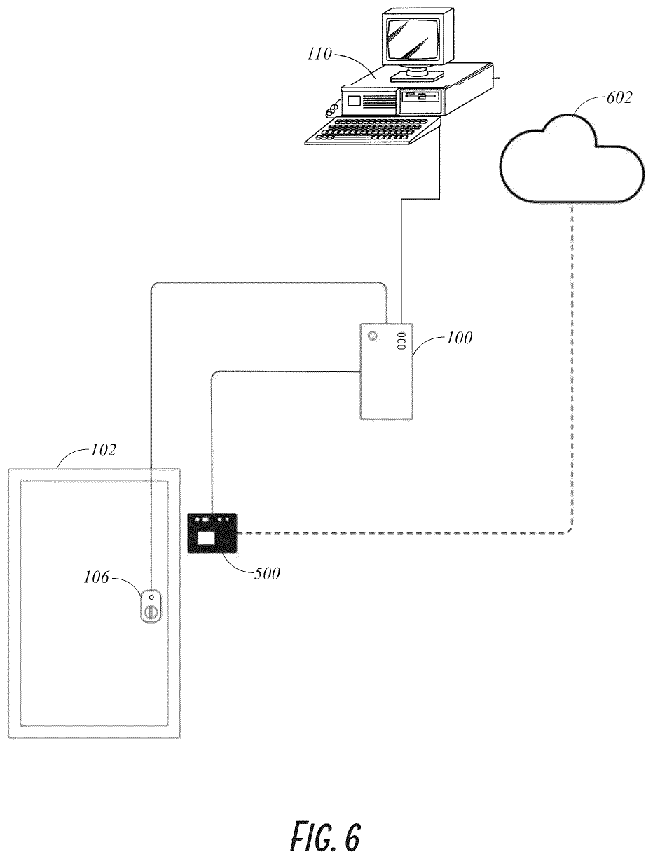

FIG. 6 illustrates the major elements of a representative system used to control access to a building or other secure area using an embodiment of the subject invention, where the subject invention is integrated into an existing system providing badge-based access control.

It may include access control panel 100, and one or more access points such as doors 102 or turnstiles (not shown). Doors 102 include electronic locks 106; turnstiles may similarly include remotely controlled means for locking and unlocking them. Facial recognition module 500 will generally include a means for providing visual feedback to the person presenting the badge, such as green LED light 112 and red LED light 114 (not shown in this image). As in FIG. 1, green will generally indicate that the user has successfully badged in, and is allowed to enter; at all other times the red light will generally be illuminated to indicate that the system is operational, though other lighting signals are possible. Access control panel 100 may also connect with one or more servers located in cloud 602. Access control panel 100 may also connect to a computer 110.

In an exemplary embodiment, each facial recognition access point module 500 may be connected using five or more wires: generally two wires for supplying power, one or two wires to carry the LED signal from the access control panel, and two signal wires to communicate with the access control panel 100.

The proposed technology can be deployed by exchanging existing badging units with a new module containing the proposed technology. The hardware can utilize existing wiring to communicate with legacy door controllers and door access infrastructure.

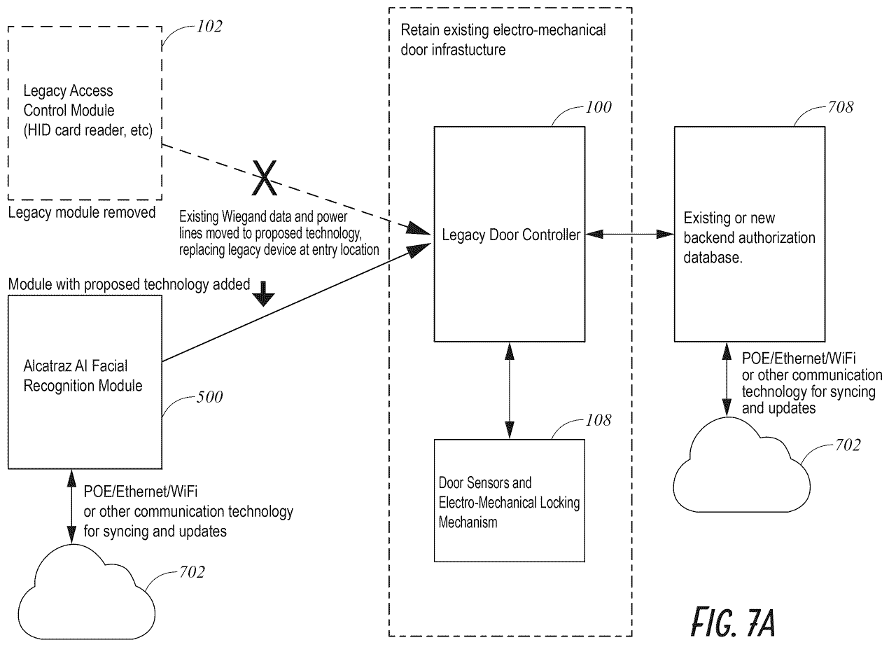

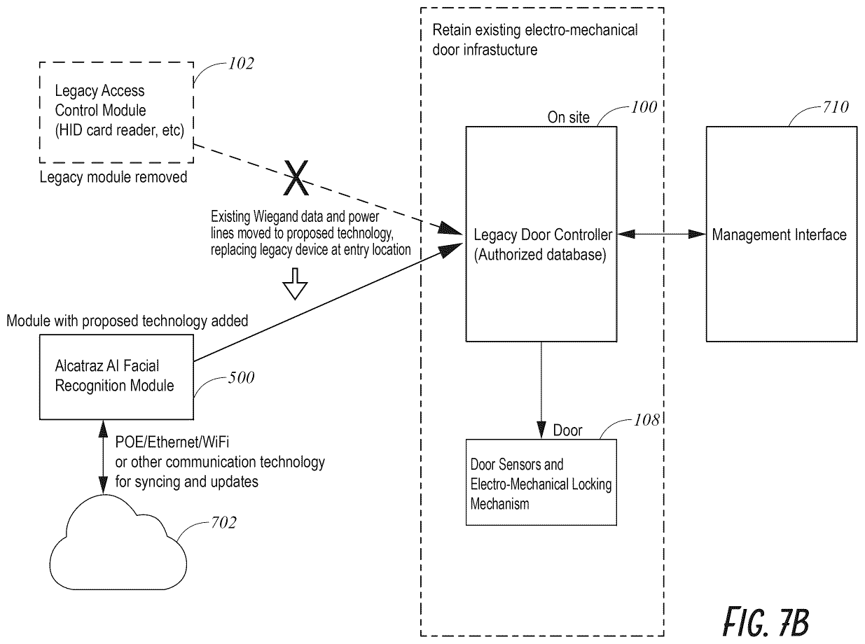

This simplifies installation at locations that have existing investment in door access systems, as no new wiring is required. FIG. 7a Illustrates this module swap in context of existing infrastructure.

Legacy badge readers 102 can be retained, or can be removed and the badge readers in facial recognition modules 500 can be used for that purpose. Facial recognition access point module 500 is added to the system to enable facial recognition, and is connected to legacy door controller, which is access control panel 100, which may connect with electro-mechanical locking mechanism 108. Facial recognition access point module 500 may also be connected to a remote server accessible over the Internet located in the cloud 702, but may be physically connected to a local server for security reasons. Electronic lock 108 is also connected to authorization database 708, which may exist on access control panel 100. Authorization database 708 may also be connected to a remote server 702, which can be local or in the cloud, which may provide means for remote monitoring, updating, etc.

FIG. 7b shows an alternative embodiment. As in FIG. 7a, legacy badge readers 102 can be retained, or can be removed and the badge readers in facial recognition module 500 can be used for that purpose. Communication between facial recognition access point module 500 and access control panel 108 is bidirectional to enable LED signals (such as signifiers of admit/deny actions) to be transmitted to facial recognition module 500. Facial recognition access point module 500 may also be connected to a remote server accessible over the Internet located in the cloud 702, but may be physically connected to a local server for security reasons. Electronic lock 108 is also connected to authorization database 710, which may exist on access control panel 100. Authorization database 710 may also be connected to a remote server 702, which can be local or in the cloud, which may provide means for remote monitoring, updating, etc.

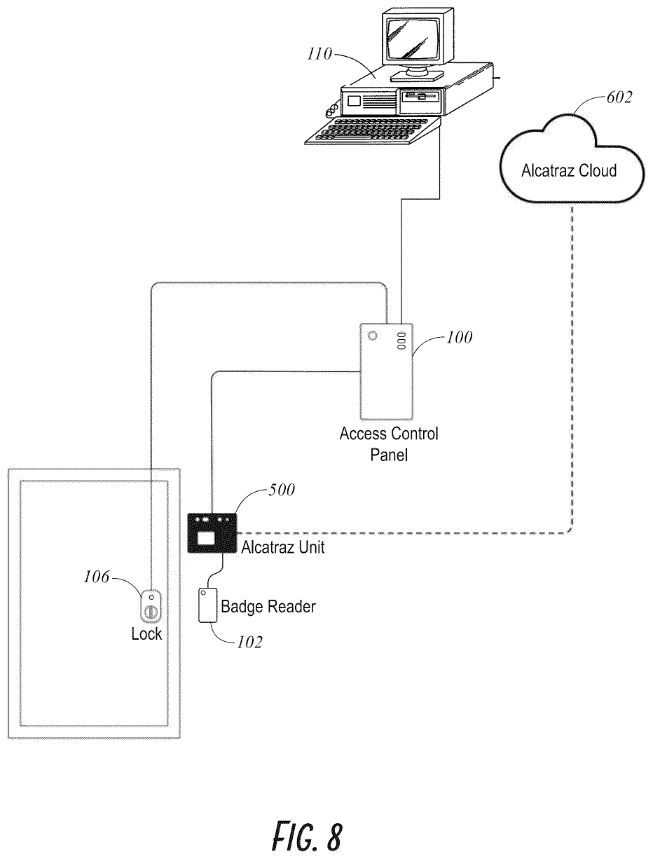

FIG. 8 illustrates an embodiment in which an access point sensor module according to one aspect of the subject invention may be used to directly control door.

It may include an access control panel 100, and one or more badge readers 102, which are typically located at access points such as doors 104 or at turnstiles (not shown). Doors 104 include electronic locks 106. Badge readers 102 will generally include a means for providing visual feedback to the badge holder, such as green LED light 112 and red LED light 114. As in FIG. 1, green will generally indicate that the user has successfully badged in, and is allowed to enter; at all other times the red light will generally be illuminated to indicate that the system is operational.

Facial recognition access point modules 500 are added to the system at access-controlled doors 104 and/or turnstiles. In an exemplary embodiment, each facial recognition access point module 500 may be connected using five or six wires: two wires for supplying power, one or two wires to carry the LED signal from the access control panel, and two wires to control the access control mechanism (door, turnstile, etc.). Facial recognition module 500 may also include a badge reader, as well as means to read other forms of identification, including but not limited to technologies such as Bluetooth. Facial recognition access point module 500 may also be connected to a remote server accessible over the Internet located in the cloud 602, and/or may be physically connected to a local server 110 for security reasons.

A module using color (often defined as “RGB” for red/green/blue images which are standard color images), depth and infrared images for facial recognition may be used. This module uses badging to train the system with the user's face. Each time the person badges in, his or her face is recorded in the system. After a certain amount of time, usually after the first badging interaction, the system will have enough precision to work based only on facial recognition (no more badging requested). In alternate embodiment, the facial recognition access point module 500 may capture a series of images prior to eliminating the badging requirement, and may further require that each of the images are of sufficient quality (that is, with sufficient sharpness and with enough of the person's face being visible) to enable high accuracy. 3D data is able to detect all standard methods of spoofing (using a picture, a video on a screen, etc.) and prevent unwanted access.

In at least an embodiment, the authentication algorithm combines RGB, infrared and 3D depth data for better accuracy. The main algorithm is based on RGB and infrared processing while 3D data is used to confirm RGB authentication and add further accuracy. In one embodiment, over time, as the system learns more and more, the 3D personalized facial model is also used in recognition.

Embodiments may include synchronized RGB, infrared and depth sensors. As traditional face detection algorithms work only on RGB data, a method needed to be invented to access face features from 3D mapping. Performing image detection on RGB and infrared frames and projecting them to depth data improves accuracy and enables the system to detect spoofing, as well as improving the accuracy of recognition and tracking. Knowing the position and intrinsic parameters of each sensor and their relative extrinsic parameters, the combination of rotation, translation and dilatation transforms can be defined, as they are required to match each RGB, infrared and depth pixel.

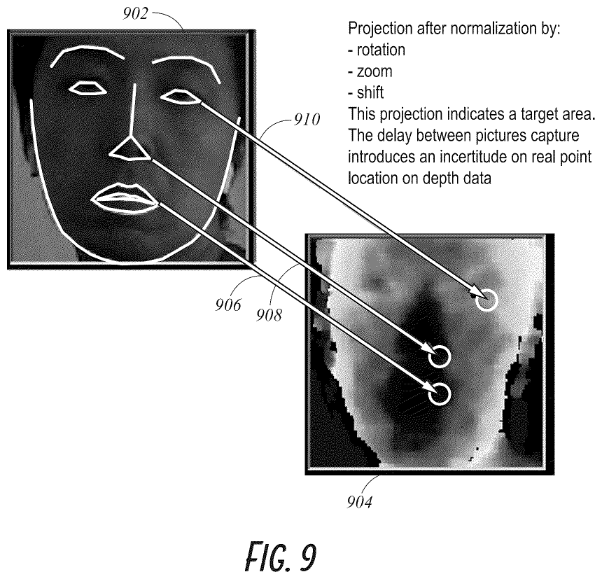

This location estimate includes small uncertainties as both pictures are not taken exactly at the same time. This estimate can also be quantified. FIG. 9 presents a visual explanation of this projection mechanism.

Image 902 is an RGB image of a potential entrant. Image 904 is an infrared image captured at roughly the same time. Arrows 906, 908 and 910 illustrate how specific landmarks on the RGB image may be projected on to the IR image.

Due to hardware limitations, two images theoretically shot at the same time may still have a small delay in between them. When mapping one image onto another it is useful to know if they were taken at different times and, if so by how much. Thus one aspect of the invention is to use time stamps to help align IR and RGB images. If for example, an IR and an RGB image were taken only a few milliseconds apart, they likely can be combined with high confidence, whereas if an RGB was captured 3 seconds before a specific IR image, both the location and the facial expression of the subject are likely to have changed too much to permit accurate mapping of one onto the other.

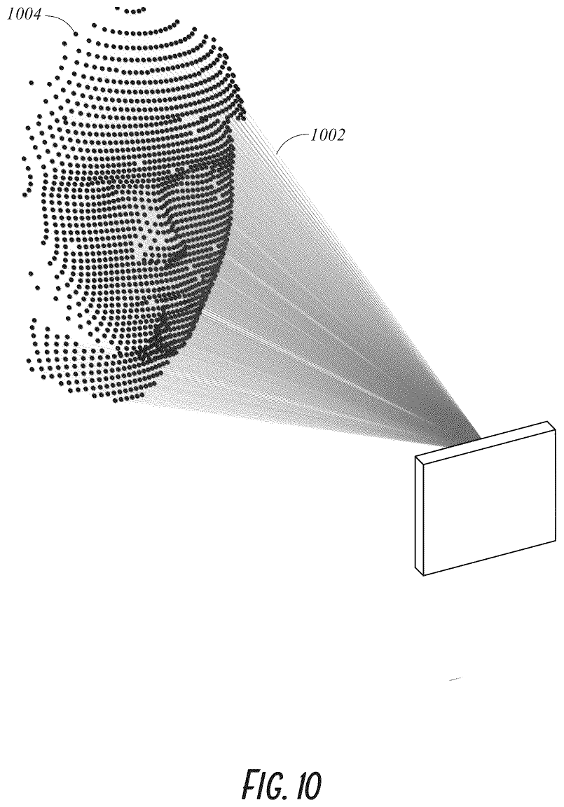

FIG. 10 illustrates how an embodiment of the access point sensor module may be used to capture infrared structured light imaging of a person seeking entry. Infrared laser projector 504 projects an array of lines or points 1002 over an area that roughly corresponds to the field of view of infrared sensors 506a and 506b, and that includes the face being analyzed. This produces an array of dots 1004. Because the two infrared sensors are separated from each other and from the structured light source by a distance, which can be as small as a few millimeters, or as wide as a foot or more, the structured light projected by infrared laser projector 504 appears different to each of infrared sensors 506a and 506b, much as our two eyes perceive the visible light as it falls on objects differently. Just as the brain interprets those differences in order to judge distance, whether interpreting the contours of a face or hitting a baseball, processor 510 interprets the pattern of dots or lines 1002 in order to build a point cloud that comprises a 3D model of the detected face.

FIG. 11 illustrates how depth data gives much more facial detail than a standard 2D color picture. Image 11a is a representation of the kind of image data captured by an RGB camera. Image 11b shows the limited number of facial landmarks that can be extracted from such an image. Image 11c shows the kind of image data that can be captured by a pair of IR sensors when “reading” an object illuminated by structured light or a time-of-flight system, and image 11d shows the number of facial landmarks that can be extracted from such a structured light image or a time-of-flight system. Similar results may be obtained processing paired stereoscopic images.

The kind of data that can be generated from monocular visual (RGB) imaging of a human face may be limited relative to the information that can generated from infrared structured light, stereoscopic IR imaging, or time-of-flight imaging. Because a conventional RGB image is essentially two-dimensional, presenting digital values for each pixel in terms of the amount of red, green and blue light captured for each, the location and shape of each structural feature of a face (mouth, nose, eyes, etc.) must be inferred from often subtle gradients in color, shading, etc. This processing generally yields a relatively crude approximation of the “architecture” of a face. Thus for an image 11a taken with an RGB camera, applying typical algorithms for facial recognition, it is possible to place only about 60 key reference points with reasonable accuracy, as shown in image 11b.

By applying structured light or time of flight imaging, and the grid projected on an object such as a human face by infrared laser projector 504, the resulting image is a point cloud such as that shown in image 11c. Processing that image yields a 3-dimensional model of a face that may contain 5000 points or more, as shown in image 11d. Such a model permits more precision in recognizing faces than is possible with only RGB image information.

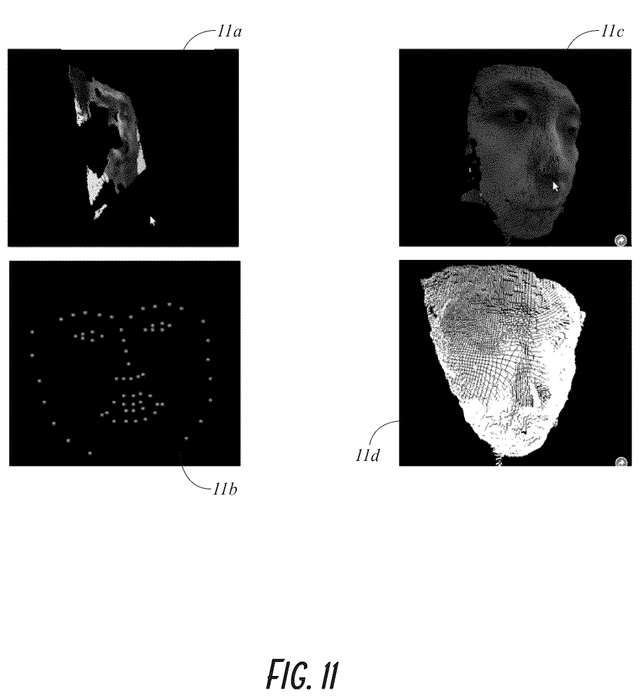

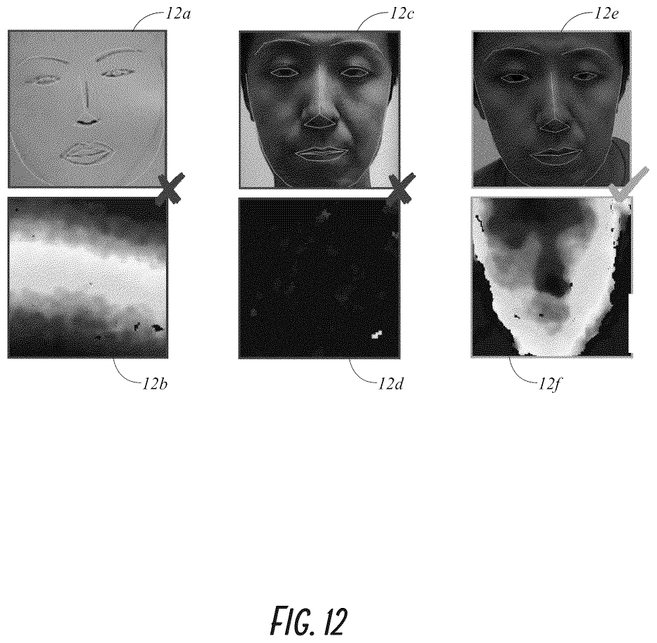

Anti-spoofing is required to prevent purposeful and malicious security intrusions. A normal color or infrared 2D picture can be tricked easily with a photo or a video. The proposed technology includes 3D pictures for this specific application. A 3D map of the face gives very useful information to detect such attacks. 3D facial characteristics are extracted and deduced if this matches generalized model of the face or the specific personal face model. This method effectively prevents all traditional spoofing methods such as 2D attacks using flat images and basic 3D masks. An illustration of this 3D data variation is presented in the FIG. 12.

In FIG. 12, image 12a shows what may be thought of as a drawing of a face on a piece of paper. An RGB image of such a drawing may extract features as if presented with an actual face. But the IR sensors reading structured light or time-of-flight imaging striking the piece of paper will generate a depth map like that shown in image 12b, which is very different from the depth map of an actual face.

Image 12c shows what may be thought of as an image of a face on displayed on a device such as a tablet computer. An RGB image of such an image may again extract features as if presented with an actual face. But the IR sensors reading structured light striking the display will generate a depth map like that shown in image 12d, which is very different from the depth map of an actual face. Similarly, time-of-flight imaging will generate a very different result than would result from an actual face.

Image 12e shows what may be thought of as an image of an actual face. An RGB image of such an image may again extract the expected features. IR sensors reading structured light striking the display will generate a depth map like that shown in Image 12f, which is easily distinguished from the objects presented to spoof the system. Similarly, time-of-flight imaging will generate a very different result than would result from an actual face.

In at least an embodiment, the proposed authentication method is based on combining recognition and anti-spoofing. The system will detect and track faces in front of the module. For each face detected, facial features and descriptors will be extracted and processed to find a potential match in authorized users' database. Other factors like stride, clothes, height and skin recognition are also used to increase accuracy.

In at least an embodiment, the anti-spoofing algorithm runs in parallel of this recognition process. RGB facial features will be used to find corresponding points in the depth map. After that, different prediction methods and parameters are combined for best results. Even if those methods are always evolving, the main ones are described below.

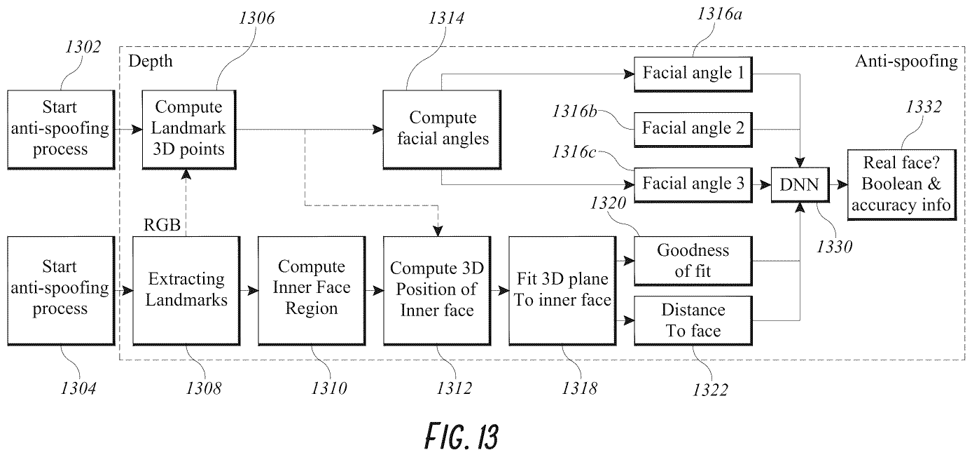

The following are some of the spoofing methods used by a proposed algorithm to determine if the detected face is a real one or not. All methods for spoof checking are processed in parallel and the results are returned with their confidence levels. Depending on each one of the values, a method was developed, based on neural networks, to output a final score with a decision. FIG. 13 presents how all those inputs are fed into the neural network (DNN) to generate the final prediction in an exemplary version of an aspect of the subject invention.

In step 1302, the (primarily) infrared-based anti-spoofing process begins, and in step 1304, the (primarily) RGB-based portion of the process begins. In step 1306, depth-based facial landmarks are extracted from the RGB image captured by camera 502. In step 1308, the RGB-derived facial landmarks are extracted from the RGB image captured by RGB camera 502. In step 1310, the RGB process determines which region of the image contains the critical region of the face (eyes, nose mouth, etc.). In step 1312, the output of the computational process in step 1308 and the output of the process in step 1310 are combined to calculate the relative distance of the detected facial features from each other.

In step 1314, the facial landmarks computed in step 1306 are used to compute a series of 3D angles 1316a, 1316b through 1316n between those facial landmarks.

In step 1318 the output of step 1312 is used to generate a normalized series of net distances from the base plane for the detected face.

With these data points, the system is now equipped to perform the anti-spoofing function. In step 1320, the quality of fit between the computed facial features and one or more stored model face maps is evaluated. In step 1322, a value for the distance between the face and the facial detection module 500 is calculated. This is performed in order to weight the quality of the image and related processing, since more distant images will have a lower resolution, and thus harder to use to make definitive decisions.

In an alternative embodiment, one or more of the previously described steps may be omitted and the equivalent function can be performed by the neural network described below.

In step 1330, the outputs of steps 1316a through n, 1320, and 1322 are fed into a neural network for evaluation. A properly trained neural network can produce an answer as to whether a real face (vs. a spoofed image) has been detected, together with numerical value or values indicating the degree of certainty associated with that answer. In step 1332, that probability is compared to a threshold that may be externally set. Thus the system may be configured so that if the evaluated images generate a, say, 90 percent probability that the system is viewing a live person, it is concluded that a real person is approaching, while lower probability is considered too large a danger of spoofing, and the system is not instructed to unlock.

In another embodiment, a DNN as disclosed in FIG. 13 may be employed to perform additional processes described in Fig as being accomplished by other means. Thus it is also possible to as part of the subject invention to feed RGB and IR images directly into the DNN, and permit the DNN to learn the factors necessary to differentiate between a 2-dimensional representation of a face and an actual face.

As discussed, an aspect of the facial recognition process may be the computation of certain facial angles. Two examples of such a process are shown in facial image 1400A and facial image 1400B of FIG. 14. Each of 1400A and 1400B represent the kind of facial image data that can be extracted from RGB images of two different faces. Each small numbered point 1402 represents a landmark that can be extracted from a full-face image. These include points indicating the overall shape of the face, and the edges of features such as the nose, mouth and eyes. Those landmarks permit facial recognition module 500 to compute a series of angles 1404 between those points.

A similar process may be used as part of an anti-spoofing process, as discussed in more detail below.

Previous explanations described main authentication and anti-spoofing methods. In an exemplary embodiment, There are additional checks that need to be done for extra anti-spoof security.

Those methods includes but are not limited to:
Person's height and build
Skin color and microtextures analysis
Liveness information and particularly micro-movements of the face

A challenge facing facial recognition technology is how to operate when the system captures an image that is partially occluded (such as by clothing, an object or person between the facial recognition module and the face being evaluated, or facial hair), or when the person is facing other than directly toward the module, so that the relationship between the landmark features of the face varies depending facial orientation. Even if one or more of these suboptimal conditions is present, it would be advantageous to be able to perform facial recognition on the facial features that are visible to the camera(s) and/or sensors, and to allow “in-the-flow” processing under such conditions. Thus in another embodiment, the invention comprises techniques for recognizing a face when captured images of that face are partially blocked or occluded.

One method of performing facial recognition is to detect and describe facial landmarks, and then to calculate the relationships between those facial landmarks. Those landmarks may include the inside and outside corners of the eyes, the pinna of the ears, the nostrils, etc. A facial recognition system may collect over 100 such points. The highest level of certainty is achieved when all of the points that can be plotted for a face have been captured. However, in a given use case, it may be that the loss of certainty when only a specified percentage of those points, for instance, 40%, are captured, is low relative to the associated reduction in user friction. In addition, as described in more detail below, an aspect of the subject invention is the capture, processing and categorization of images of a given user from a variety of angles, and under a variety of conditions.

In another embodiment of the invention, a neural network processes the RGB image of the face, and extracts all the distinguishing facial features it needs by itself.

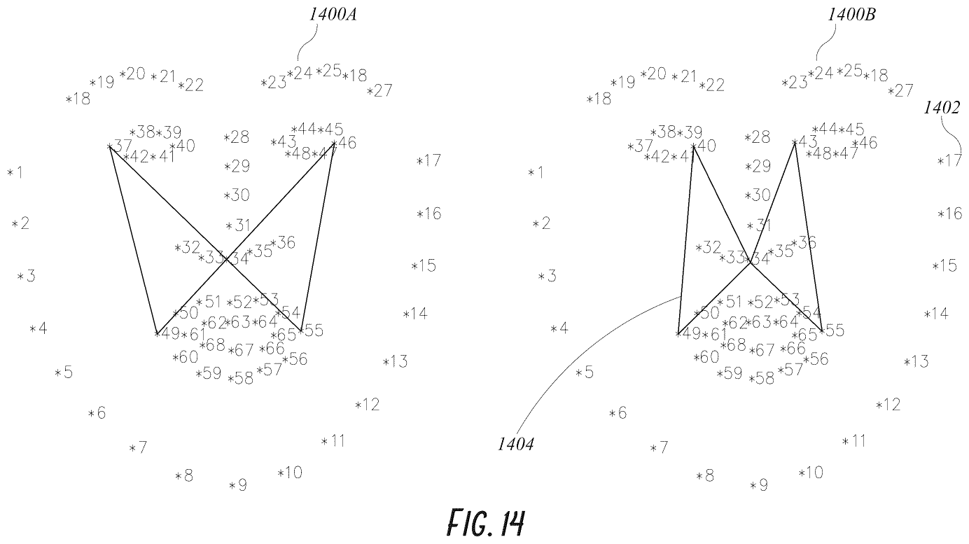

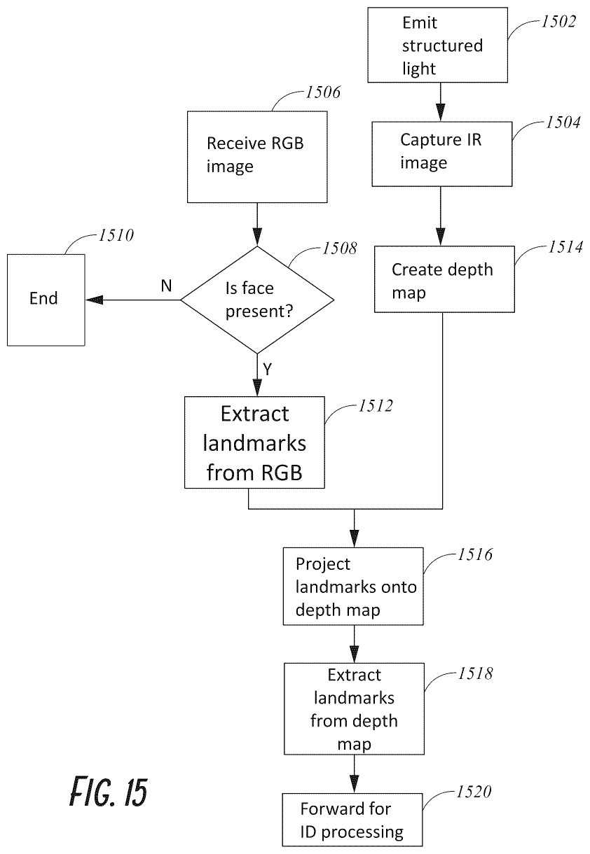

An exemplary method that can be used to incorporate both 3-D imaging and RGB imaging in a facial recognition system is illustrated in FIG. 15.

In step 1502, IR laser projector 504 may emit structured light, or unstructured general IR illumination. In step 1504, the effect of that light is captured by IR sensors 506a and 506b. At the same time, in step 1506 an RGB image is captured. In step 1508 that image is analyzed to determine whether a face may be present in that image. If no potential face is detected, then in step 1510, the process ends. If a face is detected, then in step 1512, facial landmarks are extracted from the RGB image captured in step 1506. In step 1514, the captured IR image is used to create a depth map. In step 1516, the landmarks extracted from the RGB image are projected onto the depth map created in step 1514. In step 1518, landmarks are in turn extracted from the depth map, using the landmarks projected from the RGB image to enhance accuracy. In step 1520 the landmarks so extracted are passed on for further processing and comparison with stored information about previously recognized faces.

Additional techniques may also be applied to detect attempts to spoof the system. Such techniques may include, analysis of whole-body data including height estimation and/or gait analysis. These approaches may permit the system to perform these additional verification steps “in the flow,” without requiring potential entrants to stand in place before a camera and/or sensor at close range. Other techniques that may require such steps include analysis of facial movements such as smiling and blinking. Another technique is to apply a combination of visible and infrared sensors to detect the unique characteristics of skin, such as subcutaneous veins. Such techniques and others can be applied individually, or in combination. Neural network analysis can be used to combine multiple sources of data with greater accuracy.

Another method according to the subject invention combines RGB and IR information to create a more detailed and accurate facial model.

Classification methods are used to process authentication and spoofing detection methods and determine if the person is authenticated successfully. This information is forwarded to a lock, login or any system requesting this type of information. FIG. 6 16 presents a block diagram of the technical workflow from RGB and depth data to output information “Successful ID or not” in an exemplary method.

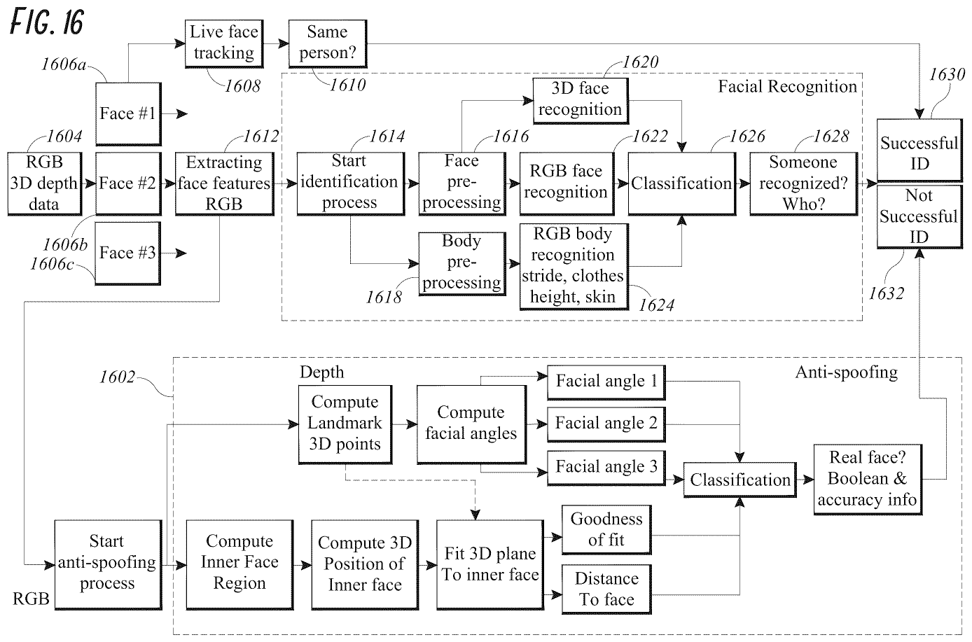

The portion of FIG. 16 enclosed in dotted line 1602 is essentially the same as is described in FIG. 13, and thus will not be described again here. In step 1604, preliminary processing on the RGB image is performed.

One aspect of preprocessing that may be performed is automated image adjustment of the captured RGB image. A common technique for performing this step is commonly referred to as Histogram of Gradient, or HoG processing. This is a method for expanding or compressing the contrast range of an image to fit the captured image to occupy the full potential dynamic range of the image. This form of image processing may be optimized for the entire captured image, or it may be based on the characteristics of a specific region of interest.

Other preliminary steps may include cropping the image around the detected face; matching the infrared and RGB images; determining if the captured images are clear enough to permit further processing (that is, considerations such as enduring that the image is not too blurred, and neither too overexposed or underexposed); and other potential checks on image suitability. Other pre-processing steps may also be employed to make subsequent processing more efficient. Similar steps may also be taken to pre-process whole-body images.

If multiple potential faces are detected and separated for processing in steps 1606a, 1606b through 1606n. To separate them, the proposed method ranks all detected faces from the most likely to go in to the least likely using three parameters: distance to the door, orientation of the face and position in the image. The following steps, illustrated only for one such identified face for simplicity, will be performed for each of them.

One aspect of the process is assuring that each face is properly tracked as people move within the field of view of the camera and/or sensors, at least until they have been identified. Thus in step 1608 each face is tracked, as described in more detail below. In step 1610 the system determines whether the tracking protocol is functioning correctly and the tracked face roughly matches the face previously matched to that moving image.

Separately, for a detected face, in step 1612, the features of the captured face are extracted. This process can combine data from both RGB camera and IR sensors. The extracted features may be applied to the FIG. 13 process as well. In step 1614, the process of identifying the specific person is initiated. In step 1616, pre-processing of the facial image is initiated. This pre-processing may comprise automated exposure adjustment of the captured RGB image, as previously discussed. This form of image processing may be optimized for the entire captured image, or it may be based on the characteristics of a specific region of interest.

Other preliminary steps may include cropping the image around the detected face; matching the infrared and RGB images; determining if the captured images are clear enough to permit further processing; and determining if the orientation of the subject's face will permit further processing. Other pre-processing steps may also be employed to make subsequent processing more efficient.

In step 1618, pre-processing of the captured images of the entire body of the selected person is initiated. This may consist of similar steps to those discussed above. Performing recognition of the body can be useful for a number of reasons. For example, if the system has learned through previous analysis that the face approaching the access point is attached to person who is roughly five feet tall, and the face being tracked appears to be attached to a person who is more than 6 feet tall, that can be an indicator of a spoofing attempt, or a reason to reject a specific identification. It is also possible to detect and analyze a person's gait, another distinctive biological trait that can be used to identify a user or detect spoofing.

In step 1620, the IR-based portion of the principal facial recognition process is performed. In step 1622, the RGB-based portion of the principal facial recognition process is performed. In step 1624, the principal portion of the body recognition process is performed. This process may include analysis of the person's body shape, clothing, height, stride, and other factors. In step 1626, the results of IR image facial processing, RGB image facial processing and body image processing are combined and weighted in so that a single profile of the person seeking admission is ready for evaluation. In general, face recognition will be weighted most heavily, followed by height, followed by other characteristics. In step 1628, the output of step 1626 is evaluated against the database of recognized users to determine if the person is recognized. If the person is recognized with a sufficient confidence level, then in step 1630, the access point is unlocked to permit entrance. If the person is not recognized as a permitted entrant, then in step 1632, the process ends without unlocking the entry point. Alternatively, if the person remains with view of the camera and sensors, additional images may be captured and analyzed. As an additional alternative, if a person is not recognized with a sufficiently high confidence level, the person can be prompted to present a badge to validate the identification.

In an alternative embodiment of the process illustrated in FIG. 16, steps such as computation of facial angles may be performed by a neural network without prior encoding of the characteristics of real faces vs. 2-dimensional representations.

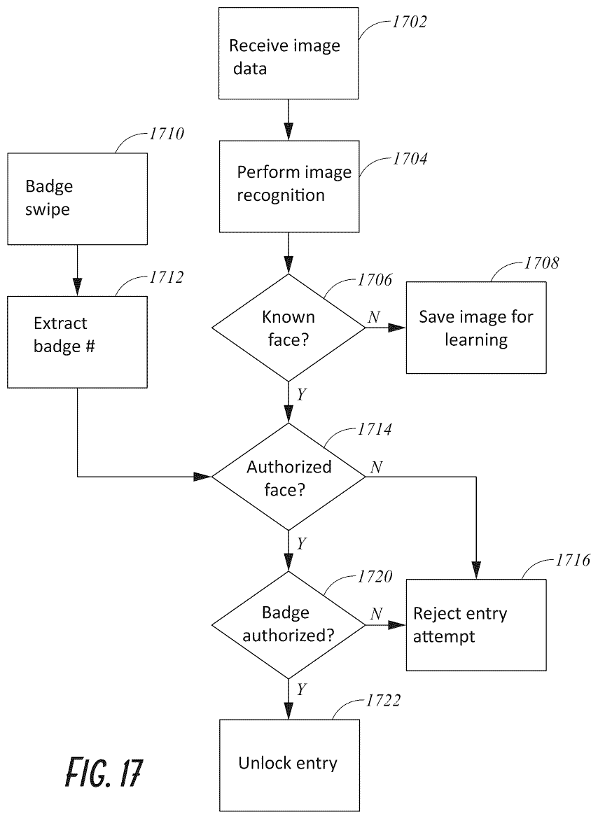

As described above, the subject invention may comprise the use of face recognition as the primary or only authentication tool in an access control system. However, it can also comprise a multi-modal system that combines face recognition with other technologies, including badge readers. FIG. 17 illustrates the high-level architecture of an exemplary system that includes both badge readers connected directly to facial recognition modules 500 and face recognition hardware and software. In step 1702 the facial image data to be evaluated is received. In step 1704 the image is processed for facial recognition. If the face is not recognized in step 1706, then in step 1708 the facial image is saved for a potential new identification, and no signal is sent to the door lock or turnstile, regardless of whether a valid badge is presented to the badge reader. In step 1714 it is determined if the identified face belongs to an authorized entrant. If not, then in step 1716 the entry attempt is rejected, and the access point does not unlock.

Separately, in step 1710 a potential entrant presents a badge to the badge reader 102 (or a badge reader incorporated into facial recognition module 500). (The badge swipe can occur before, during or after image capture and processing.) In step 1712, the badge number is extracted from the badge reader. In step 1720, the badge number as extracted from the presented badge is compared to the badge number associated with the identified face. If the two badge numbers do not match, then the process ends without unlocking the access point. Optionally, the system may record the unsuccessful attempt, send an alert, flag the record of the badge number for review, or some other means of acting on the failed attempt. If the badge numbers do match, then in step 1722, the system sends an unlock signal to the access point.

It should be noted that some or all of the steps described as taking place within the facial recognition module can instead be undertaken by a central processor or control access panel communicating with a plurality of facial recognition modules.

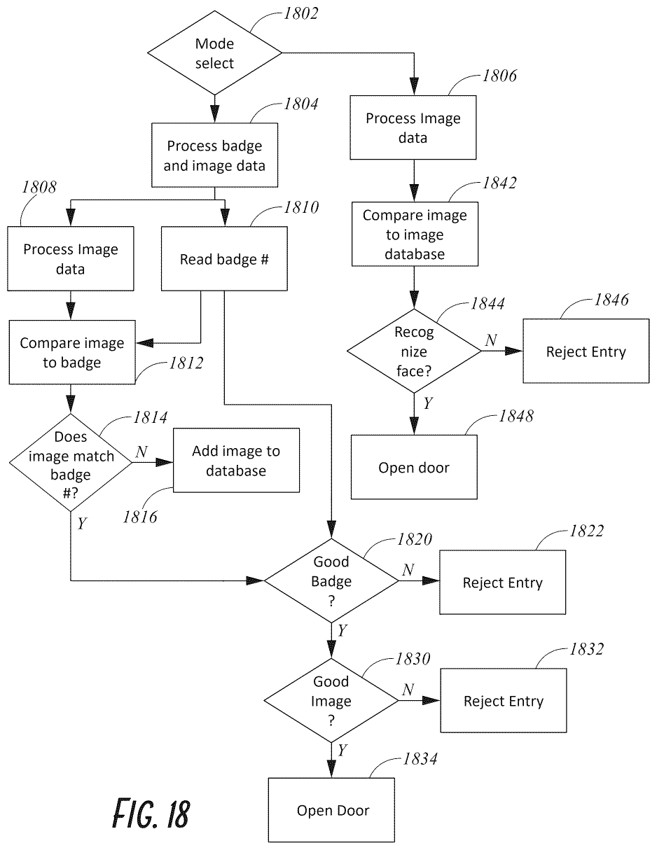

The operation of another exemplary system is described in FIG. 18.

In step 1802 it is determined which of several possible modes of operation is to be used. If both facial recognition and badge numbers are to be used, the process starting with step 1804 is followed; if facial recognition-only is applied, the process starting with step 1806 is followed. (It is also possible to operate in badge-only mode, in which case the steps shown in FIG. 18 will not apply.)

In step 1808 the facial image data to be evaluated is evaluated and the person is identified. In step 1810 the presented badge is read to extract the badge number. In step 1812 the badge number and identity of the person in the facial image are compared. In step 1814, the system determines how to act based on that comparison. If the captured image and the badge number do not agree, then in step 1816, the image is added to the image database. If the badge number and image agree, then the process advances to step 1820.

The process of choosing when to add images to the database may depend upon the level of training the system has reached with a given user. For example, if the database includes fewer than a set number of stored images of a user, the system may store each captured image above a certain quality threshold until the set number of stored images is reached. After that number of images has been stored, the system may first compare new images to stored images, and either add the new images if they are of higher quality than the previously stored images, or present usefully different images, such as from different angles, or different lighting conditions, or the like.

In step 1820 the badge number as read in step 1810 is evaluated. If the badge number is not authorized for entry, then in step 1822 entry is denied. In step 1830, it is determined whether or not the image is of sufficient quality to support identification. If quality is insufficient, then in step 1832, entry is denied. If quality is sufficient, then in step 1834, the door or other access control apparatus is unlocked.

If the system is operating in facial recognition-only mode as determined in step 1802, then in step 1806, the captured facial image is process for recognition. In step 1842 the processed image is compared to the database of images. In step 1844 it is determined whether the image matches an authorized entrant. If not, then in step 1846, the entry attempt is rejected. If it does match, then in step 1848 the system either sends the appropriate signal to access control panel 100, or directly triggers the door to unlock, depending on the implementation.

For any security system there are tradeoffs between speed and convenience on the one hand, and accuracy and security on the other. When a facial recognition system is new, or when a new user is presented, the system has not yet accumulated a library of captured images to which the new image may be compared. Accuracy generally requires multiple captured images. Thus an image-based systems will either be slow and inconvenient (requiring a user to present him or herself for multiple image captures before gaining entrance), or insecure (by setting a low threshold for admission until an adequate library has been developed), or both.

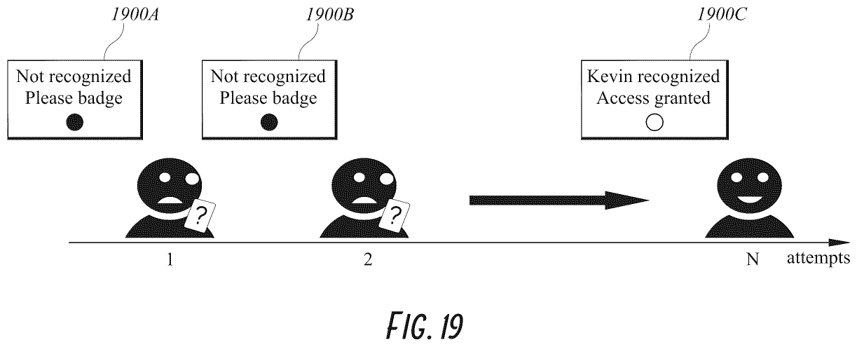

Another great improvement proposed is a badge learning method. Standard biometric systems request the user to perform an additional out of norm registration process to be included in the system and user setup. With the proposed technique, users can keep their existing badges. No more specialized enrollment needed. The first time a user approaches a physical access point, their badge is scanned and pictures of the person are bound to their badge ID and stored in the system to train the recognition algorithms. Even if the person is recognized, the system waits until enough data is present to reach a very high accuracy before switching to full facial authentication. When this accuracy is reached, the person can go in and out using only their face. This badge learning concept is illustrated by blocks 1900A, 1900B, and 1900C of FIG. 19.

In block 1900A, a potential entrant approaches a controlled access point for the first time (or the first time after the installation of the facial recognition system). Because the person is not recognized, a badge swipe is required in order to gain entrance. In in block 1900B, the potential entrant seeks entrance again, having previously done so a small number of times. The facial recognition system has not yet built up a sufficient library of images to permit badgeless entry, and again requires a badge read. In block 1900C, the facial recognition system has built up a sufficient number of images that it is able to recognize a specific user (here called “Joe”) and permits him to enter without having to badge in.

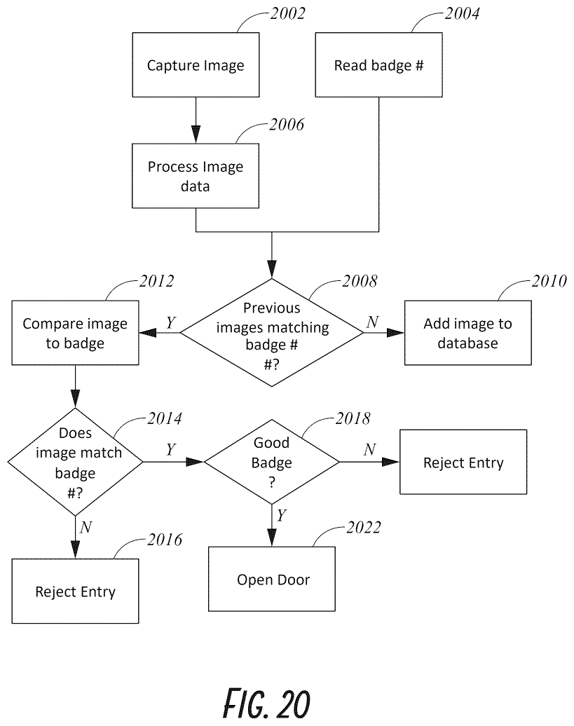

A system that combines badge readers and facial recognition modules permits the facial recognition system to learn by pairing the unique identifier of a user's badge with that user's facial images. FIG. 20 is a flowchart describing the steps involved in an exemplary process to employ a system that includes badge readers to train the facial recognition system.

In step 2002, a facial image is captured. (It should be noted that it is also possible for facial recognition module 500 to capture and process a series of images in a single physical approach by a potential entrant; for simplicity, a single image is discussed.) In step 2004, the potential entrant submits a badge to the badge reader and the badge number is extracted. In step 2006, the image is processed for facial recognition. In step 2008, it is determined whether the system has stored other images associated with the badge number. If not, then in step 2010, the image is stored. If other images associated with the badge number have been stored, then in step 2012, the new image is compared to the stored images, and in step 2014, it is determined whether the match is close enough to conclude that the same person is presenting the badge as in previous attempts. It is likely to be desirable to employ a form of dynamic scoring, such that for a new installation, a lower confidence level is required than in a mature system, and so that a lower confidence level is required the second time a specific badge number is presented compared to the fiftieth time. Another approach to dynamic scoring is to condition the system's response based in part on the level of confidence in a given instance of facial recognition. For a high level of certainty of a match with an authorized entrant, a badge swipe may not be required; for a high level of certainty that a person is not an authorized entrant, even a badge swipe may not result in admittance. For a low-confidence identification, the person may be allowed in if the badge swipe corresponds to the tentative identification. If a match is not indicated, then in step 2016, the entry attempt is rejected. If a match is indicated, then in step 2018, it is determined whether the badge number presented indicates permission to enter at that entry point. If the badge number does not have permission at that entry point, then in step 2020 the entry attempt is rejected, and the door does not unlock. If the badge number does have the requisite permission, then in step 2022 the door is unlocked.

Once a system that includes both badge readers and facial recognition modules has accumulated a sufficient number of images of a given user, the system may be used so that facial recognition alone is sufficient to gain entrance to a building, and employees may not be required to use the badge reader to gain entrance (except when the facial recognition process results only in a low-confidence identification). This method will reduce friction at access points. Ideally, it will permit a user to enter as if the security system was not there—there will be no need to stop or slow down or stare into the camera and/or sensor unnaturally.

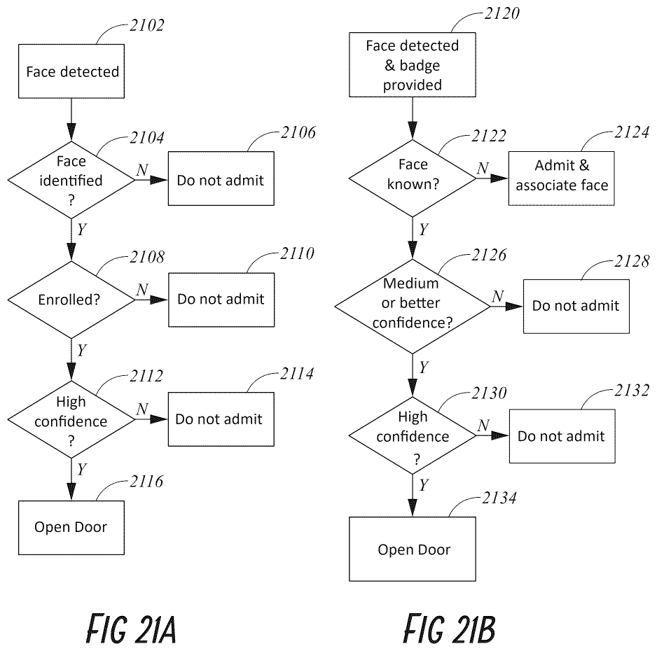

Additional approaches to learning are described in FIGS. 21a and 21b. FIG. 21a illustrates an exemplary process for learning using only facial recognition (that is, without matching up the user with a badge number). This learning process is applied to every new user to be included in the database. Several users can be totally enrolled while others are just starting the process. Any new person will have to complete this process to unlock full functionalities. In step 2102 a face is detected. In step 2104, it is determined whether that face can be identified. If not, then in step 2106 the access point is not unlocked. (If a user subsequently provides an authorized, badge, the person can enter.) If the face is identified then in step 2108 it is determined whether or not the identified person is authorized to enter at the access point. If the person is not authorized (either because the person is not recognized, or because the system can tentatively recognize the person, but has not accumulated enough images of the person to provide sufficient confidence in the identification), then in step 2110 the access point again is not unlocked based on facial recognition. If the recognized face is associated with an enrolled account, then in step 2112, it is determined whether the confidence level in the facial identification is above a set threshold. If it is not above the threshold, then in step 2114 the access point again is not unlocked based on facial recognition. If the identification is above the threshold for a high-confidence identification, then in step 2116 the access point is unlocked.

FIG. 21b illustrates an exemplary learning process that includes both facial identification and (roughly) simultaneous badge read. In step 2120, both the badge read and facial image are input. In step 2122 it is determined if the captured image matches an authorized face in the database with very high confidence. If so, then in step 2124 the person is admitted, and the face is associated with the submitted badge number. If not, then in step 2126, the level of confidence in the facial identification is evaluated. If the confidence level is low, then in step 2128 the entry attempt is rejected. If the confidence level is at least above a set level, then in step 2130 the identification is again evaluated. If the identification does not meet a required level of confidence, then in step 2132 the attempt is again rejected. If it does meet the minimum requirement, then in step 2134 the door is unlocked.

It should also be noted that the subject invention contemplates not only a system that captures and stores images as images, but a system in which the images are processed to extract key aspects of the images, and only that information, which may be thought of as metadata, is stored. Such metadata may be based on aspects of the images such as depth information about the face, the size and shape of and distances between key landmarks (eyes, nose, mouth, etc.) or other descriptive and/or distinctive aspects of the image. An advantage of converting images to such metadata and storing the data that way is that the images are effectively encrypted in that form, and thus the images and associated data stored in the system are likely to be useless to a hacker even if the data is somehow extracted from a facial recognition module. Additionally, more and more countries are creating minimum regulatory thresholds for security and protection of personal identifiable information (PII). By storing abstract metadata, the system avoids storing PII.

Different methods of controlling access to a secure building or area can create vulnerabilities that malicious persons could use to gain access. An additional concern with an access control system that uses computers and stored data is that the computers, and the data stored on them become targets for hacking as well. If a computer system includes personally identifiable information, or PII, that increases their attractiveness as targets, and the damage that could be caused by an intrusion. These issues are particularly concerning when security systems operate using a public “cloud” for the storage and transmission of sensitive data.

It is therefore desirable to implement an access control system that enhances the separation between PII about building entrants and the systems used to admit them. Thus another aspect of the subject invention is that it may be implemented so that the access control system does not know the identity of recognized users beyond their badge numbers (which are generally encrypted), plus highly abstracted metadata about their faces. Thus there is little or no value to a malicious actor to the data stored on the systems used to perform facial recognition. Thus a system according the teachings of the subject invention may operate without any PII other than the badge number of a user.

The process of curating images relative to single user is intended to maximize the probability that the system will be able to quickly recognize that user. Thus while the initial emphasis is on accumulating multiple images of at least a minimum acceptable quality, once a minimum number of images has been collected, the goal becomes maximizing the quality of those images. A variety of weighting heuristics may be employed to optimize the image library. Thus weight may be given to the quality of the images; to how recent those images are; to ensuring that images from a variety of lighting conditions (such as early morning, midday and evening); or to other factors such as facial expression, degree of blur, etc. As the system acquires new images that are determined to be of higher quality than similar previously stored images, the old images may be purged in order to reduce memory and storage requirements. The system may also store multiple sets of images for different “looks” for a user, such as winter clothing vs. summer clothing; bearded vs. shaved faces, etc. Images may also be categorized by the orientation of the face relative to the camera and/or sensors.

This embodiment may also be used to implement a longer-term two-factor authentication system. In other words, users may be required to both run their badges through the badge reader and be recognized by the facial recognition system.

One such approach is to apply the facial recognition as described herein, and apply the user's badge as a secondary check that is informed by the results of the facial recognition process. Thus if facial recognition results in a high level of confidence that an entrant is a specific approved person, the system can either admit that person without requiring a badge, or use a badge swipe as secondary confirmation depending on the level of security desired by a specific facility. If facial recognition results in an identification that falls below a specified level of confidence, the system can require a badge swipe in order to open the door or unlock a gate or turnstile, etc. Finally, if the prospective entrant is not recognized, is recognized as a (specific) non-authorized person, or if the recognition falls below the specified threshold, and the user either cannot produce a badge, or provides a badge that does not correspond with the identity of the person as determined by facial recognition, the person can be denied entry.

As previously discussed, an objective of the subject invention is to enable authorized persons to enter an access-controlled area with little or no friction. In order to accomplish this, the invention also comprises methods for recognizing authorized entrants without requiring them to alter the normal process of entering a space as if access was not controlled. This requires that the facial recognition module, and the image processing software that is used on the images captured by the module, need to be capable of recognizing faces while people are in motion.

A user starts approaching a door with the intent to enter. By the time he reaches the door the authentication and anti-spoofing are already done and the door is unlocked. The main goal is removing the user interaction with the security system. In most cases, the user should not notice the security checkpoint.

Quick in-motion detection is key to user experience. While a user is approaching the door, the proposed system starts processing his face at around 3 m distance.

As the person gets closer, the accuracy of the data and the authentication improves. The system is able to process many views (from different distances) of the person before he arrives at the door. As the person gets close to the door, the authentication algorithm would have checked all parameters and determined if the person is authorized to go in. If yes, the door is unlocked before the person reaches the door. If not, further info is displayed on the module's screen.

The user is simply approaching the access point (from top left to bottom right). The proposed authentication method starts capturing and processing facial data when user is close enough and within the field of view (FOV).

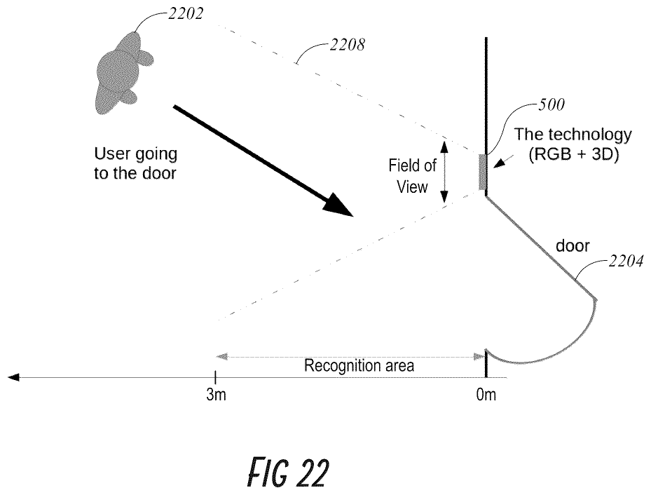

FIG. 22 provides a visual of this concept.

A potential entrant 2202 walks toward an access-controlled door 2204. Facial recognition module 500 is mounted on the wall near door 2204. The cameras and sensors mounted on facial recognition module 500 each have a specific field of view 2208, sometimes expressed as an included angle. They will also have a specific range beyond which a face, even if detected, will not be captured with sufficient resolution to enable accurate recognition. And although it is not necessary for a person to be looking directly at the camera or sensor for facial recognition to be performed using the subject invention, the divergence of the orientation of the face from the camera and sensors does have limits—the person cannot be facing 180 degrees from the camera and sensor. In some implementations, a divergence of greater than about 45 degrees may render facial recognition unreliable. Together, these factors mean that there will be a relatively short interval during which a face must be found and recognized in order to permit “in the flow” permissioning.

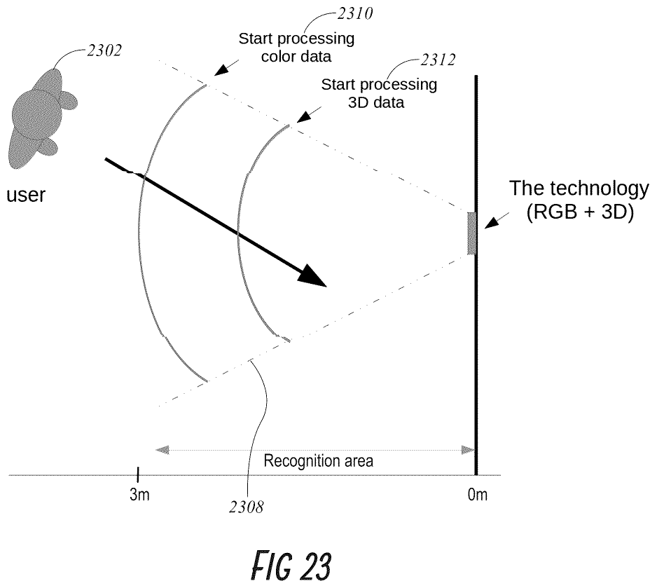

The final user experience target is “In the flow”. The user does not have to be aware there is an identity control during normal operation. When a user is approaching the door, if he is recognized and authenticated, the door is unlocked and no additional user interaction is required. If not, the user interface will request the user to badge in. FIG. 23 provides a simplified representation of the setting.

A potential entrant 2302 walks toward facial recognition module 500, which is mounted on the wall near an access-controlled door (not shown). The cameras and sensors mounted on facial recognition module 500 each have a specific field of view 2308. The capabilities of facial recognition module 500 are partially dependent on the distance between potential entrant 2302 and facial recognition module 500. When potential entrant 2302 enters the region defined by field of view 2308 and the range at which RGB camera 502 is capable of capturing potential entrant 2302 with sufficient resolution 2310, facial recognition can begin. When potential entrant 2302 approaches further, and reaches the region defined by field of view 2308 and the range at which infrared sensors xxx are capable of capturing potential entrant 2302 with sufficient resolution 2312, anti-spoofing processing can begin.

Unless done extremely efficiently, “in the flow” facial recognition requires considerable computational power, and requires processing a large number of large image files. An aspect of the invention is a method for optimization of the process of finding, tracking and identifying faces in order to reduce computational load and thereby both speed up identification and make it possible to perform the required process using relatively inexpensive microprocessors.

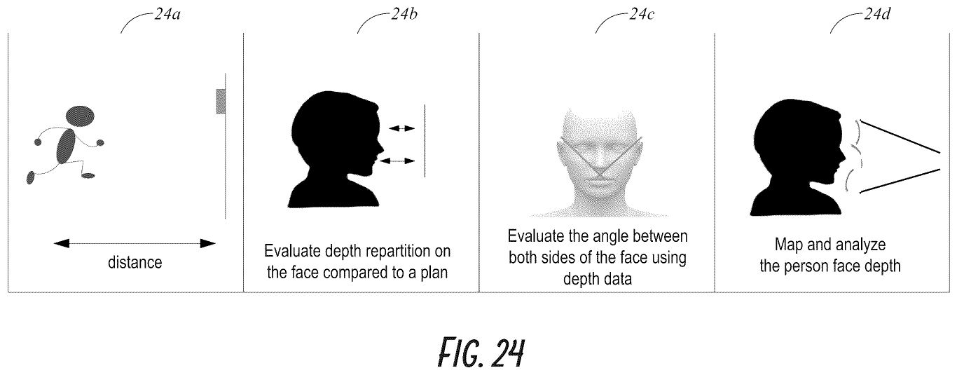

The first method is checking the distance of the user to the sensor. If the sensor is far away from the person, the data accuracy will be reduced. Second method is checking if the face depth map fits a plane or if there are any 3D variations in it. Third method measures multiple physical angles between both sides of the face and uses this angle value to determine potential spoofs. A real face will be around 60 degrees when a piece of paper will be close to 180 degrees. Finally, another approach is to analyze the 3D mapping of the face and compare it to our facial print dataset to determine if it matches a generalized face model. FIG. 24 with visuals 24a through 24d presents visuals of those four main parameters and methods, which can be run sequentially or in parallel.

In visual 24a, a person potentially seeking entrance to a restricted access area gets close enough to facial image recognition module 500 for a useful image to be captured. In visual 24b, the person has approached to within adequate range to perform facial recognition, and the facial recognition program performs an initial evaluation to determine if a human face is being presented. In visual 24c, depth-based facial recognition may be performed including measuring angles presented by the presumed face. In visual 24d, the full 3-D map of the face in the captured image is compared to those in a previously collected facial image database and/or to the two-dimensional image to confirm that features extracted from the 2D image correspond to features in the 3D image.

FIG. 25 is a high-level flow chart illustrating the steps involved in an exemplary efficient facial recognition process. In step 2502, RGB camera xxx captures an image of the entire field of view of RGB camera 502. In step 2504, the captured image is analyzed—not (initially) for purposes of determining who is there, but simply to determine if the captured image includes a person, and if so, where in the captured image the person is. This is a computationally simpler task, and can be completed relatively quickly. This step can consist of searching for a face, or it can consist of searching for a shape likely to be human body. In step 2506 it is determined whether or not a person appears to be present. If no face or body is detected then the process loops until a face is detected. When a person is detected, the region of interest, or the portion of the field of view that contains the image of interest (the face) is defined in step 2508. This region can be of virtually any appropriate size. In the currently preferred embodiment, it can be as small as 120 pixels by 120 pixels. In step 2510, a subsequent RGB image is captured, and the image region defined in step 2506 is analyzed to determine if the person has moved, and if so, in step 2512 the amount of movement is estimated. This process can be computationally intensive, so the load on the processor is reduced by limiting the analysis to the previously defined region, or a region slightly larger to accommodate potential motion. If the person is determined to have moved in 2514, then in step 2516 the defined region of interest is adjusted accordingly. A variety of techniques may be used to track one or more objects of interest. One such method is known as Kalman Filtering. This approach uses a series of measurements observed over time, which may contain inaccuracies such as noise and other errors, and produces estimates of unknown variables or states. A dynamic model is created that, based on a set of initialized states, compares the predicted output of the model to the actual measurement of the object of interest. The delta, or difference, between the measured value and the predicted model is used to adjust the model state values. In this way the object is “tracked”. However a variety of methods can be used to detect movement and track changes in the region of interest. In step 2518 the defined image region is processed in order to recognize the captured facial image. In step 2520 it is determined whether the system recognizes the analyzed face. If the face is not recognized, then steps 2510 through 2518 are repeated. If the face is recognized, then in step 2522 the images captured by the IR sensors are analyzed. Tracking may continue the entire time a given human figure is within view of the camera and sensors. The system may also attempt to locate a person who has moved out of view of the camera and sensors for a period after the last “sighting,” and attempt to match images taken before the “dropout” with those take after.

It should also be noted that the processes described herein may in some circumstances exceed the capabilities of processor 510 if pursued simultaneously. It may therefore be advantageous to provide the system with heuristics that prioritize tasks so that less essential tasks can be skipped. Thus for example, if the system is tracking multiple people approaching an access point, various processing steps may have to be performed on only every 2nd or 3rd captured image of each person, rather than on all captured images.

In step 2524 the images captured by the infrared sensors are analyzed to determine whether the image is an actual person, or a spoofed image such as a printed photograph or tablet computer. As in step 2508 above, the analysis of the infrared images is restricted to the defined image area in order to reduce computational load. If the analysis of the infrared images determines that the captured image is not spoofed, then in step 2526 the positive and validated identification is passed forward, either to trigger unlocking of the door or otherwise. If the image is determined to have been spoofed, then in step 2528 no action is taken to unlock the entrance. In addition, in certain implementations the system may send a notification of the spoof attempt, record the images associated with the step, or both.

FIG. 26 illustrates an exemplary optimization method that can be used by the subject invention to reducing processing load by restricting the portion of the captured image to be analyzed. Once a human form 2602 has been found, and a face 2604 has been located, region of interest 2606 is defined such that it includes the located face plus a margin of error, to make it more likely that, even if the subject is moving, the next captured image will still contain most or all of the face.

Alternatively, the invention can used to detect an area of an image likely to contain human skin, and based on the assumption that a face will generally be located somewhere above that area of skin, focus efforts to locate a face in that region.

In another embodiment, the invention also comprises methods for preventing unauthorized persons from entering a controlled space by following an authorized person, also known as “tailgating.” Tailgating is a way of gaining entrance to a restricted area by walking in behind an authorized person (whether or not the authorized person is aware someone is behind them). Social conventions tend to pressure the authorized person to hold the door open to be polite, even if they are not sure they even know the person behind them, thereby enabling an unauthorized entry.

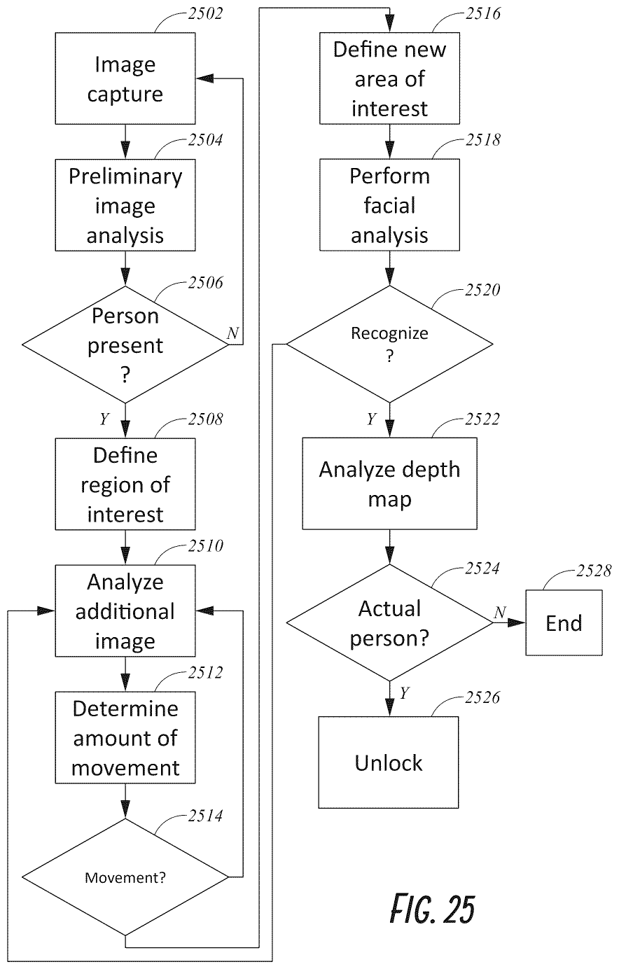

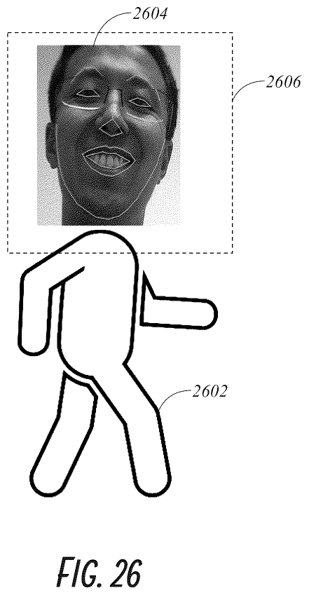

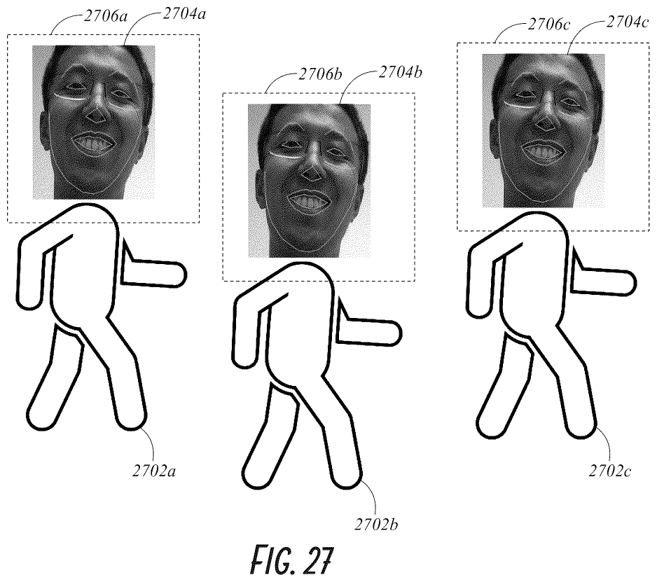

Because the facial recognition module is capable of detecting multiple potential entrants simultaneously, an aspect of the subject invention is that it can significantly reduce or even eliminate the possibility of tailgaters entering a controlled space. FIG. 27 illustrates how the subject invention can be used to detect multiple potential entrants simultaneously. Facial recognition module xxx may find multiple humans 2702a, 2702b through 2702n in the vicinity of the controlled access point. Image processing permits the facial recognition module 500 to detect each such human form, their associated faces 2704a, 2704b through 2704n, and define regions of interest 2706a, 2706b through 2706n.

Once the system has determined that multiple potential entrants are in the vicinity of the controlled access point, the appropriate action to be taken can be set by policy. For example, if multiple people are approaching an access point and one of them is not authorized, or if one person's face is not visible to the facial recognition module, depending on policy, the door can be kept locked until everyone is authorized, or by asking for a second method of authentication, or an alert can be triggered. Other potential options are to open the door and notify security, to keep a log of each such unauthorized person (and admit both people, or not), or to admit the unrecognized person or persons and give the unrecognized person a timed window (of an number of minutes)—enough time to check-in and obtain permission to enter in another form, such as from an attendant in a lobby. If the unrecognized person does not do so within the permitted interval, a notification can be sent to building security or another designated responder.

Receiving real-time authentication data from a single or multiple connected units, it is up to the administrator's policy to decide how to enforce physical access control and notifications based on anti-tailgating. For example, if multiple people are approaching an access point and one of them is not authorized, depending on policy, the door can be kept locked until everyone is authorized, by asking for a second method authentication. The admin has the option to also open the door and notify security, keep a log of the unauthorized person or give that person a timeout of 5 minutes, enough time to check-in at the lobby. If this action is not completed, a notification is sent.

Real world use case of the technology includes multiple people approach and authentication. The technology handles this by processing all incoming pictures simultaneously. Each face is processed as a separated input and prediction is generated before the group reaches the door.

FIG. 28 is a flowchart describing high-level exemplary steps that may be used to determine the appropriate action when multiple potential entrants are detected. In step 2802, the RGB camera captures an image. In step 2804, processor 510 analyzes the image. If in step 2806 only one person is found in the image, then the anti-tailgating process loops back to step 2802. If facial recognition module 500 determines that more than one person is within a specified distance from the entry point, then the anti-tailgating process continues, and in step 2808 it is determined whether all persons determined to be within the defined distance have been identified. If all persons determined to be within the defined distance have not been identified, then in step 2810, the system performs the previously specified anti-tailgating response. Potential anti-tailgating responses may include one or more of: not unlocking the access point until any unidentified persons have left the specified area; unlocking the access point, but triggering an alert, or logging the tailgating event, either when denying entry or after allowing it.

If all persons within the defined distance have been identified, then in step 2812 it is determined whether all of those persons have the requisite permission to access the controlled entrance. If they do, then in step 2814, the access point is unlocked. If not all persons have the requisite permission, then in step 2816, the system performs the previously specified anti-tailgating response. Potential anti-tailgating responses may include one or more of: not unlocking until any unidentified persons have left the specified area; unlocking the access point, but triggering an alert, or logging the tailgating event, either when denying entry or after allowing it.

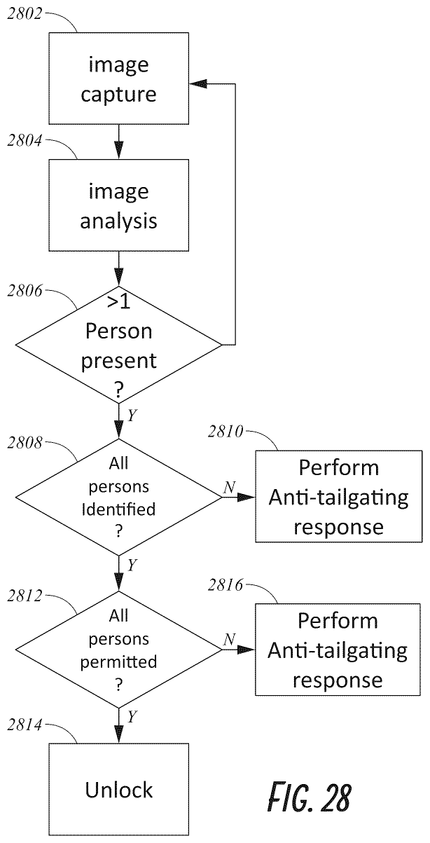

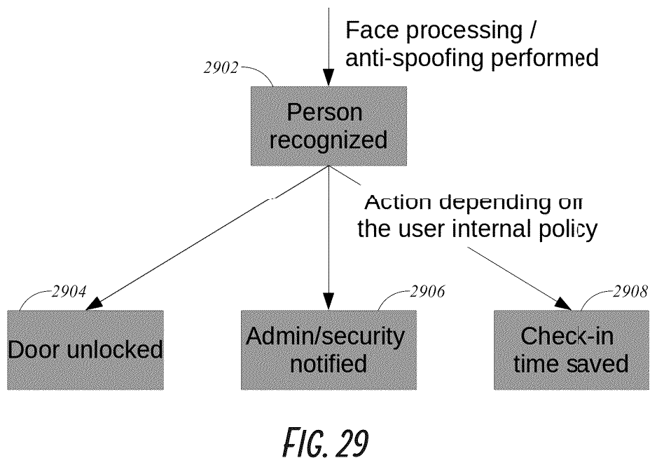

FIG. 29 presents options that can be followed in the event tailgating is detected. If a tailgater is detected 2902 following an authorized person, a definable administrative policy can automate one or more of unlocking the door 2904 (or not unlocking it), notifying an administrator or building security 2906, and logging the time of the event 2908.

Another aspect of the invention is the process for generating, evaluating and storing useful images of potential admittees in order to improve accuracy and reduce friction. In a real sense, a facial recognition system does not actually recognize faces; it simply confirms or rejects the possibility that the image it is evaluating is a “close enough” match to one or more images stored in a library of images. Thus it is very important to curate that library in order to ensure that it contains high-quality images that will best support the evaluation process. When a priority for the access control system is to enable authorized admittees to minimize interaction with the system that means that the system will ideally be capable of validating users even if they are not facing the camera and sensors, or if their features are partially blocked by clothing, glasses, facial hair, etc.

Facial recognition requires a lot of pictures of the same user to be efficient. This proposal replaces traditional biometric registration process with learning through the normal user badging process. Each person receives a badge and uses the system like a traditional badge-controlled access point. The first time the user badges in by the door, multiple facial scans are stored in the system and a new 3D face model is built. The badge number is binded to the facial data. The system outputs a badge number as normal When the system has enough data to have a high confidence on the recognition, it will recognize the user with enough precision and the badging will not be required any more. Usually this method requires one badging interaction. This approach removes all registration and setup steps which are time consuming. In addition, all facial data captured and stored will be under the normal usage conditions which would provide better facial recognition accuracy.

The facial recognition method uses previously stored RGB, infrared, and depth pictures of the same person to generate the model for matching. The model and the recognition accuracy is also improved over time as each user uses the system more. This training throughout several days allows the system to become robust to personal and external changes.

Here is a non-exhaustive list of the fluctuating parameters which are affecting the recognition accuracy but improved with continuous learning:
Clothes
Makeup
Haircut and beard (hiding one portion of the face)
Facial expression (tired, smiling . . . )
Position of the face compared to the module (right, left angled, portion hidden by something else)
Distance from the module
Speed of the person
Movement
Lighting Conditions

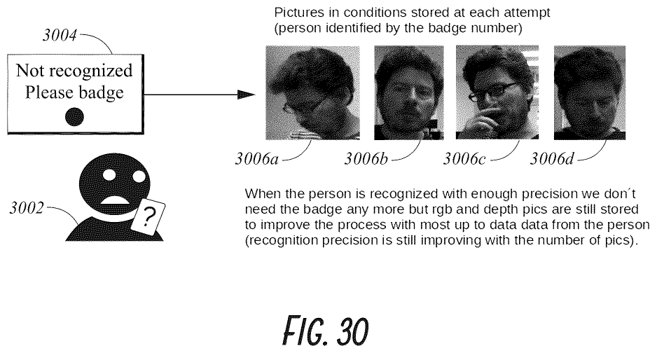

FIG. 30 illustrates how a library of images increases the likelihood of correct facial identifications. When an unidentified person 3002 approaches a facial recognition module, at least one image is captured. Assuming that the captured image or images are “good enough,” and that the person presents a badge 3004, facial recognition module 500 compares the captured image to stored images 3006a, 3006b, 3006c through 3006n associated with that badge number. The more images the system accumulates, particularly including a variety of facial expressions and of angles relative to the camera and sensors, the better the chances of accurate identification. The higher the quality of the images the system accumulates-that is images in which most or all of the face is visible, well lit, and generally facing toward the camera, the better the chances of accurate identification. The system will keep learning the person's face even if the person is fully enrolled. This continuous learning improves accuracy because someone's appearance changes over the time.

In some embodiments, the invention also comprises systems and methods for coordinating and sharing data regarding authorized entrants across multiple devices and multiple entry points. In a multi-entrance context such as a building or campus with multiple entry points, a user may generally use a single entry point, and thus that entry point may accumulate a large number of images of that user. When that user approaches a different access point (assuming it is also a permitted entry point), that user will expect the system to recognize her. This can be accomplished by sharing images (or the metadata extracted from them) between access points.

The proposed technology can be deployed self-contained or connected to multiple units. One of its key features is synchronized learning within a group. Groups can be configured and defined based on the company, facility, location, etc. All data recorded at any of these access points within the group using the technology will be aggregated and shared to provide a more complete dataset of face models. If a person is registered and recognized at a door, all other doors within the same group will be able to recognize him without additional learning.

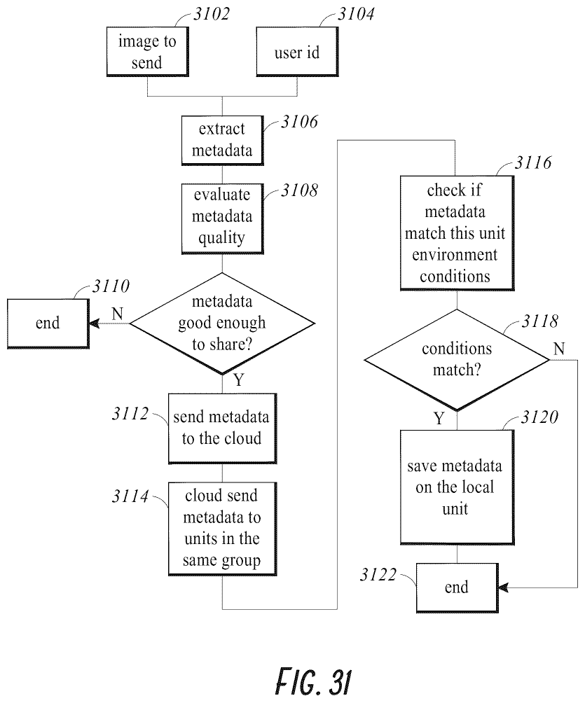

FIG. 31 illustrates an exemplary method that can be used to share recognized faces among multiple access points. In step 3106, metadata is extracted from image 3102 and paired with user ID 3104. The metadata may include, but is not limited to characteristic facial landmarks, angles, skin luminosity, etc. In step 3108 the metadata is evaluated for quality, so that only information that will likely be useful for future recognition interactions is shared. If the extracted metadata is of insufficient quality, then in step 3110 the process ends. If the extracted metadata is of sufficient quality, then in step 3112 the metadata is transmitted to a server in the cloud, and in step 3114 the cloud server in turn sends the metadata to other relevant facial recognition modules. (Relevant modules may be those located at other entrances to the same building, other entrances within a campus, or may be defined in another way.)

In step 3116 a receiving facial recognition module determines if the received metadata matches the environmental conditions affecting the receiving module. For example, if the metadata was generated from an image captured in bright sunshine, creating a very high-contrast image with deep shadows, and the receiving module is located indoors where lighting is always even, producing low contrast, the received metadata may not increase the accuracy of recognition by the receiving module. If the environmental conditions are similar enough, then in step 3120, the metadata is saved by the local unit. If not, then in step 3122, the process ends without saving.

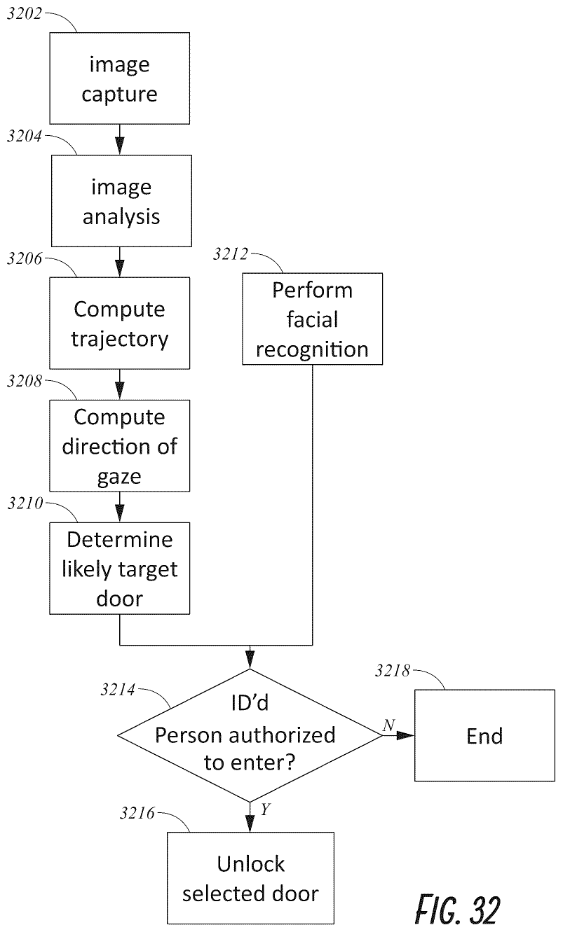

Another challenge for an access control system that is designed to minimize friction and required interaction may arise in a context in which multiple access-controlled doors are relatively close together, such as in a hallway. In some contexts, it will be inappropriate or prohibited to simply open all such doors when a person who is to be permitted access to only one of those doors approaches. Opening multiple doors unnecessarily may also create security vulnerabilities—a person not in view of the facial recognition module may be able to enter undetected. In another embodiment, the invention also comprises systems and methods for determining, in the case of a location with a plurality of separately controlled entry points, which of those entry points a user seeks to enter. By capturing and analyzing the trajectory and gaze of the potential entrant, the subject invention may be used to predict the door the user seeks to enter, and unlock only that door. FIG. 32 is a flowchart describing the steps of a high-level exemplary method for selecting which of multiple doors should be opened.

In step 3202 an image of the potential entrant is captured, and in step 3204, the image is processed. (In an actual implementation, a series of images may be captured and analyzed, but for simplicity a single image capture is described.) In step 3206 the trajectory of the potential entrant is calculated; in step 3208 the gaze of the potential entrant is analyzed. In addition to these steps, the direction in which the potential entrant is facing may be analyzed, and other indicators of intent may be detected. In step 3210 these inputs are used to extrapolate the likely door the person is approaching.

Separately, the detected face is used to perform facial recognition 3212 as described previously. In step 3214, it is determined whether the identified person is authorized to enter the door the person is approaching. If so, then in step 3216, that door is unlocked. If not, then in step 3218 the process ends without unlocking a door.

In practice, it may be advisable to perform the predictive steps 3202 through 3210 iteratively, so that the accuracy of the prediction improves both with more data and as the user gets closer to the intended door. When multiple people are in a multi-door environment, all of them may be separately tracked, both for intent (in order to decide which door or doors to open) and for anti-tailgating (to make sure only authorized people enter each door).

A related problem for a facial recognition-based access control system is that it will not always be the case that a person who is near an access-controlled entry point will actually intend to enter. People may congregate near a doorway, sit outside or otherwise be in the vicinity without actually intended to enter. Thus it will be advantageous to be able to only open the access point if the recognized person manifests an intent to enter. In another embodiment, the invention also comprises systems and methods for detecting whether a person in the vicinity of an entry point intends to enter.

The proposed technology is currently able to detect and recognize people 3 meters from the sensor. This can be concerning if an authorized individual is walking in front of the entrance but not planning to go in. For example, in a hallway, a person can pass several entrances before going through one. Only intended doors must be unlocked for security reasons.

The proposed module includes facial and eye analysis to detect if the person is specifically gazing in the direction of the door. If this condition is met, the unlock mechanism will be activated. If gaze towards the general direction of the sensor is not detected, no action is taken. The system combines the “in the flow” target by not asking the user to do anything specific and the intent detection to unlock only requested entrances.

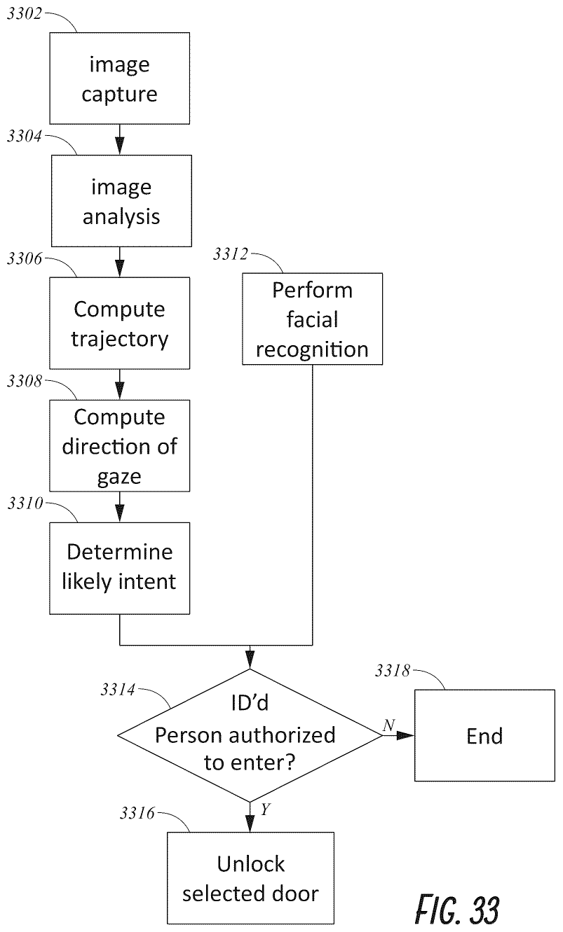

FIG. 33 is a flowchart describing the steps of a high-level exemplary method for determining whether a person observed by a facial recognition access control system intends to enter.

In step 3302 an image of the potential entrant is captured, and in step 3304, the image is processed. (In an actual implementation, a series of images will be captured and analyzed, but for simplicity a single image capture is described.) In step 3306 the trajectory of the potential entrant is calculated; in step 3308 the gaze of the potential entrant is analyzed. In addition to these steps, the direction in which the potential entrant is facing may be analyzed, and other indicators of intent may be detected. In step 3310 these inputs are used to produce a probability that the person intends to enter the access point.

Separately, the captured image is used to perform facial recognition 3312 as described previously. In step 3314, it is determined whether the identified person is authorized to enter the door the person is approaching. If so, then in step 3316, that door is unlocked. If not, then in step 3318 the process ends without unlocking a door.

In practice, it may be advisable to perform the predictive steps 3302 through 3310 iteratively, so that the accuracy of the prediction improves both with more data and as the user gets closer to the intended door.

In building security implementations that include multi-factor authentication, such as systems that include both badge readers and facial recognition modules, the subject invention can also be used to detect improper behaviors such as the use of an authorized badge by an unauthorized person, or an authorized person using a different authorized person's badge. A company may wish to restrict such practices in order to prevent employees from giving their badges to anyone else, to keep accurate track of which of their employees are in a facility, or for other reasons. Thus in another embodiment, the invention comprises methods for identifying people who attempt to enter a controlled space using an improper badge. FIG. 34 is a flowchart illustrating an exemplary process for detecting when a valid badge is presented by a person other than the person to whom the badge was issued.

In step 3402, facial recognition is initiated. In step 3404, analysis of the captured image is performed, and in step 3406 the analyzed image is used to attempt to identify the person. In step 3408, it is determined whether the person can be identified. If not, then in step 3410 the process ends. Separately, in step 3412 the presented badge is read and the ID number is extracted.

In step 3420, the recognized face and badge number are compared. If they do not match, then the process ends 3410 without unlocking the access point. If they do match, then in step 3422 it is determined whether the identified person is authorized to enter. If not, the process ends 3410 without unlocking the access point. If the person is authorized, then in step 3424 the access point is unlocked to permit entrance.

Additional variations are possible, including taking different actions depending on the confidence in a given identification, and adding a “maybe” step in which a potential entrant is neither accepted nor rejected, but has to provide additional input, such as providing better images by standing in front of facial recognition module 500.

The subject facial recognition system, like most or all neural network-based systems, requires training in order to develop the algorithms used to perform as intended. This requires that a large number of images of faces be presented and analyzed. In the currently preferred embodiment, much of this training is to be performed while developing the system and prior to deployment in specific installations, thereby significantly reducing the ramp-up period in an actual deployment.

In order to minimize both friction and inaccurate identifications, and to do so for people of a broad range of ethnicities, comprehensive libraries of images are very useful.

When a person walks by the door, the proposed technology starts looking for similar profiles in the database. To reduce the processing time and complexity, several external parameters are used to decrease the number of candidates. Here is a non-exhaustive list of possibilities:
Checking time: people are usually coming around the same hour and those profiles will be checked first when someone is coming by in the same time slot.
Recurrent groups: As people have routines, the proposed technology is also associating people who are usually coming together (same commute, team going out for lunch time, etc.). Those “associated profiles” will also be checked with priority if one of those individuals approaches the physical access point

To improve facial recognition, diverse pictures of millions of subjects are needed, with annotations to correctly identify same and different identities. To do that, an aggregation tool needed to be built, which downloads pictures of faces from social websites.

This dataset provides good quality images of people from different origins. This is especially useful for facial recognition as many social users have multiple pictures on their profiles, which allows the dataset to annotate same identity automatically. The following section details how these pictures from different websites are clustered and processed to identify pictures of the same person and decrease redundancies for algorithm training.

Traditional facial recognition methods are known to have higher accuracy on some types of faces while accuracy may decrease for others. In order to increase facial recognition speed and accuracy, the authors needed to collect millions of pictures from people from those specific ethnic origins.

RGB images can be collected in bulk using the above tool. One important requirement is to have the pictures annotated by name or profile, to identify faces correctly. If this information is not available, another method for identification is the proposed clustering method. We will consider that the dataset is preprocessed and includes only normalized face pictures (RGB or grayscale). We don't know who the subject of the picture is but we can assign person ID numbers. Annotation is the process of having a human review a captured image and associate an ID (name or badge number) with that image.

The technology for clustering is semi-automatic and aggregates all pictures from different origins to find reoccurrence of same individuals. Pre-processing is automatic and pictures with similar faces are collected into batches. An operator is required to confirm or reject matchings where the algorithm does not have high confidence. This efficient method is a good alternative to manually matching pictures with manual human interaction, improving accuracy on the database content before any post processing.

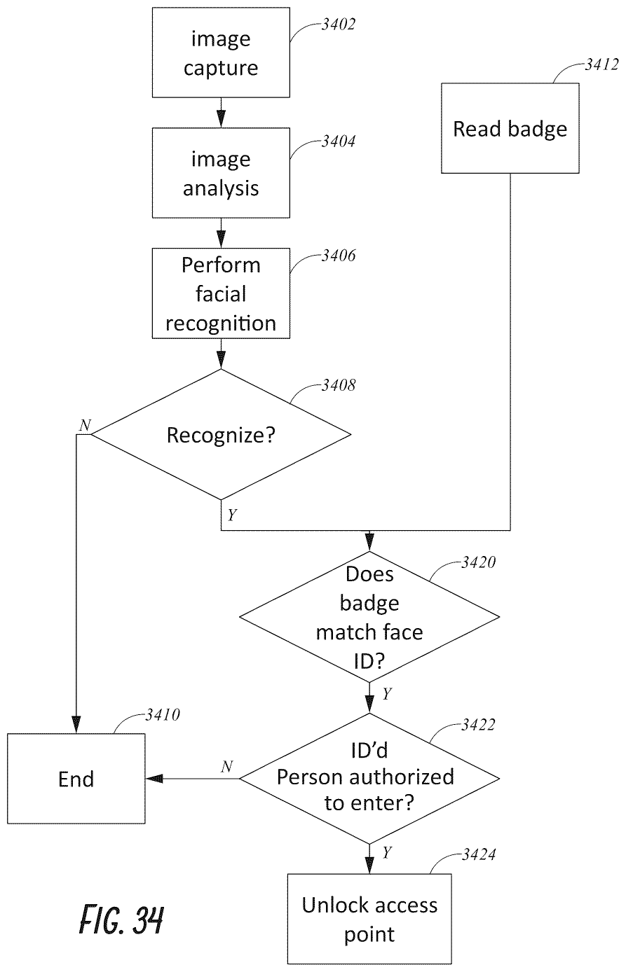

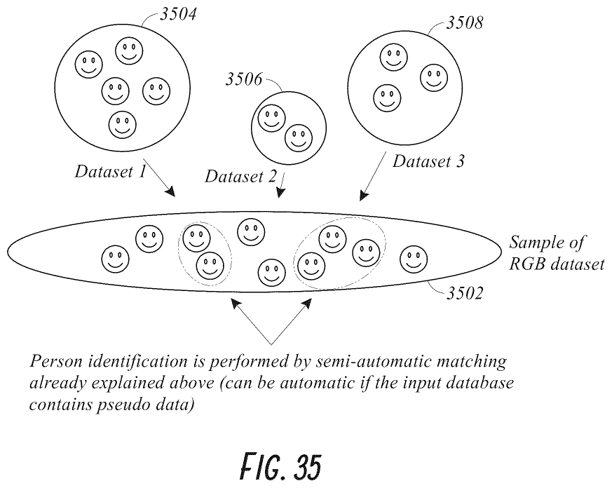

The process works in 3 steps: a) Process all pictures and automatically look for very close ones. As the similarity threshold is very high, confidence that the person is the same in a group is (several groups can have pictures from the same person). We will call those groups of very close pictures “clusters”. FIG. 35 explains this automatic matching of very similar pictures.

Facial recognition module 500 (not shown) will collect a large number of facial images 3502. It would be very time-consuming for a human operator to have to individual identify all of the pictures individually, even if just during initial training. Thus in an exemplary embodiment, facial recognition module 500 may group those images into clusters 3504, 3506 and 3508 based on a level of confidence that all of the images in cluster 3504 are of one person, images in 3506 of a different person, and so on. This will permit a human operator helping to train the system to identify a single image representing a cluster, and thus accomplish the identification process more efficiently.

When all pictures are organized into clusters consisting of one or more pictures: b) Compare each cluster to all other clusters by comparing each picture within the first cluster to all pictures from the other cluster and calculate the similarity confidence.

This process enables further simplification of the process by automating the merging of clusters when there is a high likelihood that two (or more) clusters contain pictures of the same person.

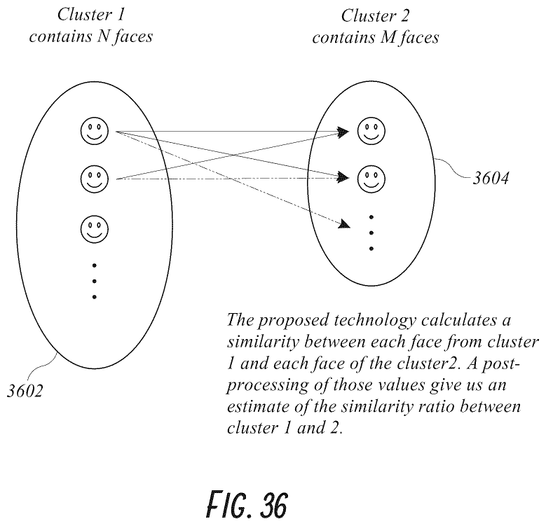

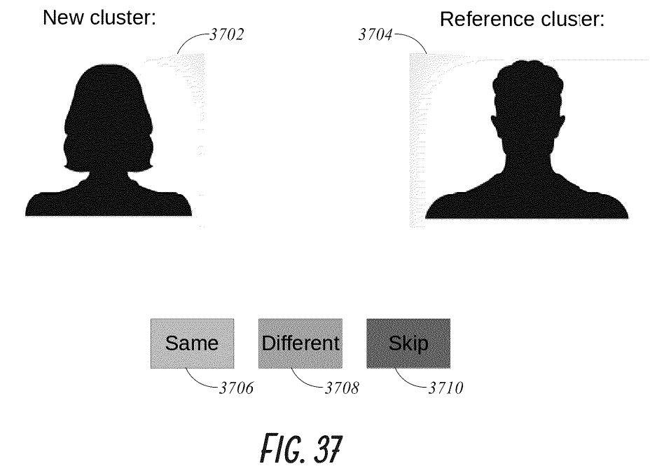

FIG. 36 presents a visual explanation of this pairing method. Thus where cluster 3602 contains a number of images determined to be all images of the same person, and cluster 3604 contains a number of images determined to be all images of the same person, all of the images in both clusters can be compared in order to estimate the degree of similarity between the two clusters. If the degree of similarity is sufficiently high, the two cluster can be merged into a single larger cluster. This may be performed automatically by facial recognition module 500, or may be assigned to a human operator, as described in FIG. 37 below.

For each cluster, rank all other clusters by their combined similarity confidence (higher are more likely to include the same person). c) Display the current cluster and the first one in the similarity clusters list to the operator. If the person is the same, clusters will be merged. If not, we will propose the next cluster in the similarity buffer. FIG. 19 is an example of a visual interface used. The user should confirm or reject if the two clusters are the same person by clicking one of the proposed buttons.

FIG. 37 provides a view of a possible embodiment of the visual interface using the proposed technology to evaluate person matching. The user interface may present a representative image from an existing cluster of images 3702, as well as a representative image from a new cluster of images 3704. The human operator may then be prompted to mark the clusters as same 3706, different 3708, or to skip the matching process 3710 if the human is unsure.

After X iterations (X is a number depending on the type of pictures and time we want to spend), this new cluster may be deduced as a new person and a new cluster ID may be assigned. If there is mismatch, same cluster or if the comparison is too ambiguous, ambiguous data may be saved for more specific manual post processing.

Because of parallel processing and human error, another step may be necessary to increase again the accuracy in the database. After all processing, final post-processing will be operated on the database to remove again any potential person duplicates (same person identified with different person IDs).

The process is identical to above: a) Build a cluster by extracting Y random pictures for each person ID in the dataset (Y to be decided depending on the time we want to spend and target accuracy). Random factor is very important for better accuracy. b) For each generated cluster, compare it to all other clusters and generate a list of similar clusters from higher similarity to lower one. c) For each cluster, consecutively display X closest clusters from the similarity list to the operator. If one of them matches (same person displayed) person IDs will be merged. If after X comparisons no identical person identity is detected, we will consider this person cluster to be unique.

This allows for automatic processing of obvious results and human validation of ambiguous ones. This dataset processing method allows a good accuracy on person ID assignation and same-person image clustering. All automatic clustering methods depend on a numerical threshold which should be adjusted depending on the type and quality of input data. Lower thresholds will be more accurate but can increase manual processing time, higher thresholds will reduce manual intervention but also matching accuracy. Ethnic origins of the person can also be a factor for threshold adjustment depending on what type of data was used to create and test the clustering function. If facial characteristics are very different from the ones used to create the clustering method, results may be less accurate.

The dataset used in the proposed facial authentication technology also includes pictures of people taken in real-world conditions. To match as many common parameters of facial capture as possible (picture quality, orientation, luminosity, size, distance . . . ), functional sensors may need to be deployed at various locations. The captured pictures can be aggregated with the existing dataset (already described in previous sections) and improve the facial recognition database by adding depth data.

Previous sections described data collection for recognition pictures but fake data like paper faces and other spoof attempts may be used to test and evaluate anti-spoofing algorithms. This dataset also requests as much diversity as possible to be efficient.

To resolve this problem, a recording module may be used to capture faces and other features may be added to the display to create a gamification around the spoofing part. The display may show an enigmatic message like “Are you human?”. Those words and color indications encourage users to try several approaches to trick the system. Additional information and messages are displayed to guide the user and show the progress.

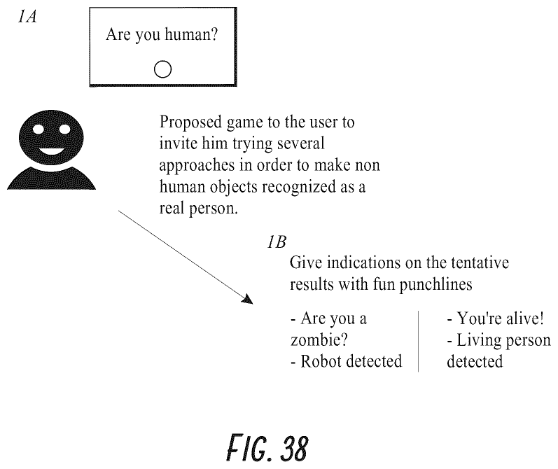

Finally, those “game units” may be positioned in strategic places like technical universities and facilities where people are more familiar with this type of features. FIG. 38 gives examples of messages that may be displayed by the gaming unit.

While it may be desirable to permanently install dedicated facial recognition modules at access control points in many situations, there may also be contexts in which an ad hoc access control point is desired. It may also be the case that facial recognition may be useful for other purposes for which more portable hardware is useful.

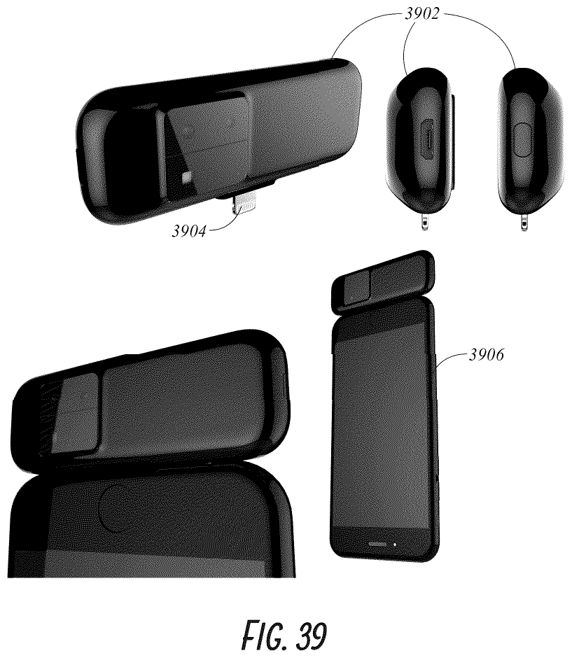

The following embedded module had been designed to provide a real-time 3D sensing experience to mobile users, as shown in FIG. 39. This module contains an RGB and depth cameras (or IR sensors) pointing to the user and live streaming the captured video to the phone. This module also contains its own battery and power module. The specific embodiment of module 3902 illustrated in FIG. 39 is intended to be used in connection with smart phones and/or tablets from Apple Corp., and features the proprietary Lightning connector 3904 included in many Apple products. Alternative implementations may use other connectors, such as a form of USB (Universal Serial Bus) in order to work with other smartphones or tablets, such as those using the Android operating system. Module 3902 may also include one or more IR light sources and one or more IR sensors. Module 3902 may also include its own RGB camera, or may connect to the RGB camera or cameras already present in connected smart device 3906.

The setup and provisioning of a building security system, especially a system that includes multiple components that can be configured in software, can be a time-consuming and difficult process. Some systems have required users to type alphanumeric codes into devices with limited user interfaces, or perform other precise tasks with limited feedback. Thus it is another object of the invention to provide a simple provisioning process that can be performed by people having a variety of levels of technical skill. This object is provided by an aspect of the subject invention that permits settings and other aspects of the setup process to be communicated to edge devices including facial recognition modules by presenting visually encoded information to be input via one or more cameras on the device. One method of accomplishing this is to present a portable device with a display, such as a tablet or smartphone with a coded message, such as a barcode or QR code, so that it is seen by the edge device.

In one embodiment, When the system is first turned on, it enters configuration and setup mode automatically. In this mode, the system has all connectivity disabled by default. The camera is enabled to accept configuration input and the display is enabled to convey information. The administrator or installer may configure the unit using the included application. The app may be available on a smartphone and tablet device, as well as a web client. The app may consist of step-by-step configuration with explanation for each option. After the administrator or installer has selected all the settings, the app may encode the configuration settings into a barcode and display them on the screen. At this point, the administrator or installer can present the barcode to the camera to easily transfer and save all the selected settings to the system.

The system and related subscriptions described herein are designed to work with and without Internet connectivity. Without Internet connectivity, subscription products can be managed and renewed via NFC and RFID. Before shipping each system to the customer, there can be created a set of special and unique NFC and RFID credentials for each system representing the annual subscription renewal. This set of subscription renewal credentials are stored internally to the edge unit and are recognized by that particular system. When the customer wants to renew a subscription for a system without internet connectivity, the customer will be given a corresponding NFC (Near Field Communication) or RFID renewal credential for that year. The customer may then present the credential to the system. The system may read the credential and match the credential against its internal records to update the subscription and expiration date accordingly.

In another embodiment, the invention also comprises a tool to enable an employer to provide information about the morale and emotional health of its employees. The technology required to recognize individual people can also used to recognize indicators of the emotional state of the people being analyzed. Thus detecting smiles versus frowns and grimaces, laughing versus crying can all be used to inform management about their workforce as a whole, as well as potentially identify individuals who might benefit from extra attention.

The technology proposed provides various information:
Number of people near the door
Distance for each person
Intent of each person based on head or eye gaze
The identity for each person if recognized
The anti-spoof result for each person (real or fake)

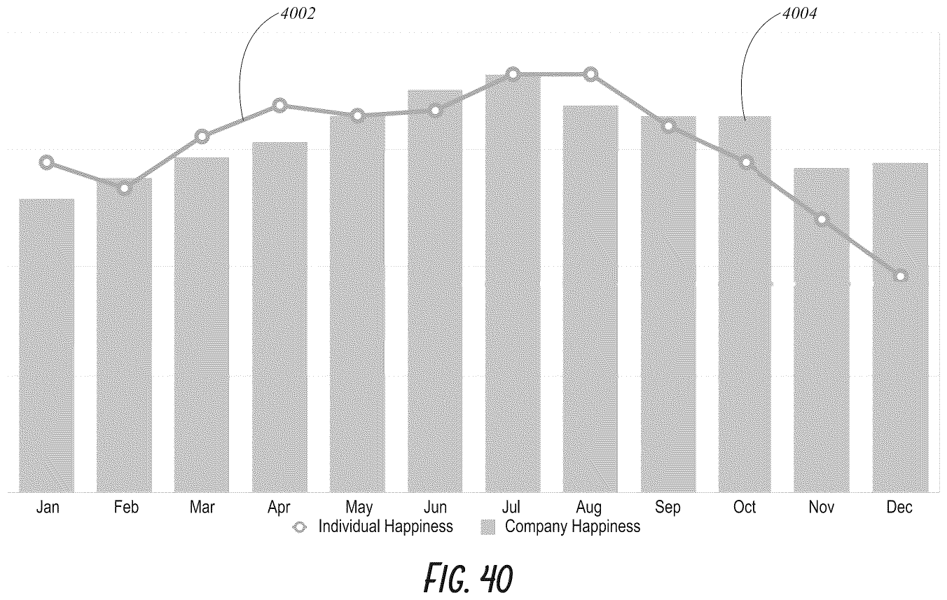

The proposed method uses facial recognition to grant access to incoming people. The authentication system may also provide additional features like automatic personnel timekeeping without any manual check-in and emotion tracking. This is especially useful when comparison on individual versus department, group or company is analyzed. For example, a performance review of an employee can be correlated with his quarterly physical presence in the company and their emotional analysis for a more complete insight into their profile and current work. Another example is when a notification is triggered if there is an outlier per company configuration-a group of people working on a project experience longer working hours correlated to lowered positive emotion levels throughout weeks or months. The company can potentially hire help or delay deadlines. FIG. 40 gives an example of a visual presentation of the data.

Line 4002 illustrates an exemplary method to track the displayed emotional state of an individual who passes regularly through an access point controlled by facial recognition module 500. Bar chart 4004 illustrates an exemplary method to track the overall displayed emotional state of all of the people (or a subset thereof) moving through an access point controlled by facial recognition module 500.

Additionally, a company can track how employees react to an announcement pre and post the event by tracking their emotional behavior. The company can time an event based on how the company's emotional level is in general. This is presented in FIG. 41. Different facial expressions may be recognized and associated with different emotional states. Those emotional states can be tracked over time, and changes in overall emotional states can be used to affect various company policies and initiatives.

Another aspect of the invention that leverages the image recognition capabilities of the facial recognition module is to use a system of encoded badges or stickers for purposes such as guest badges. The authentication platform is using image processing to grant access. The main target is facial recognition but this tool can also be used to recognize any 1D or 2D barcodes. For guest recognition and access, custom name tags can be created with QR codes or barcodes. The person doesn't have to be recognized by the system and access can be granted for a limited time.

This use case can give more liberty to guests and temporary employees but also avoid all tailgating alerts. It's also a way to track guest movements by checking (for example) this person is always with a representative of the company.

Another aspect of the invention that leverages the image recognition capabilities of the facial recognition module is to use information generated by the facial recognition modules to inform other systems, such as emergency response systems. In the event of fire, live shooter situations, earthquake, etc., an essential piece of information for first responders is knowledge of how many people are inside a building or critical area of a building. Since the technology intrinsically uses 3D scanning with volumetric data to do facial authentication, it can also recognize bodies even if no face is detected or recognized. This is especially useful in case of emergency, when during evacuation, people can be counted on the way out and an alert can be dispatched if a mismatch is present between employees indoors versus employees outdoors.

In another embodiment, the subject invention may use facial recognition to determine not (or not only) the identity of a given person, but to read that person's facial expressions as a user interface-that is, as a means for interacting with a computer system.

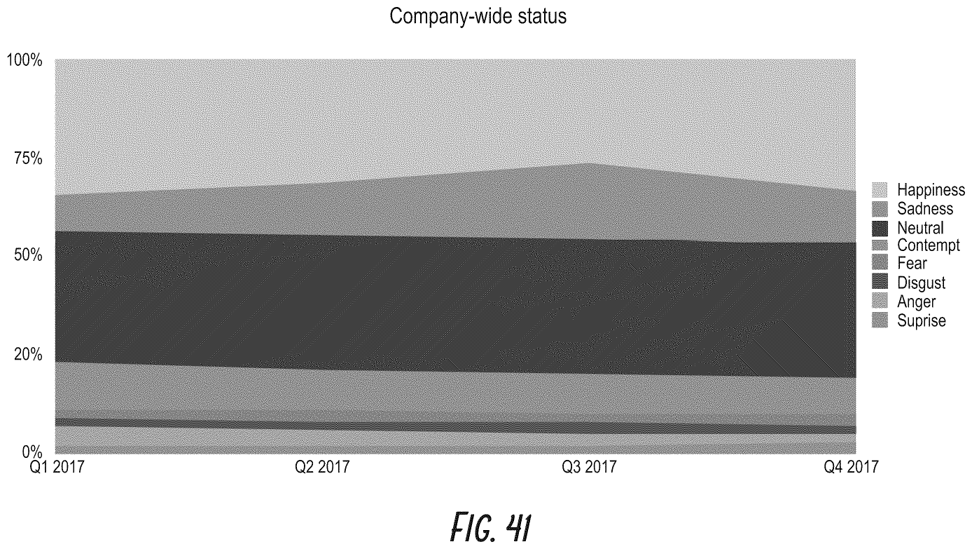

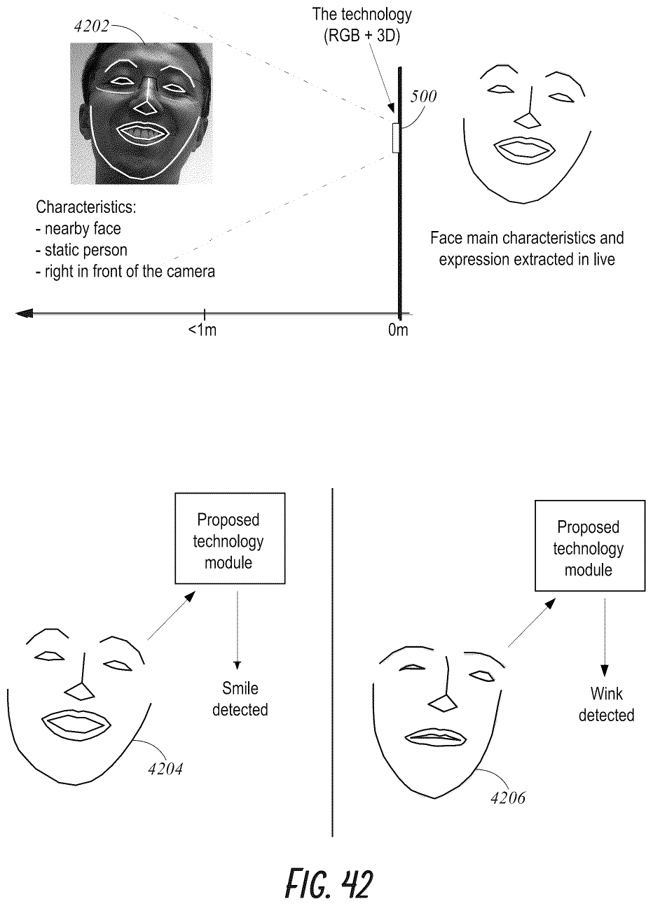

In an embodiment, authorized individuals may be able to perform administrative tasks with their facial expressions. Main tracking points may be mouth, eyes and global facial movements. FIG. 42 provides some detail on how that is done.

When person 4202 approaches facial recognition module 500, and that person has been recognized as an authorized person through extraction of person 4202's facial features, it is also possible for person 4202 to trigger actions based on facial expressions. Thus if person 4202 smiles, facial recognition module 500 recognizes smiling face 4204, and can initiate an action that has been associated with a smile by that person, such as navigating among menu items; if person 4202 winks, facial recognition module 500 recognizes winking face 4206, and can initiate an action that has been associated with a wink by that person, such as selecting a menu item. Such expression-based actions can be the same for all users, or could be customized on a user-by-user basis.

Because security systems should be designed to prevent and detect a wide variety of methods of compromising them, it may be desirable to incorporate technologies inside the facial recognition module to detect a variety of forms of physical tampering. Thus in an embodiment of the subject invention, the invention comprises additional components that can detect tampering with the system.

The physical anti-tampering functionality has two main purposes. First, the system is designed to protect the internally stored user and location data from being accessed. Second, in the event of tampering the system's door unlock functionality will be automatically disabled via software to prevent physical access to the secured space. In an exemplary embodiment, Upon detecting a physical access attempt, the system may perform an alert action and self-destruct. The notification can be configured to be any combination of sound and alert messages via digital transmission. The self-destructing action involves repeatedly erasing and overwriting sensitive user and location data regions within the internal flash storage and any removable storage medias.

In an exemplary embodiment, the system consists of three main types of physical anti-tampering detection methods. Any combination of the anti-tampering detection methods may be configured and used depending on the situation. First, in an exemplary embodiment the system has an internal barometer (also known as pressure sensor) and a physical structure which prevents rapid pressure changes. The system software monitors the barometer for rapid pressure changes via an interrupt. This antitampering method is designed to detect an intrusion involving physically breaking the casing of the system. For example, drilling into the casing or cracking the casing.

Second, in an exemplary embodiment the system has an internal ambient light sensor and a small light source between the wall mounting plate and the system casing. When installed, the light is emitted from the light source, reflected from the wall mounting plate, and detected in the ambient light sensor. The system software monitors for light level changes from the ambient light sensor via an interrupt. This anti-tampering method is designed to detect when the system has been physically removed from the wall.

In an exemplary embodiment the system has an internal accelerometer. When mounted on a wall, the system is expected to be relatively physically stable. The system software monitors for rapid acceleration via an interrupt. This anti-tampering method is designed to detect physical shock to the system such as being pried off by a crowbar or being hit by a hammer.

Another approach to sensing tampering is to monitor the image captured by the camera and sensors. If, for example, the location of normally stationary objects changes, and especially if the location of all such objects move together, it can indicate that the facial recognition module has been removed from its normal location.

Another aspect of the invention is the ability to operate in low-light conditions. The infrared laser projector may, in some embodiments, project enough light under certain conditions to permit one or both IR sensors to capture a useful 2D image. This image may be used for facial recognition in place of or in addition to RGB images when there is insufficient light to permit the RGB camera to produce high-quality images.

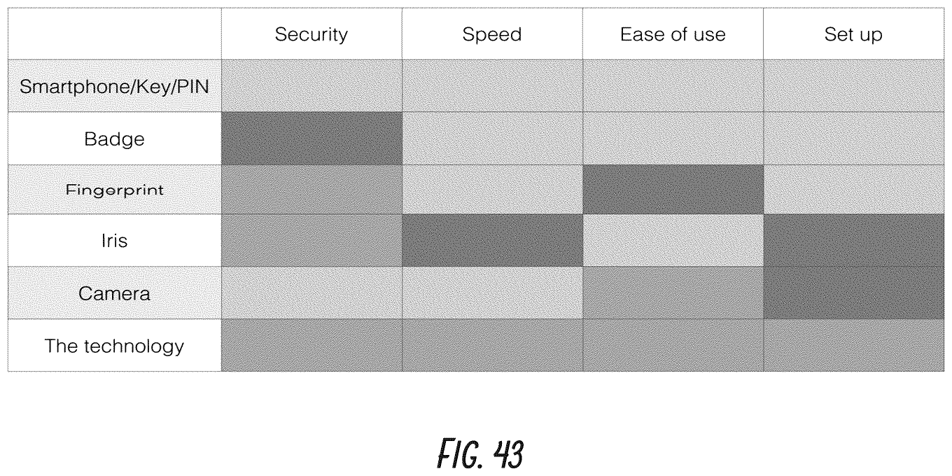

The subject invention provides multiple benefits as compared to previous building security technologies. FIG. 43 presents a comparison of classical access control methods and the proposed platform based on various criteria. This comparison is based on security, speed, ease of use and setup.

In many cases, facial recognition modules will be mounted to a wall near an entry point. Available mounting points may include a wall above the entry point, a wall on either side of the entry point, or the ceiling above the entry point. These facial recognition modules will thus not be positioned directly in front of the path of people approaching the entry point. With a conventional cuboid form factor, on which the cameras are mounted on the front face of the cube, a result of such mounting points is that a significant percentage of the field of view of the cameras mounted on the front panel of the cuboid is likely to be effectively wasted, as it will cover an area where people are unlikely to be. This effectively reduces the useful resolution of the sensor or sensors used to generate the images used for facial recognition.

One possible adaptation is to angle the lens or lenses relative to the front panel of the facial recognition module. However, this may present significant drawbacks. When a facial recognition module includes multiple imaging sensors, such as a plurality of visible light cameras, or a visible light camera and one or more infrared sensors, accurate alignment of the multiple imaging sensors is important in order to maximize accuracy. In the case of a facial recognition module that includes one or more infrared emitter that emits structured light, it is also important that these emitters are reliably aligned relative to the infrared imaging sensors, both as assembled, and after the unit has been handled, shipped, dropped, etc. If these sensors are mounted at an angle to the front surface of the facial recognition module, the odds of misalignment are increased. This approach may also complicate the weatherizing of the module.

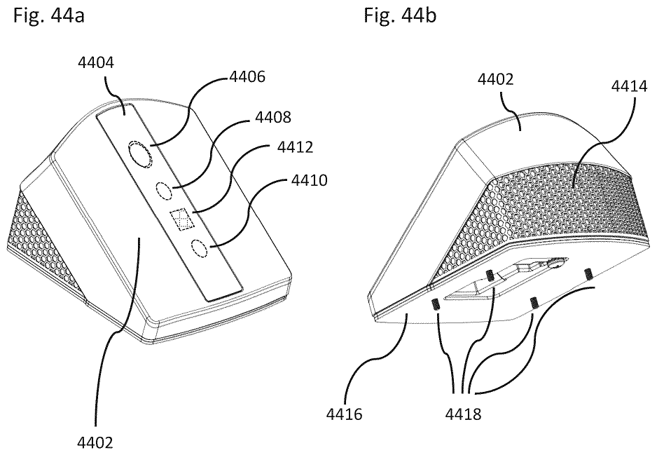

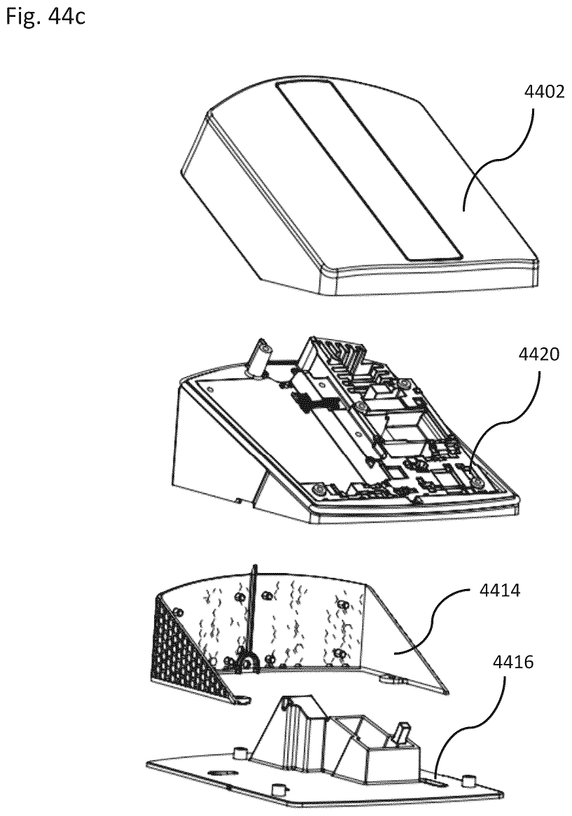

One solution to that problem is a non-cuboid form factor for the facial recognition module. One such form factor is an overall wedge, as illustrated in FIGS. 44a, 44b and 44c. As shown in FIG. 44a, an exemplary embodiment of such a wedge-shaped device includes front cover 4402. Front cover 4402 includes transparent window 4404, behind which are located visible light image sensor 4406, infrared sensors 4408 and 4410, and IR emitter 4412. As shown FIG. 44b, the “wide” side of the overall wedge shape may be partially covered by front cover 4402, and partly by wire mesh 4414. Front cover 4402 is fitted over main chassis 4420, as shown in FIG. 44c. Transparent lens cover 4404 is preferably comprised of glass, for scratch resistance, but may also be made from various plastics, such as polycarbonate. Lens cover 4404 may be co-molded with the rest of front cover 4402, or may be a separate piece attached to front cover 4402 with liquid adhesive, 2-sided tape, or some other method. Back plate 4416 is to be mounted against the wall or other surface to which the facial recognition module is to be attached, for instance, by fasteners 4418.

As shown in FIGS. 44a, 44b, and 44c, the facial recognition module may be constructed generally in the shape of a wedge. That wedge may be defined by an included angle of roughly 30 degrees, though other angles may also be employed. The use of an angled facial recognition module chassis enables the imaging sensor or sensors and (if employed) IR emitter to provide more efficient use of the resolution of the imaging sensor or sensors relative to the area to be covered as compared to a sensor that is mounted parallel to the wall adjacent to the access control point. A facial recognition module according to these teachings may also be used in other applications, such as mounted on a turnstile, or in other positions.

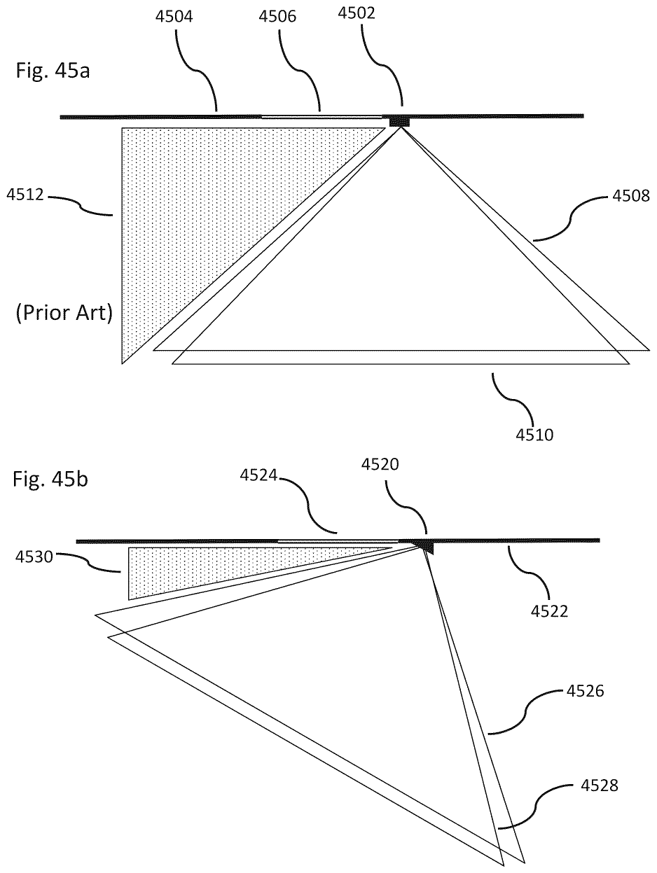

At least a benefit of an angled facial recognition module as disclosed herein is illustrated in FIGS. 45a and 45b. FIG. 45a illustrates the coverage of the image sensors in a conventional cuboid facial recognition module with forward-facing image sensors. When facial recognition module 4502 is mounted flush with or parallel to a wall 4504 adjacent to the entry point 4506, the field of view 4508 of visible light sensor and field of view 4510 of IR light sensor (if present) will be offset relative to the entry point. The area covered by the field of view of an imaging sensor may be thought of as an included angle; the wider the lens, the larger the included angle. When a cuboid facial recognition module is used, a possible area without camera coverage includes the wedge-shaped area 4512 immediately in front of the entry point 4506. This blind spot increases the possibility that a person could reach entry point 4506 while evading detection by facial recognition module 4502.

By employing a wedge-shaped facial recognition module with an angled field of view for the imaging sensors from the position to the side of the entry point, the blind spot immediately in front of the entry point can be reduced or possibly eliminated. As shown in FIG. 45b, wedge-shaped facial recognition module 4520, located on wall 4522 next to entry point 4524, angles the field of view 4526 of visual light sensor and the field of view 4528 of the infrared sensor or sensors. This significantly reduces blind spot 4530 in front of entry point 4524, potentially to the degree that it is difficult or impossible for a potential entrant to evade detection by facial recognition module 4520.

In the currently preferred embodiment, as shown in FIG. 45b, the field of view 4526 of the visual light sensor or sensors will be larger than the field of view 4528 of the infrared sensor or sensors. This permits the visual light camera to be optimized to accomplish the purpose of detecting the presence or absence of a person near the secure entry point, whether identified or not. Thus if a person is detected by the RGB sensor in the vicinity of the entry point, and then is no longer detected in that area, without having moved out in a direction that would take that person away from the entry point, the facial recognition module may conclude that the person has gone toward or into the entry point. The infrared camera or cameras are preferably focused on a narrower field of view 4528, because they are preferably optimized for facial recognition, which will generally be improved by allocating the available pixels on a given sensor to a smaller viewing angle in order to improve resolution.

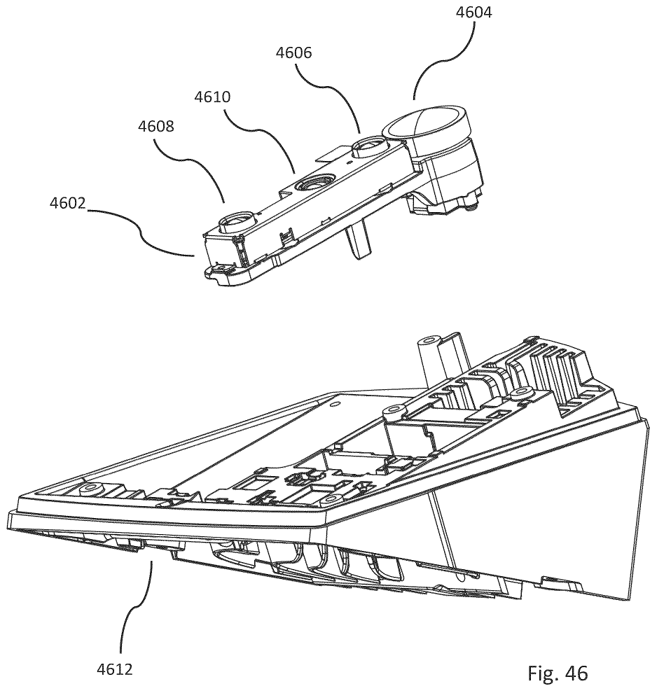

Preferably, the plurality of image sensors and (if present) infrared emitters may be mounted to a common carrier or backplane that can be mechanically isolated from the rest of the facial recognition module, as illustrated in FIG. 46. In the illustrated exemplary embodiment, imaging carrier 4602 provides a common reference and mounting points for visible light sensor and lens 4604, infrared sensors 4606 and 4608, and infrared emitter 4610. Because the sensors and emitter are all attached to the same imaging carrier 4602, it is easier to ensure consistent alignment between these devices. Mechanically isolating the optical sub-assembly from the rest of the facial recognition module can help protect sensitive optical sub-assembly components from forces encountered during shipping, installation and operation.

Imaging carrier 4602, together with all of the imaging components, is in turn attached to the main chassis 4612 of the facial recognition module.

In many applications, it will also be advantageous to provide tamper-resistant methods for securing the facial recognition modules to a building, turnstile or other location. Ideally, such methods will prevent tampering. Because complete tamper-proofing (in the sense of prevention) is not possible, it is desirable that tampering trigger an alarm or notification, so that appropriate responses can be undertaken.

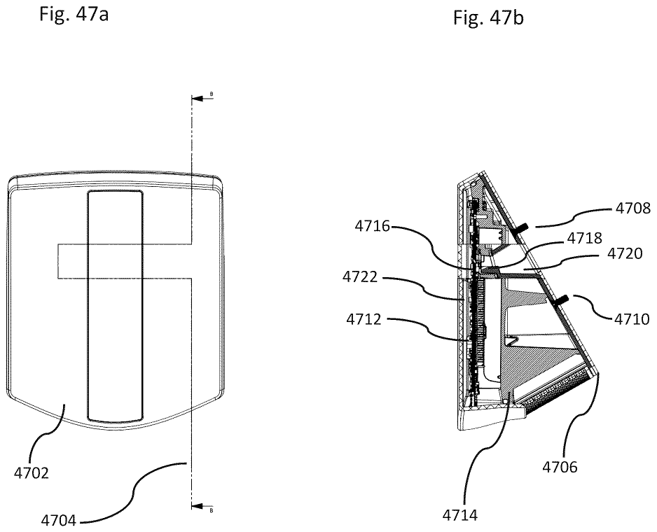

An exemplary tamper-resistant structure is illustrated in FIGS. 47a and 47b. FIG. 47a shows a facial recognition module as seen from above the front cover 4702. Dashed line 4704 represents a section line, and 47b shows an internal view of the facial recognition module through section 4704.

Wall plate 4706 includes holes to retain wall mounting screws 4708 and 4710. When the facial recognition module is fully assembled, the mounting screws are hidden and not accessible without disassembling or otherwise tampering with the facial recognition module. PC board 4712 is attached, preferably with fasteners, to main chassis 4714. It includes multiple components, including several components related to tamper protection. These may include proximity sensor 4716, which is oriented so that it senses the distance between proximity sensor 4716 and tab 4718. Preferably, the distance between these two components is very small (preferably in the range of 0.1 to 3 millimeters, with a currently preferred optimum distance of 1mm). Thus even a small amount of relative motion between tab 4718 and proximity sensor 4716, such as may occur if someone attempts to tamper with the facial recognition module will be detected by proximity sensor 4716.

Tab 4718 is preferably molded or cast into wall plate 4706, though it may also be a separate component attached to main chassis 4714. Tunnel 4720 within main chassis 4714 provides a channel for the wires connecting the facial recognition module to the rest of the system, but closes off the rest of the internals of the facial recognition module from exposure to weather, etc.

In the event of any relative movement between wall plate 4706 and main chassis 4714, proximity sensor should detect a change in the distance between tab 4718 and proximity sensor 4716.

In at least an embodiment, the facial recognition module will also include at least an internal accelerometer 4722, also preferably mounted on PC board 4712. Accelerometer 4722 is configured to detect movement and/or vibration. When the facial recognition module is normally mounted on a structure, any significant movement detected by accelerometer 4722 is likely to indicate an abnormal condition, and may indicate tampering. However, movement detected by the accelerometer could also indicate building vibration, which could be caused by operation of heavy machinery, an earthquake, or some other condition that does not indicate a possible security breach.

In the event potential tampering is detected, in an embodiment the facial recognition module may be configured to prevent any authentication from being completed for a specified time after the possible detection event. However, to minimize the likelihood of a false event, which could reduce the perceived reliability and/or utility of the system, it may be advantageous to provide a multi-factor evaluation process before deviating from normal function. If only a single accelerometer detects motion, it is possible that the signal indicates a malfunctioning sensor, or some other anomaly that does not actually indicate tampering. Thus for example, when vibration is detected from internal accelerometer 4722, that input can be compared to other inputs, which may include an additional accelerometer within the same facial recognition module, or one or more cameras on the facial recognition module, or a microphone, or inputs from other facial recognition modules installed in the same facility, or some other device. If someone is trying to, for example, remove a facial recognition module from a wall, that action will not only cause movement and/or vibration that would likely generate a signal from one or more accelerometers, it would also likely cause the entire field of view of the camera(s) to shift simultaneously. Thus if the camera image shifts at the same time as one or more accelerometers suggest movement, the fact that two or more inputs are consistent with a tampering event gives a higher confidence level that such an event has been detected. If the facial recognition module is also equipped with a proximity sensor 4716, the output of accelerometer 4722 can be evaluated together with the output of proximity sensor 4716. If both proximity sensor 4716 and accelerometer 4722 indicate motion on a single facial recognition module, but no other facial recognition modules in the same system detect such events, it may be proper to infer a security breach event.

In the event that the facial recognition module determines that tampering has been detected, a number of responses may be taken. If the facial recognition module is still connected to the server or other central equipment, a tamper alert may be transmitted. The facial recognition module may, upon determining that a tamper event is taking place, delete or corrupt all internally stored data (so that, if a malicious actor removes the facial recognition module it will be impossible to access any information about authorized users, images, etc.), or even temporarily or permanently render the facial recognition module inoperable. In the event of temporary suspension or disabling of function, resetting the device may be enabled by requiring a specific code to be transmitted to the facial recognition module.

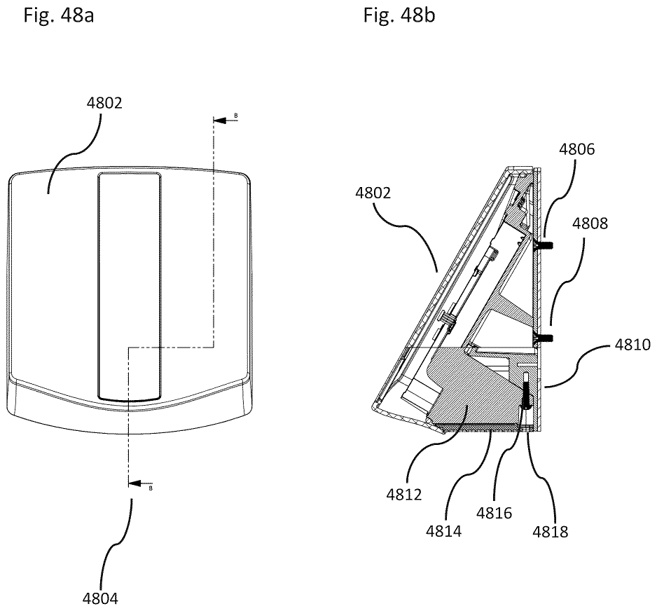

Additional tamper-proofing features are shown in FIGS. 48a and 48b, which show an embodiment with tamper-resistant means for attaching the facial recognition module to a wall. FIG. 48a shows face plate 4802 from above, and shows cut line 4804 which gives the cross-section shown in FIG. 48b.

When installing a facial recognition module according to this embodiment, the facial recognition module is attached to the wall or other mounting surface in stages. Fasteners 4806 and 4808 are used to attach wall plate 4810 to the wall or other surface to which the facial recognition module is attached. When main chassis 4812 and face plate 4802 are attached to wall plate 4810, fasteners 4806 and 4808 are completely hidden and inaccessible.

Main chassis 4812 includes a mesh portion 4814 to allow air circulation around the internal heat sinks and/or internal fan. Mesh portion 4814 includes a small clearance intended to permit access to one or more security fasteners 4816 which attach main chassis 4812 to wall plate 4810. Security fasteners can be configured in a variety of shapes, such as pin-in-hex, Torx security, pin drive, etc., as are commonly known in the art. Access hole or holes 4818 in mesh portion 4814 may be sized so that a tool may be inserted through holes 4818 to tighten security fasteners 4816, but small enough that that fasteners 4816 are held captive inside the facial recognition module even when fullly retracted from wall plate 4810.

In many applications, facial recognition modules will be mounted outdoors, where they may be exposed to extremes of temperature and humidity. Thus robust weatherproofing of the facial recognition module will be advantageous. Weatherproofing is complicated by the fact that a facial recognition module as disclosed herein may require some form of heat sinking, because facial recognition is processor-intensive, which means significant heat may be generated inside the facial recognition module. In some applications, passive cooling, such as in the form of one or more finned heat sinks, may be sufficient. In other embodiments, one or more cooling fans may also be employed. Thus completely sealing the entire facial recognition module against the elements is problematic because it can lead to excessive heat build-up inside the unit, which can lead to premature component failure or even start a fire.

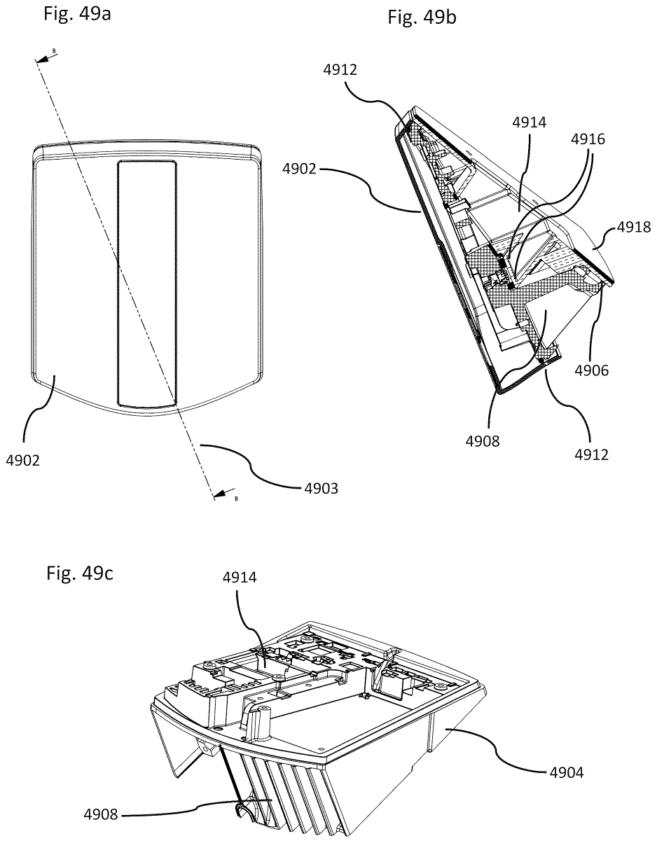

An exemplary facial recognition module structure with enhanced weather resistance that also permits effective heat evacuation is illustrated in FIGS. 49a, 49b and 49c. FIG. 49a shows front cover 4902 and cutline 4903, which defines the plane used to create the cutaway view in FIG. 49b. The structure of that enclosure includes three primary components: front cover 4902, main chassis 4904, and back plate 4906. Main chassis 4904 includes heat sink 4908. Heat sink 4908 is preferably made of a thermally conductive material, such as aluminum. In an embodiment, the entire main chassis 4904 is a single casting of aluminum. This improves passive cooling by providing a relatively large thermal mass to absorb heat generated by the internal components. It extends to the area where the primary heat-generating components, such as the microprocessor, are located on the PCB. Front cover 4902 at least partially wraps around main chassis 4904. The junction between front cover 4902 and main chassis 4904 may be sealed in a variety of ways, including adhesives, grease, gaskets, etc. In the currently preferred embodiment, an o-ring 4912 is seated in a circumferential groove extending on all sides of the main chassis. O-ring 4912 may be made of any of a variety of suitable materials, such as various elastomers. These components are placed and dimensioned so that when front cover 4902 is attached to main chassis 4904, o-ring 4912 is sufficiently compressed against the inner surface of front cover 4902 to create a seal. O-ring 4912 seals the junction between front cover 4902 and main chassis 4904. Because of the wedge shape of main chassis, and because front cover 4902 leaves the “wide” face of the wedge exposed, that portion of main chassis 4904, which in a preferred embodiment will comprise a finned heat sink, remains exposed to the elements in order to aid heat dissipation. Main chassis 4904 is therefore preferably configured so that there are no openings between the exposed area of main chassis 4904 and the interior of the facial recognition module, which helps to protect internal components from the elements. However, it is also generally necessary to provide a path for wires to run from the facial recognition module into a hole in the wall of the building to permit connection of the facial recognition module to the rest of the system and to provide power. This goal may be accomplished by defining an internal “tunnel” 4914 between the outside of the facial recognition module, through back plate 4906 and main chassis 4904. Gasket 4916, which may be similar to o-ring 4912 or may be a different form of resilient material seals tunnel 4914 against main chassis 4904. When combined with o-ring 4912, this creates a sealed chamber inside the facial recognition module for the sensors, microprocessor and other electronics.

The other end of tunnel 4914 is substantially flush with the rear surface of back plate 4906. The rear surface of back plate 4906 may be partially or substantially covered with back plate gasket 4918, where it joins the wall or gang box. This form of construction can both protect the cable routing from undesired access and weatherproof the penetration in the structure to which it is attached without inhibiting the effectiveness of the heat sink(s) by enclosing them inside a sealed enclosure.

FIG. 49c provides a different view of main chassis 4904, heat sink 4908, and tunnel 4914.

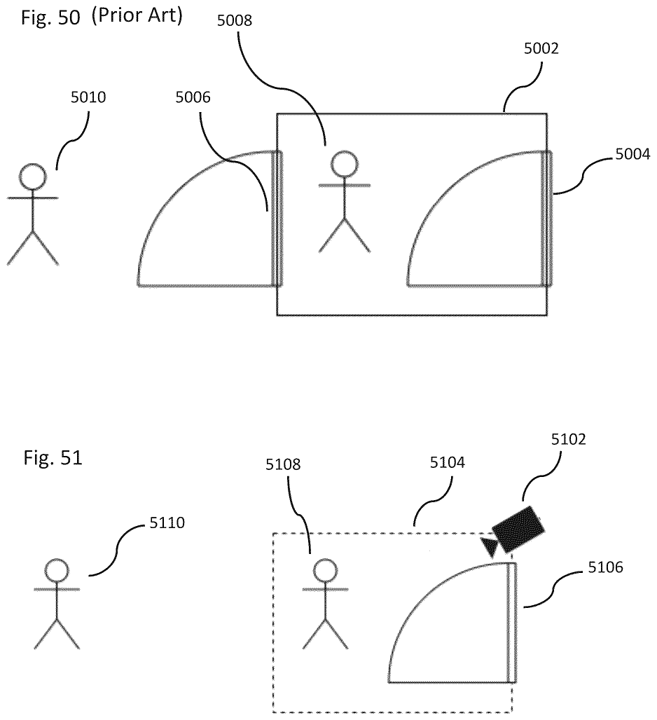

One way known in the prior art for controlling access to areas that require a high degree of security is commonly referred to as a man trap. A simplified diagram of one form of man trap is shown in FIG. 50. The traditional man trap comprises a small chamber or anteroom 5002 with two lockable doors-an inner door 5004 that provides access to the secure area, and an outer door 5006 that provides access to the man trap.

A man trap can increase security in two ways: it can provide a brute-force form of 2-factor authentication, if, for example, a key or machine-readable badge is required to enter the man trap, while biometric identification (facial recognition, retinal scan, etc.) is required to open the inner door.

A man trap can also be used to inhibit tailgating. Thus when one person 5008 has entered the man trap, outer door 5006 again locks, preventing second person 5010 from entering without separately presenting proper identification. However, if the man trap is not monitored, a properly credentialed user could simply bring an unauthorized person in with him or her.

One method for addressing this kind of tailgating is to make the man trap too small to fit a second person. However, such small spaces are generally perceived as unpleasant by many people; they are also likely to present accessibility issues.

Another approach is to include visual monitoring of the space inside the man trap, such as with a video camera, or a window that permits a guard or other observer to ensure that only one person at a time is in the man trap before authorizing the opening of the inner door. However, this approach is likely to be expensive, both in terms of the building of the man traps themselves and in terms of the staffing required.

Thus while conventional man traps can be highly effective in controlling access, they can be expensive to purchase, install and operate. It is therefore desirable to provide similar functionality in a more cost-effective manner.

One such approach involves use of a facial recognition module, as described herein, with a single access control point as shown in FIG. 51. Rather than create a physical man trap enclosed by actual walls and two doors, facial recognition module 5102 can be used to define a controlled area 5104 around door 5106 that leads to an access-controlled area. When user 5108 enters controlled area 5104, facial recognition module 5102 determines whether user 5108 is an authorized entrant. If user 5108 is confirmed to be an authorized entrant, and no other potential entrants are within controlled area 5104, facial recognition module 5102 will trigger the opening of door 5106. However, if another person 5110 enters controlled area 5104, facial recognition module 5102 will detect the presence of a second person, and will not unlock door 5106 unless second person 5110 either leaves the controlled area or is authenticated as an authorized entrant.

Two-factor authentication, which may provided an additional layer of security, can be accomplished by requiring both positive facial recognition and a second form of credentialing (such as a badge as evaluated by a badge reader or a key).

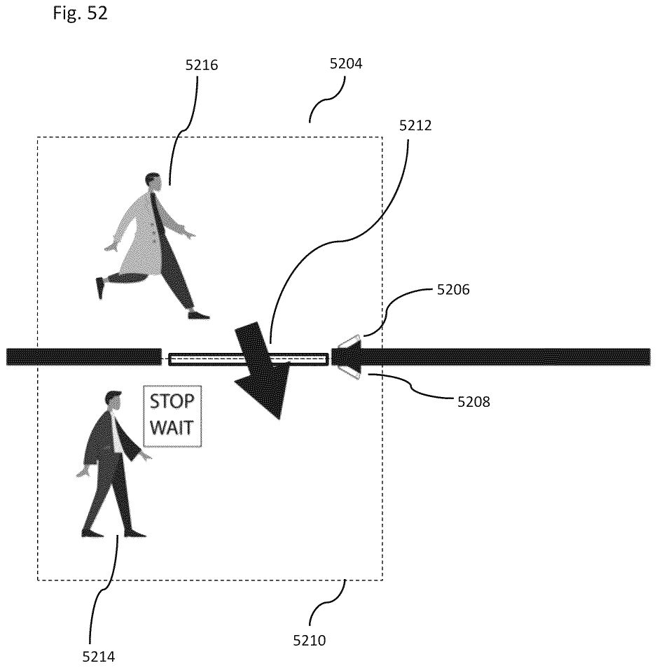

If facial recognition modules are deployed such that one facial recognition module covers the inside of an entry point and the other facial recognition module covers the outside of the same entry point, additional security benefits are possible. Thus, as shown in FIG. 52, at an entry point, area 5204 is controlled with facial recognition module 5206, while facial recognition module 5208 controls area 5210 on the other side of door 5212. Such a system can be configured so that prior to unlocking the door 5212, facial recognition module 5204 queries facial recognition module 5208 to confirm that there is no unauthorized person 5214 in controlled area 5210, and facial recognition module 5208 can query to confirm that no unauthorized person 5216 is in controlled area 5204. In each case, if an unauthorized person is in the opposite controlled area, the system may be configured to block unlocking of door 5212 until the unauthorized person leaves the controlled area.

Such a deployment thus enables a significant additional security enhancement that would be difficult or impossible to accomplish otherwise. Where an entry point is equipped with at least a facial recognition module on each side of the entry point, and those facial recognition modules are connected to the same server, the facial recognition modules can substantially reduce the likelihood of a pernicious “social engineering” hack: a bad actor can often gain entry to a restricted area by walking up to a door at the same time another person is exiting that door. People tend to be polite and allow that person to enter, even holding the door open for him or her. This can allow a hacker or other malicious person into buildings or areas within buildings where they should not be. In cases in which a person who has already been admitted wants to sneak an unauthorized person in, similar risks are apparent.

An entry point with facial recognition modules on both sides can be configured to recognize the situation in which people are approaching from both sides of the entry point, and to lock the door until both persons have been authenticated. If one of the people approaching the door cannot authenticate, and does not withdraw from range of the facial recognition module, the door may remain locked, or a notification may be sent to the appropriate personnel. Preferably, the facial recognition module will display or otherwise convey a message to the first person who authenticates that, because there is a person on the other side of the entry point, the door will remain locked until the other person is authenticated or withdraws.

This approach cannot completely prevent an authorized person from improperly admitting an unauthorized person (by holding the door open to allow the unauthorized person to re-enter the controlled space and the moving through the door). But it does provide deterrence, because it is capable of recording that behavior. Another advantage of such a deployment is that it can permit enhanced tracking of who is inside an access-controlled area (by logging not just entries but also exits).

Facial recognition modules as disclosed herein may also be employed to improve security in deployments that include man traps by enabling 2-factor authentication with a facial recognition module inside the man trap and a conventional badge reader outside the man trap. In such a deployment the badger reader and facial recognition module should be connected (directly or indirectly) to the same server. In an embodiment, when a person seeking entry approaches, they use the badge reader to gain entry to the man trap. If the badge is authenticated, the person is permitted to enter the man trap. Once the person is inside the man trap, the facial recognition module performs facial recognition and compares the captured facial image(s) with the ID associated with the badge number. If the identities match (and the person is authorized to enter), the man trap permits the person to enter the secure area. If not, the person may either be allowed to exit the man trap to the non-secure side, or both doors may be locked so that the person may be detained in the man trap until security personnel arrive.

It should be noted that a man trap can take many physical forms, including full cylinders (sometimes called “circlelocks”), half-cylinders, cubes, etc. Facial recognition modules according to the teaching of this invention may be used with many such man trap form factors.

Traditional badge-based access controls can present challenges for the visually impaired. The location of RFID and magnetic stripe readers may be obvious to sighted users, but visually impaired people may find them difficult or impossible to use.

This drawback can be addressed by including a loudspeaker or other audio signal generator in the badge reader, which can signal its location to a user with a series of audio cues, such as a series of beeps or chirps. If the badge reader includes a means for detecting the proximity of objects to the badge reader, such as an image sensor, the beacon signal could modulate to indicate relative proximity, such as by increasing the frequency or pitch of the chirps as an object (presumably the badge) gets closer to the badge reader. Alternatively, the image sensors in the facial recognition module could be used to interpret the movement of the user and provide audible feedback regarding the proximity of the user to the badge reader.

In the currently preferred embodiment, the facial recognition module will include an accelerometer or other means for detecting both movement of the facial recognition module as well as its physical orientation. Because the currently referred embodiment can be oriented in multiple ways, it would be advantageous to automatically detect orientation, and to adjust certain parameters accordingly, For example, if the facial recognition module is oriented so that the image sensors are on the right side of the facial recognition module (viewed from the outside of the wall to which it is mounted), it can be inferred that the access-controlled entry is to the left of the facial recognition module. Conversely, if the facial recognition module is oriented so that the image sensors are on the left side of the facial recognition module (viewed from the outside of the wall to which it is mounted), it can be inferred that the access-controlled entry is to the right of the facial recognition module.

If the facial recognition module is oriented so that the image sensors are on the bottom of the facial recognition module (viewed from the outside of the wall to which it is mounted), it can be inferred that the access-controlled entry is above the facial recognition module.

One use of that information is automatic orientation of captured images, so that faces are captured and interpreted with eyes above mouths, etc. Another way in which the orientation of the facial recognition module may be used is to infer the location of the entry point relative to the facial recognition module. This may be of importance because when a person moves out of view to one side, that person may no longer present a possible security issue, because they are no longer near the entry point. But if the person moves out of the field of view on the side of the facial recognition module where the entry point is, it may be logical to conclude that the person has moved toward or through the entry point, which may trigger an alert.

An additional benefit of providing a sensor capable of sensing orientation (such as an accelerometer) is that it can simplify both manufacturing and installation of the facial recognition module. If a facial recognition module includes an alphanumeric display, it is obviously important that the display be properly oriented regardless of the physical orientation of the facial recognition module. One method for accomplishing this is to design the display so that it can be physically rotated relative to the rest of the facial recognition module. However, this both adds manufacturing cost and places additional burdens on the installers of the facial recognition modules. Automatic orientation based on detection by an internal sensor may also be used to properly orient that display.

Another method for leveraging a multiple facial recognition module-installation to improve the overall intelligence of the system is to provide logic at the central server to interpret the accelerometer readings from multiple facial recognition modules simultaneously. For example, if a specific local installation includes ten facial recognition modules, and a single accelerometer shows rapid vibration, while the other nine do not, that condition may suggest that the facial recognition module showing vibration is being tampered with, which may trigger a response such as sending an alert, wiping or encrypting the memory of the facial recognition module, etc. If, on the other hand, all ten facial recognition modules detect vibration at the same time, tampering may be ruled out, and a seismic event such as an earthquake may be inferred. It may then be advisable to initiate emergency procedures, such as sounding alarms and/or opening or unlocking doors

In an embodiment, a facial recognition module may include sufficient processing power that it can be used to perform locally a number of functions that may otherwise be performed by a central server or by other unrelated devices. Thus in an additional embodiment, facial recognition modules as disclosed herein may be deployed to act as programmable logic controllers for connected devices such as locks, external cameras, lighting or other devices. Thus for example, when the facial recognition module detects a person approaching an entry point during low-light conditions, the facial recognition module could trigger a connected light or lights to turn on, both to better illuminate the person seeking entry and to discourage other unauthorized persons from trying to enter. Facial recognition modules could also be connected to alarms or sirens that could be triggered under specified conditions, such as when an unauthorized person repeatedly attempts to enter. Facial recognition modules could also trigger additional cameras, such as cameras covering a larger field than those within the facial recognition module, to begin recording under specified conditions.

In an embodiment, facial recognition modules as disclosed herein may also be configured so that additional inputs may be used to affect the decision whether to permit entry at an access point. Such inputs may include signals from emergency panic switches, sensors that detect a person on the other side of the door, or another facial recognition module on the other side of the door sensing that someone is exiting.

In an embodiment, facial recognition modules as disclosed herein may also be configured to output signals to external devices. Such external devices could include other security-related systems such as alarms, lighting systems, or illuminated or digital signage. Facial recognition modules as disclosed herein could send such signals to other systems in the event that an attempted entrance was denied, or when an attempted entry is successful, or when an unidentified (or identified) person is detected in a given area.

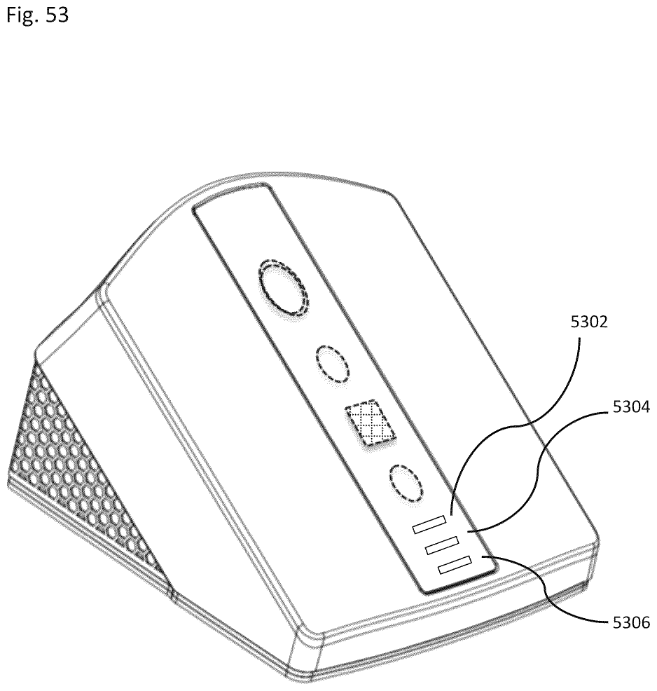

One challenge in providing building security that is both user-friendly and cost-effective is to find ways to communicate to people seeking to use the facial recognition modules easily understood signaling as to the state of the entry process without the complexity and expense of devices such as display screens. Simple colored lights, such as LEDs, may be used to convey the state of facial recognition modules as disclosed herein. In an embodiment, a facial recognition module may be equipped with one (or more) red LEDs, one (or more) blue LEDs, and one (or more) green LEDs, as shown in FIG. 53. Thus for example an embodiment of the facial recognition module as disclosed herein could include a red LED or other light 5302, a blue LED or other light 5304, and a green LED or other light 5306. Alternatively, a single device may be capable of emitting those different colors of visible light, so that only a single device may take the place of the three separate lights. Those LEDs may directly emit light toward the person seeking entry, or may be behind lenses, or may be mounted so that light pipes are used to direct and/or diffuse their output. Such a simple LED array can be used to simply convey the progress of an authentication attempt to a user. For example, the red LED may be illuminated whenever the facial recognition module is powered and ready for a user to attempt entry. When a facial recognition module is paired with a badge reader, the light on the facial recognition module can change from red to blue when a badge number has been successfully read, thereby assuring the user that the first step of the process has been completed. When the facial recognition module (either on its own or in association with a server that compares the badge information with the output of the facial recognition module) confirms that the user is authorized to enter, the light may change to green signaling that the users may proceed to enter. If the authorization attempt fails, the light may return to red to indicate that failure to the user. Other lighting schemes may of course also be employed.

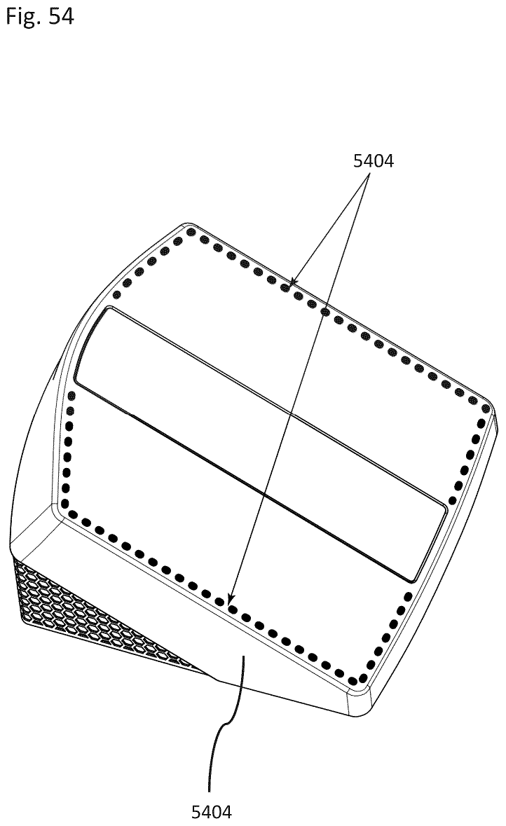

A more extensive array of lights on a facial recognition module as described herein can be employed to convey without words a number of additional concepts and/or instructions to a user. For example, one or more strips or similar arrays of independently addressable LEDs (or LEDs addressable in groups) may be arrayed in a roughly linear fashion on or around the front face of the facial recognition module, as shown in FIG. 54. In the exemplary embodiment shown, LEDs 5402 are arrayed around the entire front face 5404. Such arrays may be used for a variety of functions, and the lights in a given linear array may be all illuminated together, may be sequenced to suggest motion, or may be rapidly turned on and off together. Thus, for example, one or more arrays may “point” toward the camera(s) in the facial recognition module. Sequencing those lights so that they act as “landing lights” or arrows pointing toward the camera(s) can encourage a potential entrant to look toward those cameras in order to assist in the identification process. Similar light patterns can be used to, for example, direct a user toward the badge reader or toward the entry point. LEDs 5402 may all be a single color, or different areas of the array may be different colors, or some or all of the LEDs may be capable of illuminating in more than one color. Alternative non-LED light sources may also be used.

Facial recognition module lighting may also be used to assist in fault diagnostics. For example, flashing one color light may indicate loss of network connectivity; flashing another color may indicate hardware issues, etc.

Facial recognition module lighting may also be used to aid in provisioning-related tasks. When multiple facial recognition modules are to be monitored from a single screen, many images from those facial recognition modules may appear together. Which image corresponds to which physical location may not be obvious to an operator from viewing the images themselves. While ideally the image from each facial recognition module may be descriptively labeled at the time of installations (e.g., “South Parking Structure Side” or “Data Center Man Trap”), installers may have initially used unhelpful names like “Camera 12” or “S/N 07544.” It would be advantageous to provide a means to physically identify the facial recognition module that corresponds to a given screen image.

An exemplary means for accomplishing this is for an operator with access to the server that connects the facial recognition modules to place a specific facial recognition module into an “identification mode.” This could be enabled by, for example, illuminating or blinking one or a series of LEDs on the facial recognition module. Thus if an operator wishes to determine “which facial recognition module corresponds to this image?” the operator can chose the image and instruct the facial recognition module sending it to enter identification mode, which may comprise, for example, flashing a row of white LEDs (or, in the case of multi-color elements, turning those lights white). The operator or another person communicating with the operator can move from facial recognition module to facial recognition module until the flashing facial recognition module is located. The operator can then assign that facial recognition module a more useful description.

A primary function of a facial recognition system is to answer a (seemingly) simple question: “is that you, Carol?” This requires a decision between “yes” and “no.” Any system for making decisions between two alternative states is subject to (at least) two types of errors, commonly known as false positive and false negative results. In the case of diagnosing an illness for example, a false positive is diagnosing a person with an illness when they do not in fact have that illness; a false negative is determining that a person does not have the illness when they actually do. No such decision-making system will be perfect every time; thus such errors are always possible. When designing the decision criteria, there is a trade-off between the two kinds of errors: Very strict criteria for saying a person has the illness will likely result in few false positives but many false negatives; more lax standards will catch more disease, but result in many more false positives.

Similar issues arise when using machine learning to perform facial recognition. No facial recognition system (and no human performing the same task) will be 100% perfect under all circumstances. Identification is probabilistic; the system may misidentify a unknown (or known but unauthorized) person as a known, authorized entrant (a false positive); it may fail to identify an authorized entrant, or identify him/her as an unauthorized entrant (a false negative). Because the ratio between false positive (or False Acceptance Rate, or FAR) and false negative (or False Rejection Rate, or FRR) depends at least in part upon the strictness with which recognition criteria are applied, it is possible to trade off the FAR rate against the FRR rate.

Identification with a facial recognition module depends on many factors, but together those factors may be thought of as the Receiver Operating Characteristic, or ROC. Factors affecting the ROC include environmental conditions (e.g., is it night or day?), the specifics of a given installation (e.g., does the facial recognition module “see” potential entrants at an appropriate angle?). Thus the ROC will be different for different facial recognition module installations (and, potentially, under different environmental conditions—day, night, etc.). In order to establish the ROC for a given installation, data collected from the facial recognition module and, if user identities are held on a separate server, data from that server are required. That data includes the images of users that has been captured under the full range of operating conditions, and the known identities of the users in the captured images. Such images may be collected during a trial or provisioning period in order to train and optimize the system prior to full enablement. Alternatively, multiple facial recognition modules may be grouped and a single ROC may be generated based on the images from all of the facial recognition modules in the group. Grouping facial recognition modules will have the advantage of faster provisioning, because multiple units will reach the required number of images faster. It will also likely provide identifications under a wider variety of conditions, which may increase accuracy.

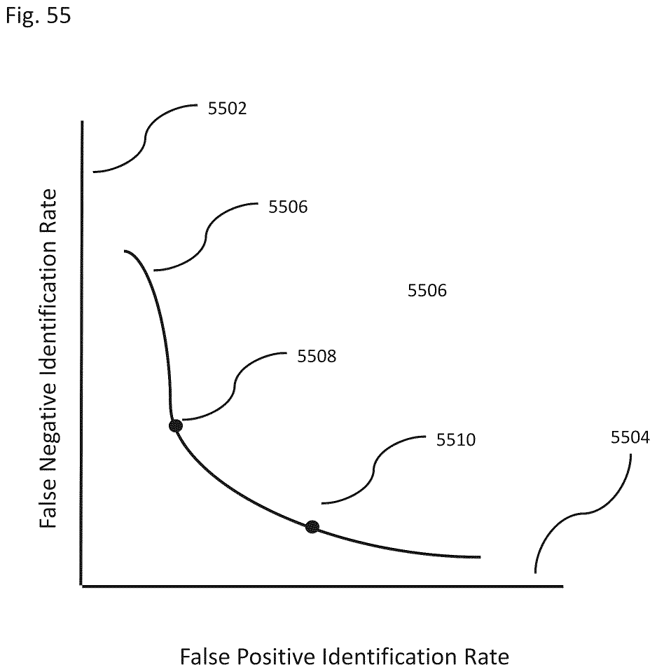

FIG. 55 illustrates a hypothetical ROC curve. Y-axis 5502 shows the rate (often expressed as a percentage) of false negative identifications—that is, the rate at which the facial recognition system fails to identify a properly authorized person. X-axis 5504 shows the rate (often expressed as a percentage) of false positive identifications—that is, the rate at which the system mistakenly authorizes a non-authorized person or misidentifies one authorized person as another. Curve 5506 illustrates that, for a given facial recognition technology, the only way to decrease the rate of false positive identifications is to increase the rate of false negative identifications. Overall improvement (that is, reductions in both kinds of errors) requires improvement in technology.

Because curve 5506 defines a range of possible trade-offs, an operator or other person configuring a given system can decide where on curve 5506 is most appropriate in a given installation. Thus, for example, at an entrance to a large, low-security facility with a lot of traffic, it may be appropriate to select point 5508. Conversely, in a very high-security context, where the cost of a false positive far outweighs the cost of sometimes requiring a potential entrant to repeat the process, point 5510 may be more appropriate. An embodiment of a facial recognition system according to the teachings of this disclosure may permit an operator or other person configuring the system to choose the appropriate point on a given ROC curve.

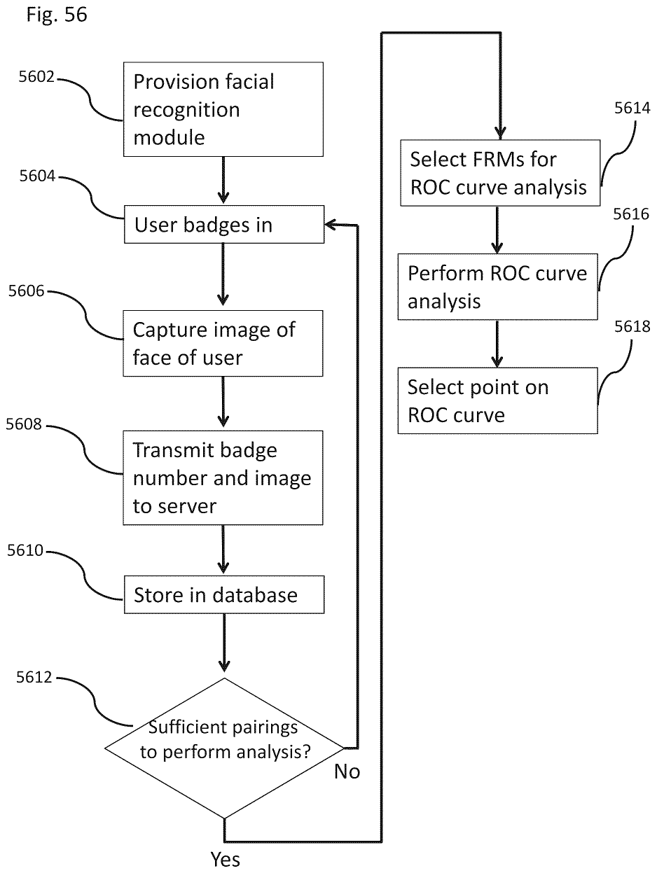

FIG. 56 illustrates the steps in an exemplary process for establishing an ROC curve for a specific installation. In step 5602 a facial recognition module is physically installed and connected at a specific location that is already controlled with a conventional badge reader, and is connected to a back end server. At this stage the facial recognition module is not functioning as a building access control; it is in a learning mode. In step 5604 a user badges into the access point. In step 5606 the facial recognition module captures an image of the user who has badged in. In step 5608 that image, together with the badge number of the user, is forwarded to the server. In step 5610 the server stores the image and the badge number as well as the relationship between them in a database. In step 5612, it is determined whether a sufficient number of badge/face pairings have been completed to perform the ROC analysis. If not, steps 5604 through 5610 are repeated over a period of days or weeks, until a desired number of presumed positive identifications have been recorded. Optionally, in cases where multiple entry points are newly provisioned with facial recognition modules, such pairings from multiple facial recognition modules can be used to increase accuracy and/or speed up the provisioning process.

Once a sufficient number of image-badge pairs have been collected, in step 5614 an administrator selects the facial recognition module or set of facial recognition modules for which an ROC curve is to be generated. In step 5616, the application running on the server generates an ROC curve similar to the one shown in FIG. 55. In step 5618, the administrator selects a place on the curve representing a specific tradeoff between FAR and FRR. In another embodiment, an administrator may select a preferred level of certainty prior to initiating this process.

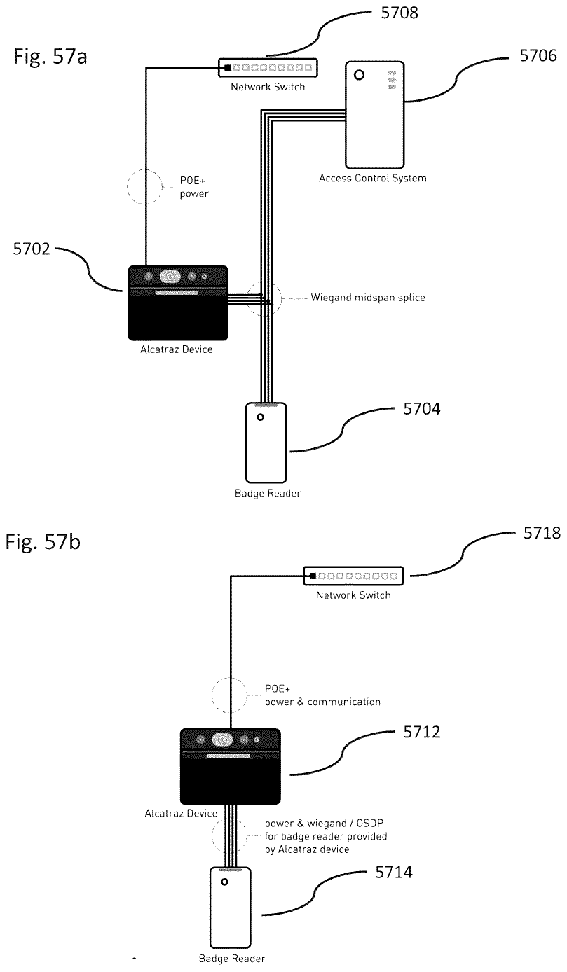

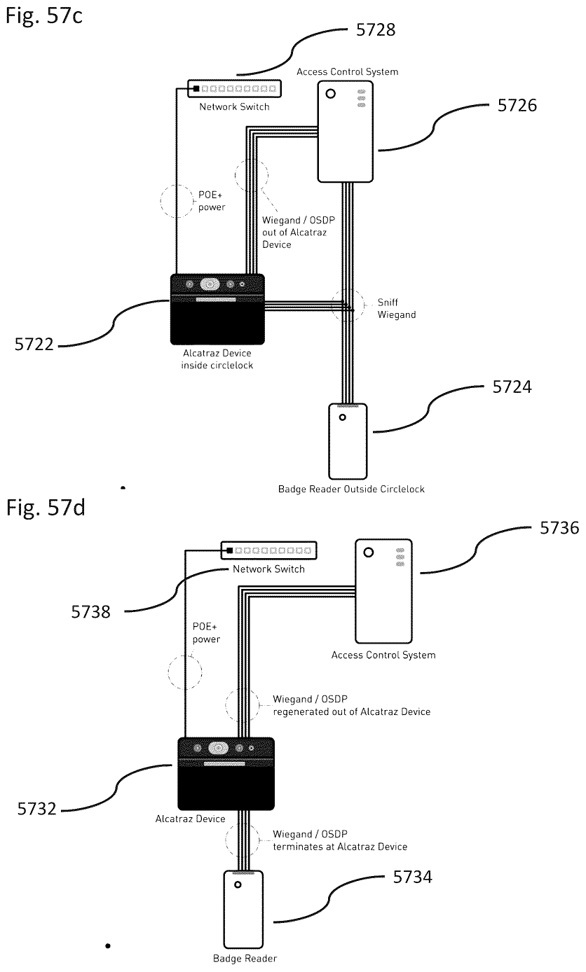

In many cases, facial recognition modules as disclosed herein will be integrated into a legacy building security system, such as one that is wired with lock controls and badge readers connected using a wiring system commonly referred to as a Weigand system. A feature of embodiments of the subject invention is that they can be integrated into such a legacy system in a variety of ways. FIGS. 57a-57d illustrates exemplary methods for connecting facial recognition modules as described herein to existing Weigand wiring.

Typical badge readers are very low-power devices, and are adequately powered by small-gage wires carrying 12 volts DC, as commonly found in so-called Weigand legacy systems. Because a facial recognition module typically includes a powerful processor, memory, LEDs, etc., it may require more power than legacy wiring and power supplies can provide. It may therefore be advantageous to provide more power to the facial recognition module than legacy wiring can deliver.

In the currently preferred embodiments, full operation of the facial recognition module requires more power than is typically available in a Weigand system, which typically provide only 12 volts DC at low amperage. One means for providing the higher voltage/current requirements of the facial recognition modules is to connect the facial recognition modules using the Power over Ethernet (PoE) protocol, which can provide 48 volts DC.

FIG. 57a illustrates an installation in which a facial recognition module according to the teachings of this disclosure 5702 is connected to existing wiring between an existing badge reader 5704 and an access control panel 5706. Such an installation may be accomplished by connecting new wires that are connected at one end to the facial recognition module and at the other end to the existing Weigand-protocol wiring. The continuity of the existing wiring is not disrupted so that the badge reader 5704 continues to communicate directly with the access control panel. In addition, facial recognition module 5702 receives power from PoE network switch 5708. Data may also flow between facial recognition module 5702 and switch 5708.

FIG. 57b illustrates another configuration for installing a facial recognition module 5712 in an existing system in which signals transmitted by a badge reader 5714 are no longer directly transmitted to an access control panel, but are instead intercepted by the facial recognition module, which is in turn connected to and powered by network switch 5718. In some implementations using a facial recognition module as shown in FIG. 57b, no access control panel may be present. Such implementations may be used, for example, in an application not connected to a building security system, such as in a setting in which the facial recognition module is used to count and/or identify people without attempting to limit access. A facial recognition module may also be deployed without connection to an access control module if it is used not to control a specific access point, but as an enrollment station—that is, if it is used to add new users into the system at a location such as a building lobby or a security office. Another context in which a facial recognition module may be deployed without an access control panel is a deployment in a building that is not already equipped with a legacy building security system with existing 12 volt wiring. Such an installation permits the facial recognition module to receive and retransmit badge information that would otherwise be sent directly to the access control panel.

FIG. 57c illustrates an exemplary configuration for installing a facial recognition in a man trap, such as a circlelock. Facial recognition module 5722 may be added to an existing system that includes badge reader 5724, which may be located at the outer perimeter of a mantrap. In such an installation, facial recognition module 5722 continues to receive low-voltage power and communication directly from an access control panel 5726, but also receives higher-voltage power via PoE from network switch 5728. Facial recognition module 5722 receives signals from the existing badge reader 5724 from the existing wiring connecting badge reader 5724, and that wiring remains in place, with the badge reader 5724 still connected directly to access control panel 5726, in addition to being connected to facial recognition module 5722

FIG. 57d illustrates another configuration for installing a facial recognition module 5732 in an existing system in which facial recognition module 5732 is directly connected to both badge reader 5734 and access control panel 5736, but also receives power from an alternate source such as Power over Ethernet. Thus facial recognition module 5732 may be connected to a PoE router or switch 5738, which provides both power and a data connection. In this embodiment, facial recognition module 5732 is placed between badge reader 5734 and access control system 5736, so that no direct connection exists between those two components.

In many legacy installations, it is essential that badge readers and some level of building security continue to operate in the event of a power failure. (Otherwise, a malicious actor could gain entrance simply by cutting power.) This is sometimes achieved by connecting an uninterruptible power supply (UPS) to the access control panel, which in turn provides power to the badge readers and door locks. In a system that adds facial recognition modules, the UPS attached to the access control panel is unlikely to be capable of providing sufficient power for the facial recognition modules to continue to operate in their normal mode. One approach to hardening such a system against power outages would be to provide power to the facial recognition modules over PoE, as described above, and to provide a separate UPS capable of sustaining higher output through the PoE network. However, such systems may not be deployed in all cases, due to the expense of UPSs capable of providing that much power or other reasons. Thus it would be desirable to provide facial recognition modules with a low-power mode that allow them to continue to operate in the event of a power failure using only the back-up power supply intended for the badge readers.

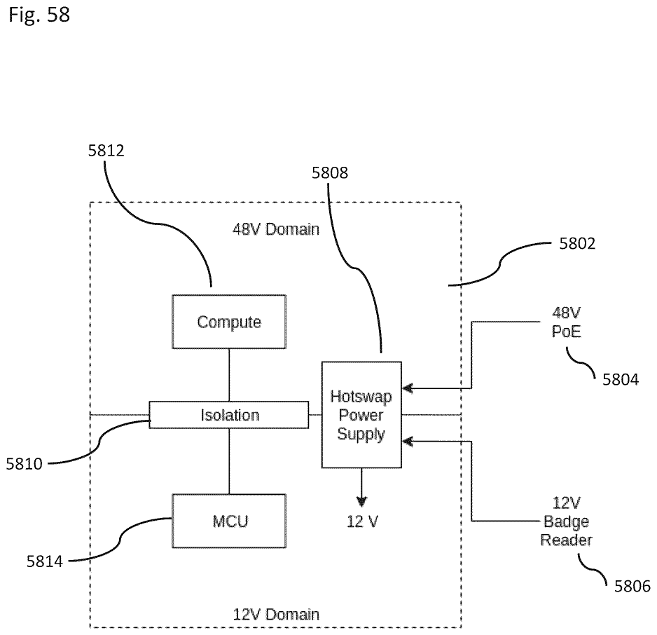

Such a facial recognition module may include two different power inputs: a 48V power input intend to be connected to a power source such as a PoE connection, and a low-voltage power connection as might be provided by existing wiring. A simplified diagram of an embodiment of such a configuration is shown in FIG. 58.

Power module 5802 includes connection for both 48V DC power 5804 and 12v power 5806. Both supplies are connected to circuitry 5808 that is capable of accepting power from both sources and switching back and forth between operating the facial recognition module on the two different voltages. This hotswap power supply can also be configured to supply power to low-power devices connected to the facial recognition module, such as badge readers, electronic locks, etc. Internal isolation circuitry 5810 enables the facial recognition module to disconnect features of the facial recognition module that require higher voltage in the event that only 12V power is available, such as primary microprocessor 5812. Additional functions, such as displays, external LEDs, imaging sensors, IR light sources and other features may be disabled in low power mode. Other internal devices, such as an MCU 5814 intended to interface with external badge readers may continue to receive power and function even after high-voltage power is lost. Alternatively, internal microprocessors (or local power supplies connected to them) may be configured to revert to a low-power mode when the facial recognition module senses that the facial recognition module is operating in low-power mode.

As facial recognition and various forms of Internet-based tracking technologies have grown in prevalence, issues of privacy invasions and non-consensual data collection and monitoring have become widespread. In many applications, it may therefore be important to limit the application of facial recognition and/or storage of information about captured images to people who have explicitly consented to being scanned and evaluated.

Traditional methods of obtaining consent, such as signing paper forms, or filling out online forms in an application or through a web browser, can be effective. However, they may have other disadvantages, such as additional administrative overhead. For employees who may normally be remote workers, for example, it may not be convenient to arrange an onsite visit to obtain written consent as part of an onboarding process.

In the vast majority of potential use cases, a party being asked for consent to be scanned for facial recognition by a specific entity (such as an employer) will already own a device that can be adapted to efficiently provide explicit consent: a smart phone.

It would therefore be advantageous to provide a method for enabling individual opt-in consent to the processing of facial images and information using each such person's smart phone.

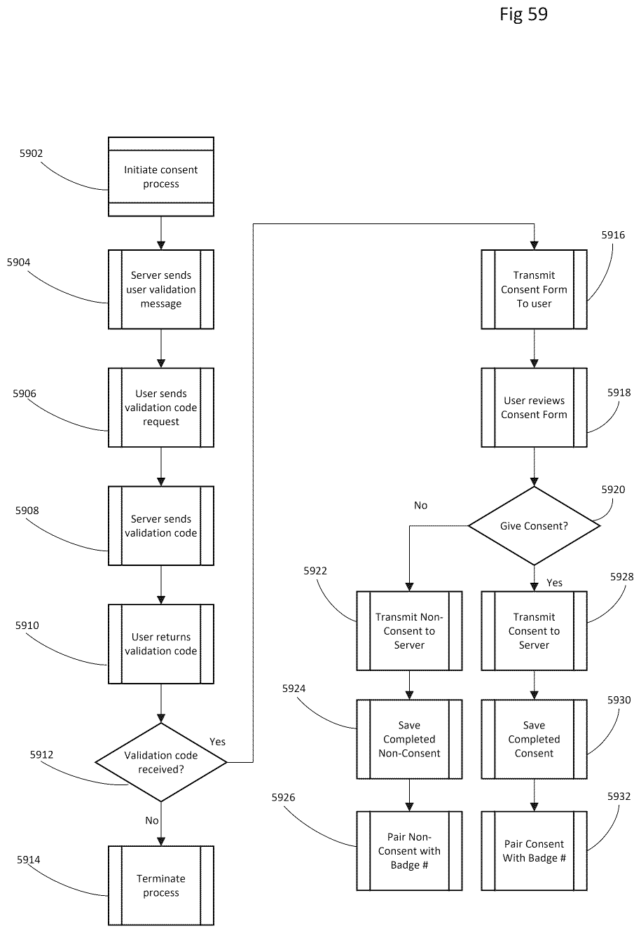

An exemplary embodiment of this aspect of the invention is illustrated in FIG. 59. It may be assumed that a person being asked to consent has previously provided a means for personal contact, such as an email address or the number for a text-capable smart phone, to the organization seeking consent. The process may be initiated 5902 by sending a prompt 5904 to the user's email address or telephone number to click on a link transmitted as part of that message. When the user clicks on the link, a message 5906 may be sent to a server, which may then transmit a code 5908 to the user's device or email address, such as the 6-digit numerical codes commonly used to authenticate users in other contexts. The user may then be prompted to provide that code 5910 back to the server, thereby providing a level of assurance that the person responding is who they say they are.

If the proper validation code is not received 5912 by the server, the process may terminate 5914 (or revert to an earlier stage to allow another attempt). If the proper validation code is received, the server may then provide 5916 to the new (or newly consenting) user an electronic consent form either in a dedicated mobile web application or through a web browser. The consent form may be generated by and/or sent from a server that is separate from the access control system, or one that is connected to it. The user then reviews 5918 the displayed terms governing their consent, and, if the user agrees to the terms, gives consent or 5920. Such consent (or decision to withhold consent) may be evidenced by a variety of means which may include checking a box on screen, “signing” with a finger on the smart phone's touch screen, giving verbal consent that may be captured by the microphone(s) within the smart phone, and or providing video consent by using a rear-facing camera on the smart phone to record the user's consent by gesture and/or speaking the required words. If the user chooses to withhold consent, the user transmits that decision (via WiFi or over a cellular network or other means) 5922 to the server. The server then records 5924 that decision in non-volatile memory, which may be solid state, a spinning drive, or other form of non-volatile storage, and pairs 5926 that decision with other information related to that user, such as a badge number. If the user chooses to grant consent, then the user transmits (via WiFi or over a cellular network or other means) 5928 that decision to the server, and the server records 5930 that decision in non-volatile memory, which may be solid state, a spinning drive, or other form of non-volatile storage, and pairs that choice 5932 with other information related to that user, such as the user's badge number.

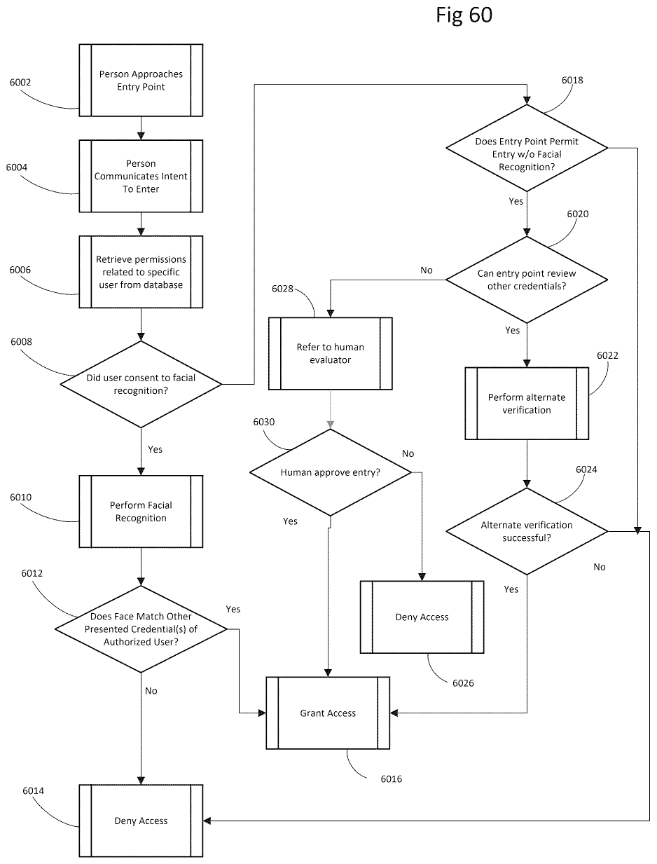

An exemplary process by which the system may selectively perform facial recognition only on consenting individuals is illustrated in FIG. 60. Initially, a person approaches 6002 a secured entry point. Such an entry point may be an external door, a gate or turnstile within a building, or a small contained area, sometimes referred to as a man trap that is protected by a facial recognition module as herein described. Upon such approach, the facial recognition camera may or may not record images, but does not initially perform facial recognition. Next, the person seeking entry may perform a task communicating the intent to enter 6004. That task may consist of presenting a badge to a badge reader, or entering a passcode on a keypad, or may consist of the person initiating a specific gesture (e.g., waving) recognized by facial recognition module as expressing intent to enter, or some other method, or a combination of such methods, such both as presenting a badge and keying in a passcode. User-specific access rules stored on a server or the access control module can then determine the following steps. If the user has presented a badge, for example, the access control point then retrieves 6006 the stored facial recognition permission status for that user and thus determines 6008 how to proceed. If that the user has consented to facial recognition, the facial recognition module then performs 6010 facial recognition on that user. The facial recognition module may then determine 6012 whether the recognized face matches the person associated with the presented badge. If the facial recognition module determines that the badge has been presented by the person to whom the badge was issued, the facial recognition module may confirm the match and either directly grant access 6016, or signal a connected access control system to grant access. If the recognized face does not match the presented badge or card, then the facial recognition module may deny access 6014, or signal a connected access control system to do so.

If the person who has signaled intent to enter has not consented to have facial recognition performed, the facial recognition system may not perform facial recognition on that person. The facial recognition module then determines 6018 whether the user is permitted to enter at that entry point without further verification. If all users (or that specific user) do not have permission to enter at that entry point, then access may be denied 6014. It is then determined whether that entry point has the capability to evaluate other forms of verification 6020. If the entry point has the capability to evaluate a second factor (such as keying in a passcode), then the user may be prompted to provide the alternate verification 6022, such as by entering a unique code into a device such as keypad or touchpad. The facial recognition system then determines 6024 whether the correct validation code or other means of identification has been provided. If the verification provided matches the previously provided verification information (such as a badge), then 6016 access may be granted. If no valid information is provided, then 6026 access may be denied.

If the entry point is not capable of reviewing an alternate form of validation (for example, if the entry point has no keypad or other means of providing an alternate identifier, the admit/deny decision may be referred to a human security operator for review 6030. The human operator may choose to admit 6016 or deny access 6026.

In at least an embodiment, the facial recognition module may send captured facial images to a central server, and said server may process the captured images to determine whether they match the previously stored images of an authorized entrant. In at least an alternate embodiment, these steps may be performed by the facial recognition module itself.

If the security rules for a given facility restrict access to only those who have consented to facial recognition, then access may be denied despite the fact that a user has presented a valid badge. However, there here may be circumstances in which a facility wishes to permit access without facial recognition under certain circumstances or for certain individuals. For instance, a facility may wish to enable new employees a limited number of entries before requiring that the employee consent to facial recognition. In such a case the system can store, on the server or the facial recognition module or both, a database or lookup table that associates such permissions with specific badge numbers.

In a conventional access control system, one or more “edge” devices, such as badge readers and locks and/or turnstiles, are connected to a central server. In such systems, data such as lists of permitted entrants, records of who has sought access and when has been stored in a central location, such as in a computer that retains such information and performs the admit/deny decision making for a potentially large number of access control points.

When facial recognition has been added to legacy systems that employ this kind of architecture, it has been common to retain the such a client-server architecture. That has meant connecting one or more facial authentication devices to the central server. Because facial authentication devices may have adequate computational power and sufficient memory to perform the tasks historically performed by a central server, it may no longer be necessary to provide a standalone server. A central server also presents what may be a single point of failure that could disable the entire system, whereas a system based on more distributed intelligence could be more resilient against such failures. Thus an aspect of the current invention is to enable a peer-to-peer topology, eliminating the need for a central server.

In a peer-to-peer facial recognition installation, each such facial recognition module may include sufficient storage to maintain its own copy of a database of users and corresponding information, such as facial characteristics, badge numbers, levels of permissions, etc. Each such module may also comprise one or more microprocessors capable of input/output operations to access the database, process images of potential entrants captured by the module, etc. Each such module may also comprise networking hardware that permits communication among multiple peer devices.

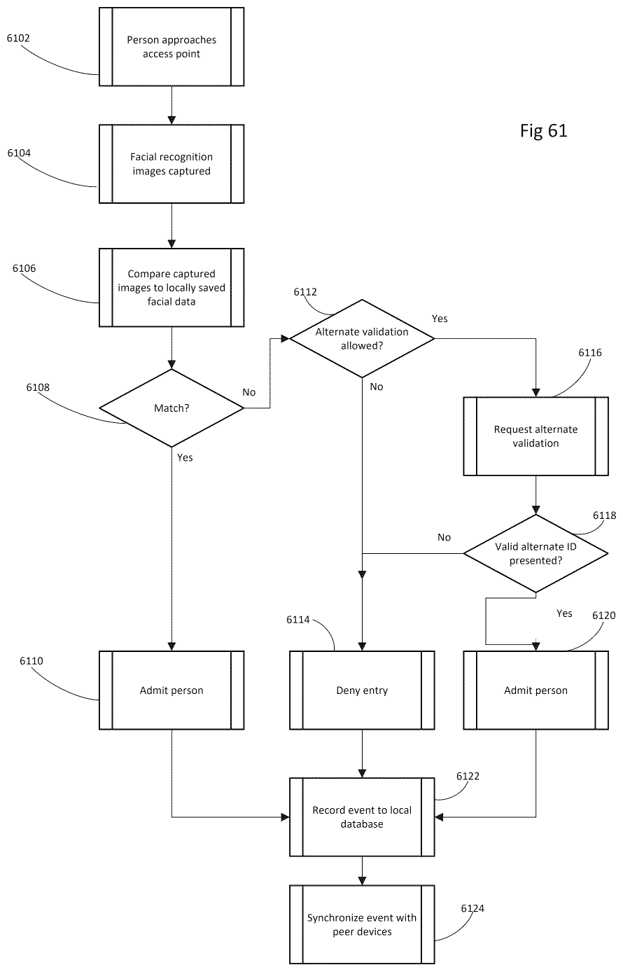

FIG. 61 illustrates an exemplary high-level process for operating such a peer-to-peer system.

Initially a person 6102 approaches a specific controlled access entry point. The system then performs facial recognition 6104 on that person, and compares 6106 the face of the person approaching the entry point to locally saved facial recognition data to determine 6108 if there is a match. If a match to an approved entrant is conformed, then 6110 the person may be permitted to enter. If no match to an authorized account is found, then 6112 it may be determined whether an alternate form of verification, such as presentation of a badge or entry of a unique code may be used. If not, then 6114 entry may be denied. If alternate verification is permitted at that entry point, the facial recognition module may request 6116 alternative verification. If it is determined that the user has presented valid verification 6118, such as a badge or unique code associated with a permitted entrant, then the person may be admitted 6120. If no such valid identifier is presented, then entry may be denied. In each case, upon admission or rejection of entry, the facial recognition module records 6122 the relevant information, which may consist of data including a time stamp, the person admitted/denied entry, the mode or modes of verification applied, etc. Finally, the facial recognition module may provide that data 6124 to one or more additional facial recognition modules at one or more other entry points, so that the databases in those multiple facial recognition modules can remain synchronized.

One of the challenges that may be associated with a peer-to-peer security system is making sure that all of the individual databases stored on multiple nodes are synchronized. If, for example, an unauthorized entrant tries to present a stolen badge at one access point, but fails facial recognition because that person is not the one associated with the presented badge, it will likely be a high priority for the node that rejected the entry attempt to quickly propagate awareness of the improper attempt to all other nodes in order to minimize the chances that the intruder gains entrance at a different node.

Facial recognition provides an improvement in building security relative to older approaches such as badge readers at least in part because it offers a second basis for authenticating aa potential entrant. As in other fields, multi-factor authentication increases security. However, all such systems rely on fallible heuristics (or fallible human judgment). In some applications, it may therefore be advantageous to implement another factor for authenticating users. One such factor is voice recognition. An access control installation may include one or more microphones for recording the voice of a person seeking entry. Such a system may also incorporate one or more loudspeakers. Thus for example in a very high security location, a potential entrant may be required not only to present his or her face for scanning, but to also speak so that his/her voice may be matched to the voice file the system maintains for that user. The addition of another factor can greatly increase the accuracy of a system where, for example, the facial recognition system identifies a given person with relatively low confidence, and the voice recognition system identifies that person with a relatively low confidence. If both voice recognition and facial recognition systems agree on the identification, then two low-confidence identifications may together offer much higher overall confidence.

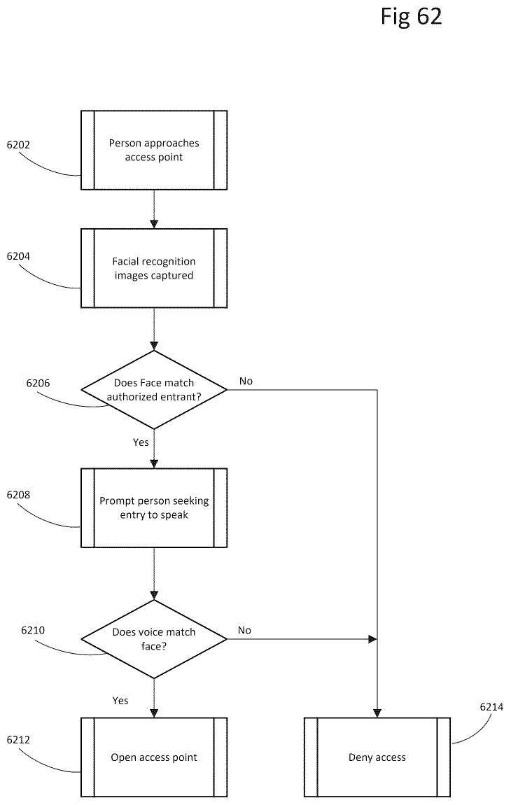

FIG. 62 illustrates an exemplary process that could used according to the present invention to incorporate voice recognition into an access control system that also incorporates facial recognition. When a person approaches 6202 an access control point, the facial recognition module at that access point captures the person's face and performs facial recognition 6204. The facial recognition system then determines 6206 whether the facial image(s) captured match the stored facial information for an authorized entrant at that entry point. If the facial image matches with a permitted entrant, then the facial recognition module may prompt 6208 the user to provide a voice sample. A variety of possible signaling methods may be used, including displaying a prompt on a display integral to or connected to the facial recognition module, or sending a prompt to the user's smart phone. Further, the voice sample may consist of a single permanent phrase shared with all permitted entrants, or may be unique to each individual but intended for repeated use, or may be rotating among a number of possible pass phrases, or a unique pass phrase generated each time a user attempts to pass through the access point.

The facial recognition system then evaluates 6210 the recorded voice sample against one or more previously recorded and analyzed voice samples. If the facial recognition module and/or access control system confirms the user's voice matches the voice associated with the face previously identified, then the facial recognition module/access point may grant entry 6212. If the voice does not match, then access may be denied 6214. Additionally, if a match is not initially made, the user may be prompted to speak the passphrase again.

In at least an embodiment, each module may include a single microphone. In at least an alternate embodiment, each module may include a plurality of microphones, and one or more forms of beam forming technology, as are commonly employed in applications such as headsets, may be employed to improve intelligibility, minimize the effects of noisy environments, etc.

In certain very-high risk environments, limiting access to certain approved individuals may not provide sufficient security. Places where cash or valuables such as jewelry are stored may demand not only that access be limited to certain approved people, but that no one of those approved people be permitted access unless a second permitted person is also allowed to enter at the same time. An aspect of the present invention enables an access control system comprising facial recognition modules to only permit entry when two people authorized to enter a secure area both present required credentials, such as badges plus recognized faces. If only one authorized person presents proper credentials, the access point can deny entry. If one authorized person and one unauthorized person present credentials, then the access point can deny entry.

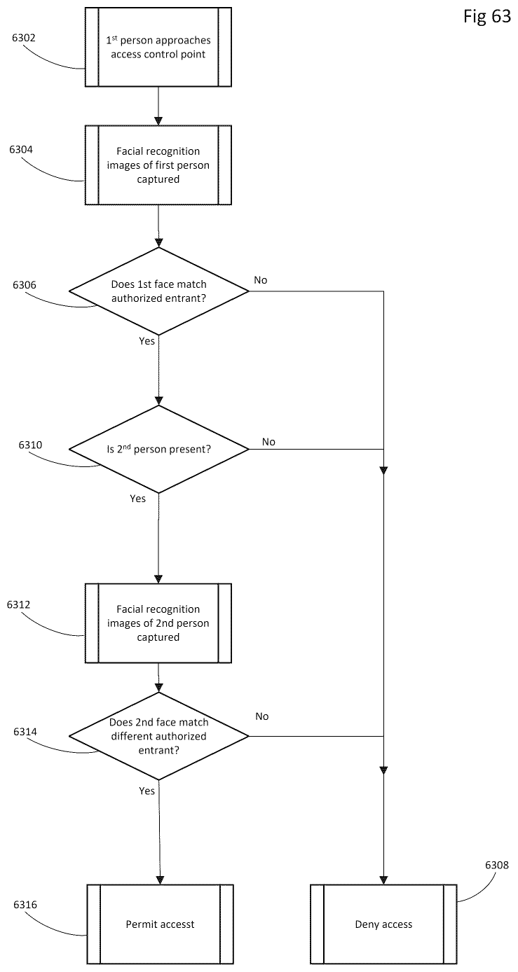

FIG. 63 illustrates an exemplary method for operating an access point to only permit entry if two authorized users present themselves for access together. Initially a first person approaches 6302 the access control point, and the facial recognition module captures one or more images and performs facial recognition 6304. The facial recognition module then determines 6306 whether it can match the facial image with a person who is authorized to enter so long as a second authorized person is also present. If the facial recognition module is unable to match the face of the person seeking entry with an authorized entrant, then entry is denied 6308. If the facial recognition module does match the face of the user with a permitted entrant, then in step 6310 the facial recognition module determines whether a second potential entrant is present. If not, then entry to the first entrant is denied 6308. If a second potential entrant is present then the facial recognition module captures one or more images and performs facial recognition 6312 on the second person. If the facial recognition module is unable to match the face of the second person seeking entry with an authorized entrant, then entry is denied for both persons 6308. If the facial recognition module does match the face of the user with a permitted entrant 6314, then entry of both people is permitted 6316.

In another embodiment, there can be different classifications for different potential entrants, so that, for example, some employees may only be permitted to enter when accompanied by another employee, while other employees such as senior executives may be permitted to enter alone.

While some facilities may prefer to require two factor authentication of entrants to a building or certain areas within a building, it is also true that some potential entrants may have strong objections to being tracked by facial recognition systems. Allowing such persons entrance with just a badge but without a second authentication factor may present unacceptable risks. While a facility or a secure area within a facility may deny entrance to anyone who refuses to consent to facial recognition, some such facilities may prefer to offer an alternative second factor. Thus an aspect of the present invention is to enable alternate second authentication factors. One such alternate authentication factor could be a personal identification number, or PIN. An entrant identifier device that permits a PIN to be used as a second factor may include a keypad accessible to prospective entrants. Such a keypad could be a dedicated physical keypad, such as those often found on devices such bank ATMs. Alternatively, if the entrant identifier device is equipped with a touchscreen, a numeric (or alphanumerical) key pad could be displayed in response to the presentation of the badge that is associated with a user who declines facial authentication. Preferably, a prospective entrant would present a badge to a badge reader. After the access control system validates that the badge is valid, the access point could request that the user enter their PIN. This request may be communicated by a simple light signal, in the case of a device with limited user interface. In a system that includes a more sophisticated display, that request could be communicated by a textual message on the display. On a system that includes audio capabilities, the system could provide an audio prompt, such as a recorded or synthesized voice prompting the user to enter the PIN on the keypad. After the prospective entrant has entered a PIN, the access control system checks the database to confirm that the PIN matches the badge number. If the PIN and badge match, the access control system may allow the person to enter. If they do not match, the access point may remain closed. The access control system may log each such entry. In some embodiments, a display associated with the access control point may visually indicate that the entrant has bypassed facial recognition. In some embodiments, a central monitoring station may similarly provide an alert.

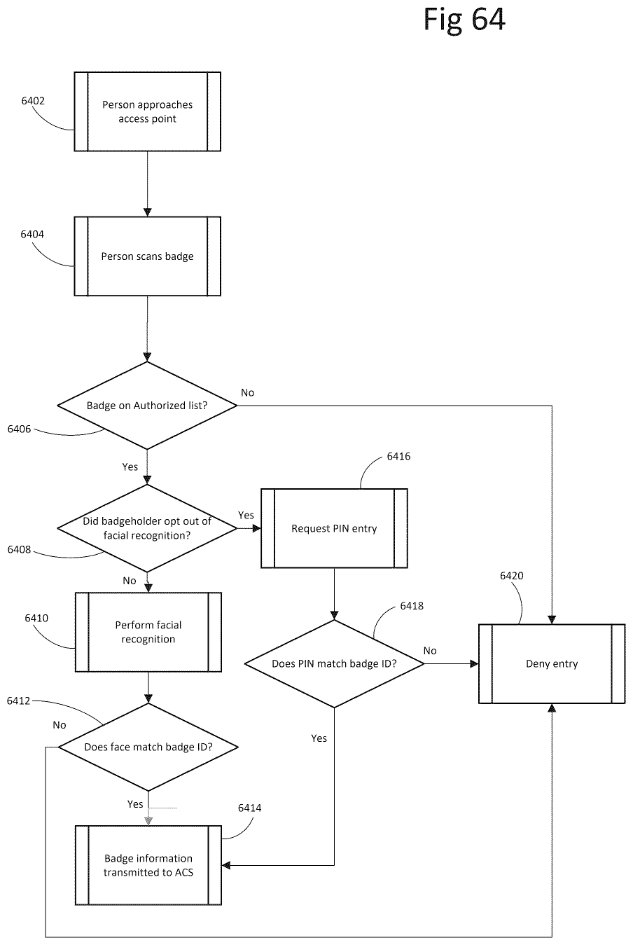

An exemplary process for incorporating facial recognition opt-out into the operation of a multi-factor authentication system that includes facial recognition, a keypad or other device for entering a passcode, and a badge reader is shown in FIG. 64. Initially, a person approaches 6402 the access point. The user then scans their badge in the badger reader 6404. The access control system then determines 6406 whether the presented badge is associated with a person who is authorized to pass through that entry point. If not, then the user is denied entry 6420. If the badge is associated with an authorized entrant, then the facial recognition model and/or access control system determines 6408 whether the user associated with that badge has opted out of facial recognition. If the user has not opted out, then in step 6410 the facial recognition module captures and processes one or more images of the user's face. The facial recognition module then determines 6412 whether the face of the person matches the badge previously presented. If the badge does not match the face, then entry is denied 6420; if they do match, entry may be enabled by confirming identity and relaying that information 6414 to the access control system.

If the user has opted out of facial recognition, the facial recognition module/access control system may request that the user present an alternative form of verification, such as entering a key code into a key pad or touch pad 6416. The facial recognition module/access control system may then evaluate 6418 whether the user has entered the correct key code. If the user has entered the correct key code, then entry may be enabled by confirming identity and relaying that information 6414 to the access control system. If the correct key code is not received, entry may be denied 6420.

Tailgating is a potential vulnerability for automated security systems. It would be advantageous for an access control system including facial recognition to be capable of reducing or eliminating the ability of potential entrants to tailgate.

An aspect of the subject invention provides methods for preventing (or at least minimizing) tailgating. An image recognition module at an access control point may have a field of view sufficient to detect the presence of people within the area around the access point. For example, it may be desirable to design and install such a module so that any person outside the access point and with a specified distance—for example, 20 feet—from the access point. When only one person is within that range, and that person is recognized as an authorized person, the access point may be opened/unlocked. If, however, a second person is detected within a specified distance, the access point may be instructed not to permit either person entry. In some embodiments, entry may be permitted for both persons if both are recognized as authorized persons. In other embodiments, the access point may remain locked unless the second person moves a sufficient distance from the entry point. In some embodiments, for example for access control systems that include a display, the access control point may display a message instructing the person or persons seeking entry what is required to permit either or both people to enter. In some embodiments, such as those that comprise a loudspeaker, the access control point may audibly communicate that the access point will not open unless the second person moves out of range.

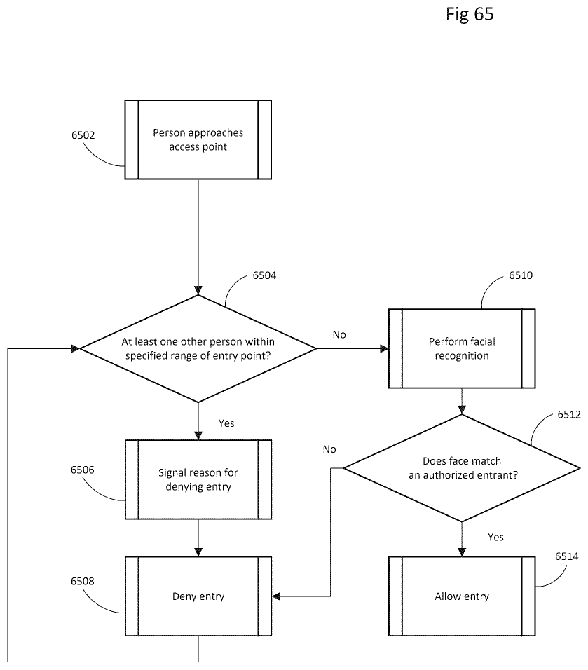

FIG. 65 illustrates an exemplary process for using a facial recognition system to prevent tailgating. In step 6502 one or more people approach an access point controlled by a system that provides facial recognition. In step 6504 the facial recognition system determines whether more than one person is within a specified range of the access point. If the facial recognition system determines that more than one person is within the specified distance from the access point, then in step 6506, the access control system and/or facial recognition system may signal to the persons outside the access point that access to all of them is being denied 6508. In the simplest case, such a signal could be a colored light, or an audible alarm tone. In cases in which the facial recognition module includes or is paired with a display, the signal could be a text message to the effect that the access point will not unlock until only one person is with range of the entry point. Alternatively, a facial recognition module that includes or is connected to a loudspeaker could deliver a similar message via audio. The facial recognition module may then re-evaluate 6504 whether subsequent to delivering that message, there is now only one person within the specified range. If more than one person remains within the specified range, notice of denial of entry 6506 may again be given, and entry again denied 6508. When the facial recognition has determined that there is only one person within the specified range of the access point, then in step 6510 the facial recognition system performs facial recognition on that one person. If that person is recognized 6512 as an authorized entrant at that entry point, then in step 6514, that person is permitted to enter. If that person is not so authorized, then entry is denied 6508.

In some embodiments, if an unauthorized person stays close enough to the entry point that entry is denied to all users as a result, an alarm may be triggered that may alert security personnel to the issue.

In an embodiment in which facial recognition operates on an opt-in basis, it may be problematic for facial recognition modules to automatically perform facial recognition on any person who enters the field of vision of a facial recognition module. One aspect of the instant invention is to use a gesture-based opt-in process before performing facial recognition. For example, when a person enters the field of view of the facial recognition module, the module may be configured to track the movement of the person, but not to automatically perform image recognition until the person performs a specified physical gesture, such as waving a hand in a specific way. After the facial recognition module detects the specified gesture, the facial recognition function may be enabled. In some embodiments, the facial recognition module may be configured to signal to a person seeking entry that it has detected that person's presence, and cue the person to perform the specified gesture.

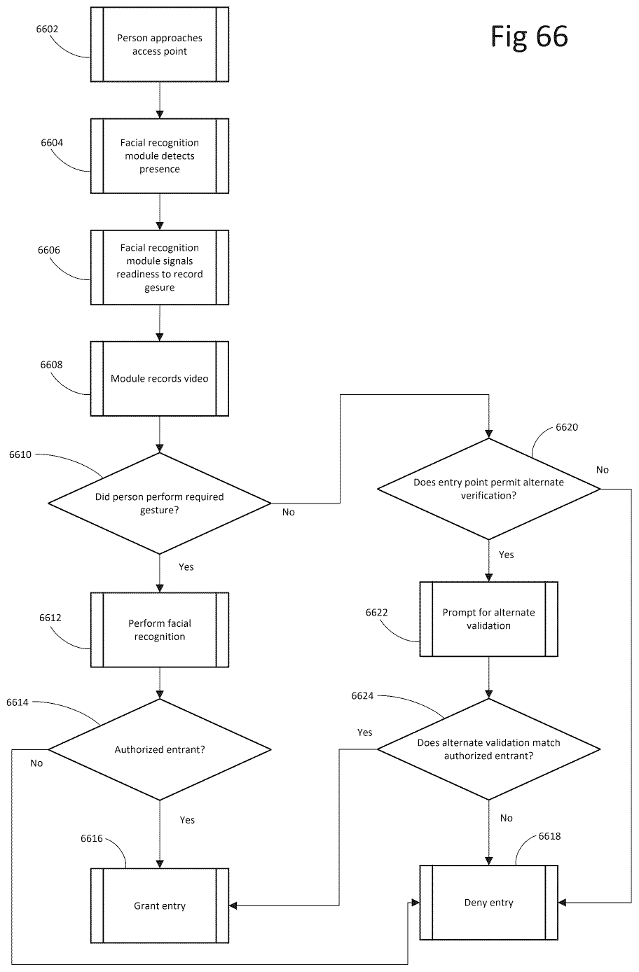

FIG. 66 illustrates an exemplary process for implementing a wave-to-consent process in a facial recognition system. After a person approaches 6602 an entry point controlled by a facial recognition module, the facial recognition module detects 6604 that a person has come within a specified distance of the module. The module may then signal 6606 the person to wave or perform specific gesture to indicate consent to have facial recognition performed. Such a signal may be as simple as illumination of a light, or may be more sophisticated, such as a display providing written instructions, and/or playing a video of a person performing the required gesture, or an audible prompt. The facial recognition module then records 6608 the person (without yet performing facial recognition) and then evaluates 6610 whether the person has performed the required physical gesture. If the person is determined to have performed the requisite gesture, then the facial recognition module may proceed to perform facial recognition 6612 on that person. If the person is determined 6614 to be a permitted entrant at that access point, then they may be permitted to enter 6616. If the person is not authorized to enter at that access point, entry may be denied 6618.

If after being prompted to perform the consent gesture, the facial recognition module determines that the requisite gesture was not performed, then the facial recognition module will not perform facial recognition on that person, but will determine 6620 whether one or more alternate methods for verification are permitted for entry at that entry point. If alternate verification methods are not permitted at that entry point, entry maybe denied 6618. If an alternate form of verification (such as entry of key code and/or a badge) is permitted, then the facial recognition module may prompt the user to provide the alternative form(s) of verification. The facial recognition module then evaluates 6624 the alternate identifier(s) provided by the user. If the alternate verification provided matches the records for an authorized entrant, then access may be granted 6616. If not, access may be denied 6618.

In some embodiments, an access control point may include a keypad or touchpad. The facial recognition module may be configured not to perform facial recognition until after a user has entered a PIN. If the user's PIN is associated with a user who has consented to facial recognition, the facial recognition module may proceed to perform facial recognition on the person. If that person has not consented to facial recognition, that person may be permitted entry without facial recognition having been performed.

For access control systems that include the ability to capture and process audio, additional techniques for verifying identity may be employed. Those techniques may include a variety of methods of using a potential entrant's voice.

In one embodiment, an access control point that comprises one or more microphones may be used to capture the voice of potential entrants. In one such embodiment, the access control system may include a display such as an LCD or OLED panel. The display may be capable of only simple alphanumeric information, or may be capable of displaying more complex information. In an exemplary embodiment that requires 3-factor authentication, when a potential entrant approaches the access point, the person may first present a card to a card reader. Upon validation of the badge, the user may next be prompted to look at the camera to permit facial recognition. (Alternatively, facial recognition could precede presentation of the badge.) Upon confirmation that the face matches the badge, the user can be prompted to speak for purposes of voice recognition. While voice recognition is possible using unscripted voice capture, the speed and accuracy of voice recognition in a variety of potentially adverse conditions, such as background noise, cross talk, etc. can be enhanced if the voice sample involves a specific string of sounds specified by and known to the voice recognition system. How the user is prompted to speak the required words or letters or numbers can vary depending on the capabilities of the specific system and the level of security required. In one embodiment, the display of the access control point can display a series of letters, number or words for the potential entrant to speak into the microphone. If an additional layer of security is desired, the prompt and desired speech sample may be transmitted to the user's smart phone via text or email, assuming that at least one of these identifiers is known to and associated with the user in the access control system. After the user receives and retrieves the prompt, the user may then speak that prompt into the microphone or microphones. The access control system then compares the voice sample on file that is associated with the badge and/or face that have been previously submitted to and stored on the access control system.

In at least an embodiment, voice samples will not be stored as analog or even digital recordings of speech, but as mathematical representations of key aspects of that speech, in much the same way that facial recognition systems as disclosed herein store mathematical representation of a person's facial features. If the voice, face and badge are determined to match those of an authorized entrant, the system can allow entrance. If one or more inputs does not meet the criteria for entrance, the system may deny entrance, or could refer the question to a human security monitor for further evaluation.

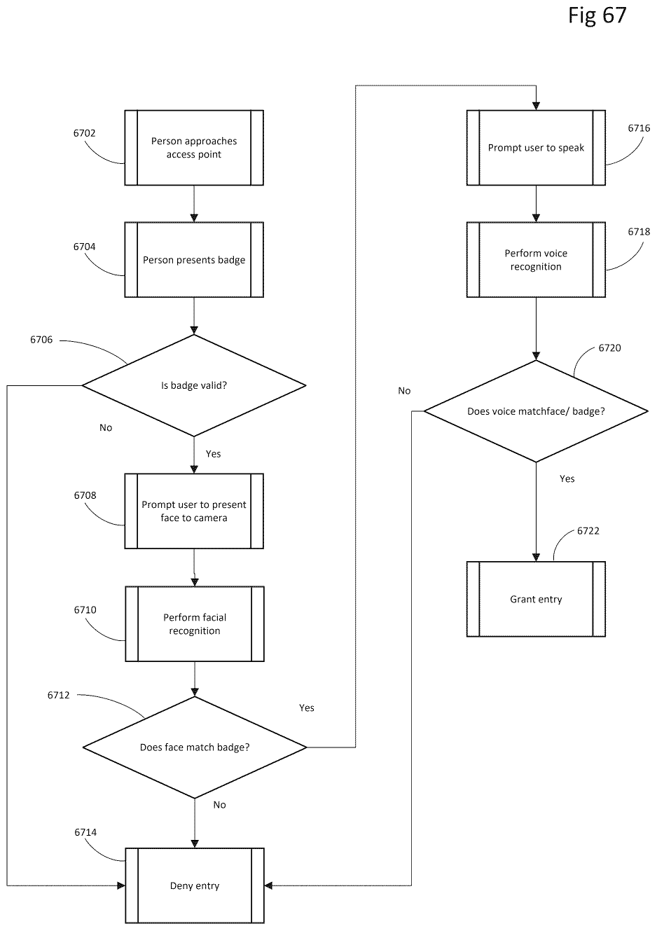

An exemplary high-level illustration of a process for incorporating voice recognition into a three-factor access control system is illustrated in FIG. 67. Initially a person approaches 6702 an access control point. In at least an embodiment, the verification process begins when the person presents 6704 their badge to a badge reader. The access control system then determines 6706 whether the badge is associated with a person authorized to enter at that access point. If that badge is not associated with a person authorized to enter at that access point, then entry is denied 6714. If the badge is associated with a person authorized to enter at that access point, then the user may be prompted 6708 to look at the camera associated with the facial recognition module or access control system at that entry point. The facial recognition system then captures one or more images of the person and performs facial recognition 6710. The facial recognition system then determines 6712 whether the face of the person seeking entry matches the stored information about face of the person associated with the previously presented badge. If the face of the person at the entry point does not match, the stored information about face of the person associated with the previously presented badge, then entry is denied 6714. If the face does match, then the access control system or facial recognition module may prompt 6716 the user to speak while in proximity to a microphone associated with the facial recognition module and/or access control system. The prompt may consist of a simple light signal illuminating, a beep or buzz from a basic noise emitter, or may be a richer signal, such as text on a display, or an audio prompt such as “please speak your passphrase into the microphone.” The passphrase may be standardized for all users at all access points, or may be specific but static for each user, or may be unique for each user and each entry attempt. The facial recognition module or access control system may then perform voice recognition 6718 on the voice sample presented by the potential entrant. The facial recognition module and/or access control system may then determine 6720 whether the analyzed voice sample matches a voice sample for that user previously stored in the facial recognition/access control system for that user as previously identified by facial recognition. If the voice and face are determined to match, then the person may be granted entry 6722. If they do not match, then the user may be denied entry 6714. Alternatively, the user may again be prompted to provide the proper voice sample again.

In a system that performs voice recognition, a preferred embodiment will include the recording, processing and storage of voice samples (or processed “voiceprints” from which identifying characteristics have been extracted) from approved entrants who are to be admitted when at least one basis for granting entrance is a voice match. An exemplary process for performing this function may involve giving such individuals a script to read into a microphone. In an exemplary embodiment, the script to be recorded varies for each enrollee, thereby providing another level of security against compromise. That microphone may be directly connected to an aspect of the access control system, or may involve the use of a recording device owned or otherwise used by the individual seeking access, such as a smart phone. In such an exemplary embodiment, a user could record him or herself reading the script and then upload the recorded file to a server, which could in turn provide the file to the access control system. In at least an embodiment, the recorded sample could in effect provide a superset of sounds from which a small subset could be selected each time the user subsequently approaches an access point that requires voice matching. In another embodiment, each individual user could have an individualized passphrase, so that access to one authorized entrant's passphrase would not be useful for any other potential entrant.

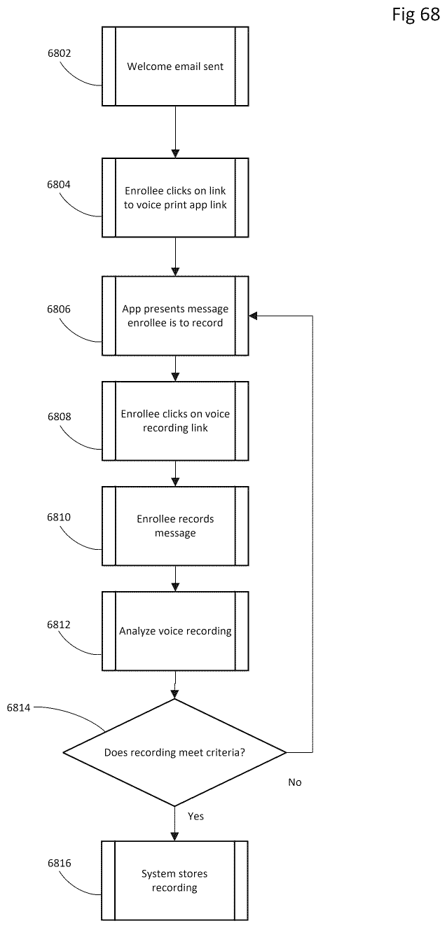

A flowchart illustrating an exemplary process for setting up a user with voice recognition is provided in FIG. 68.

A welcoming message 6802 may be transmitted to a user from whom a new voiceprint is to be obtained, such as by email or other form of electronic communication. The electronic message may contain a hyperlink or other actionable link. The user may then click on or otherwise follow 6804 the link and be taken to a web-based application to be used for providing a voice sample. The user may then be presented 6806 with a specific script to be recorded. The script may be common to all users of a given system, or may be individualized on a per-user basis. In at least an embodiment, the voice printing process will be performed by the user on a device such as a smart phone, which includes one or more microphones and the capability to record audio. The user then activates the recording function on the device 6808 and records 6810 the script. In some circumstances on some devices, they user may be required to first give permission to the application to access the device's microphone. The recording may then be analyzed 6812 to confirm criteria such as whether the recording is sufficiently clear to permit a useful voice print to be obtained, and whether the user spoke the proper script. This analysis may be performed locally on the user's smart phone, remotely on a server, or some combination of both. The system then determines 6814 whether the criteria for a proper recording have been met. If one or more such criteria are not met, then the application may prompt the user to again record the script 6806. If the recording does meet the necessary criteria, then the system stores 6816 the voice print (and/or the abstracted characteristic data extracted from it) and associates that voice print with the user who provided it.

In at least an alternate embodiment, a user's voice recording may be obtained by requiring a user to appear at a physical location, controlled by the operator of the access control system, the facility, or by a third party, where both a voice recording and photographic and/or video images may be obtained.

It should also be noted that voice prints may be used as an additional layer of security when combined with other factors such as badges and facial recognition, or may be substituted for one or more such factors.

While requiring a voice match may provide an enhanced level of security relative to other approaches, that enhancement comes at a cost: it requires additional steps when onboarding each user, and it increases both the computer processing required each time a person seeks entry and makes each admit/deny decision process more time-consuming, thereby increasing friction. It may therefore be the case that full voice recognition may be reserved for the highest security applications.

An alternative approach to using human speech for authentication may be to perform speech recognition (that is, the analysis and recognition of what was said, rather than voiceprinting who said it). This approach obviates the need for pre-recording and storing each user's voice, and may be computationally less demanding, which may permit lower cost deployments. Instead of comparing voice prints, the system could provide users with alphanumeric “keys” which the user would recite out loud at the entry point. One method of providing such keys, which provides enhanced security, is to employ an authenticator application on the user's smart phone. Such applications typically provide on screen a series of time-limited strings of alphanumeric characters. Such applications may be in communication with a back-end server, which may use an algorithm to generate the series of codes. The back-end server may also communicate with the entry point in order to confirm that a correct key has been spoken by the person seeking entry. That communication may be in the form of a push notification from the back-end server to the access control system, or may be in the form of a query from the access control system to the back-end server, or some other suitable method.

The speech recognition process itself is now well understood. It may involve analysis of spectrograms of segments of recorded speech using Fourier transforms and application of natural language processing, as are now common in the art. The process may also include processing to filter out ambient noise and other techniques for enhancing the voice signal.

In an exemplary embodiment of such a three-factor system comprising speech recognition, a potential entrant would approach an entry point. While approaching, the person could open the authenticator application on their phone. The application could then retrieve a valid alphanumeric code from the back-end authenticator server, such as “7645B.” Upon arriving at the badge reader at the entry point, the user presents his or her badge. At roughly the same time, the access control point captures images of the person and performs facial recognition. Assuming that the badge and face match each other and a permitted entrant, the access control point may then prompt the person to speak the alphanumeric code provided to the user by the authenticator application. The access control system then performs speech recognition on the recording received by the microphone located on or otherwise connected to the system. If the system is unable to parse the recording, or if the recognized character string does not match the correct code, the access control point may prompt the user to try again. Trying again may consist of repeating the same string, or a new string if the original authenticator string has expired. Upon verification that the user has spoken the correct key (and thus successfully completing all three verification steps), the access control system can initiate the process of admitting the person to the access-controlled area.

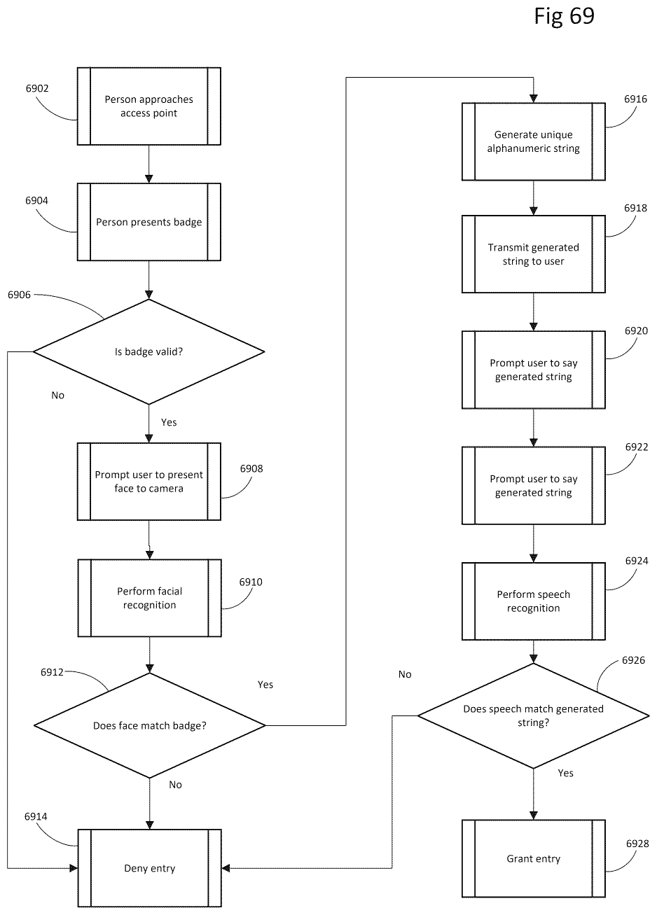

An exemplary process for multi-factor authentication including speech verification is illustrated in FIG. 69. Initially a person approaches 6902 an access control point. The person initiates the verification process by presenting 6904 their badge to a badge reader at that access point. The access control system then determines 6906 whether the badge presented is valid for use at that entry point. If not, entry may be denied 6914. If it is valid, then the user may be prompted 6908 to present their face to the facial recognition module so that facial recognition may be performed. The facial recognition module then captures one or more images and performs facial recognition on them 6910. The facial recognition module then determines 6912 whether the captured face matches the face or facial characteristics stored as corresponding to the presented badge. If they do not match, entry may be denied. If they do match, the system may generate 6916 a pass phrase in the form of an alphanumeric string to be spoken by the user in order to perform speech recognition. The string may be a series of letters and/or numbers, or may be a phrase or sentence or series of random words or phrases. The pass phrase may then be transmitted 6918 to the user. In at least an embodiment, the pass phrase may be sent to a smart phone or other electronic device associated with the user as previously identified. The user may then be prompted 6920 to speak out loud the pass phrase. The prompt may be in the form of a message on the user's smart phone, or a message shown on a screen associated with the facial recognition module, or some other method. The user then recites 6922 the passphrase, which is captured by the access control system and/or the facial recognition module. The personal electronic device/smart phone, the access control system and/or the facial recognition module then perform speech recognition 6924. The access control system or the facial recognition module then determines 6926 whether the person recited the correct pass phrase. If not, access is denied 6914. If the recited pass phrase matches the previously identified face and badge, then entry may be granted 6928.

In another embodiment, the pass phrase may be generated by a third-party authentication application.

In addition to providing another layer of security, a system that includes speech recognition may also provide a faster way of un-authorizing a user. In an access control system with decentralized admit/deny decision making, it may take some time for a change in permitted access (e.g., immediately after terminating an employee). This could happen if, for example, a specific access point is unable to communicate with other nodes or a central server for any length of time. In such a context, access could be denied at one entry point but permitted at another. In a system that requires that users speak changing alphanumeric keys, access at all entry points can be simultaneously denied at all access points simply by locking a no-longer-authorized entrant from the authenticator application. Because the authenticator code is required for entrance in these embodiments, access can be blocked even if one or more individual access points fail to receive the revocation of permission.

It should be noted that the multiple factors described herein may be undertaken in various steps and in different sequences. For example, a two-factor system using voice recognition and facial recognition without badge readers. And in such a system voice recognition could precede or follow facial recognition.

The foregoing figure assumes that the person seeking entry has already been provisioned with the authenticator application and an account with the access control system. An exemplary process for provisioning a user with access to an authenticator application connected to an access control system is described in FIG. 68 above.

While particular embodiments of the present invention have been shown and described, it is apparent that changes and modifications may be made without departing from the invention in its broader aspects and, therefore, the invention may carried out in other ways without departing from the true spirit and scope. These and other equivalents are intended to be covered by the following claims.

What is claimed is:

1. A system for permitting potential entrants into at least a building or other physical space at a controlled access point that comprises a facial recognition module to permit or reject use of facial recognition on a user, the system comprising:
a facial recognition module, said facial recognition module comprising at least a visible light sensor, at least an infrared sensor, and an infrared emitter and at least a microprocessor;
an enclosure of the facial recognition module comprises at least a front face with the visible light sensor, the infrared sensor, and the infrared emitter mounted proximately to the front face such that the visible light sensor and the infrared sensor are capable of recording images from an area beyond the front face, and the infrared emitter is capable of projecting infrared light to the area beyond the front face;
at least a database of permitted entrants into at least said building or other physical space, the database comprising one or more records regarding each permitted entrant, wherein the database is stored on at least a server;
an entrant identifier device including at least one of the group consisting of a badge reader, one or more microphones, a key pad, or a touchpad;
an alphanumeric code that is transmitted to a digital device controlled by a potential enrollee, wherein the alphanumeric code is entered into the entrant identifier device;
a digital form that is transmitted to the digital device, the digital form configured to permit a potential enrollee to permit or deny permission to perform facial recognition on the potential enrollee; and
the potential enrollee choosing to either allow facial recognition to be performed on the potential enrollee or to deny permission for facial recognition to be performed on the potential enrollee.

2. The system as in claim 1 in which the visible light sensor is a plurality of visible light sensors.

3. The system as in claim 1 in which the records regarding at least some of the permitted entrants each comprise at least a mathematical representation of features of faces of at least some of said permitted entrants.

4. The system as in claim 1 in which the entrant identifier device for determining an identity of a potential entrant is a badge reader connected to the facial recognition module by a plurality of wires.

5. The system as in claim 1 in which the entrant identifier device is a plurality of microphones.

6. The system as in claim 1 in which the entrant identifier device is a touchpad.

7. The system as in claim 1 in which an enrollment process comprises transmitting information from the server to a mobile device associated with a potential entrant.

8. The system as in claim 1 in which an enrollment process comprises transmitting information from the facial recognition module to a mobile device associated with a potential entrant.

9. The system as in claim 1 in which verification of an identity of an enrollee who has denied permission for facial recognition to be performed on said enrollee requires both that the enrollee enter an alphanumeric code into keypad or touchpad and that the enrollee present a badge to a badge reader.

10. The system as in claim 1 in which verification of an identity of an enrollee who has denied permission for facial recognition to be performed on said enrollee requires both that the enrollee speak an alphanumeric code so that it is detected by the one or more microphones and that the enrollee present a badge to a badge reader.

11. A method for controlling access to a building or other area, said method comprising:
a potential entrant to a building or other area approaching a controlled entry point of said building or area, where the controlled entry point comprises at least a facial recognition module;
prompting the potential entrant to perform a specific physical gesture, such as waving a hand;
determining whether the potential entrant has performed the specific physical gesture;
performing facial recognition on the potential entrant if the potential entrant has performed the specific physical gesture; and p1 not performing facial recognition if the potential entrant if the potential entrant has not performed the specific physical gesture.

12. The method as in claim 11 wherein the controlled entry point comprises a badge reader, and if a potential entrant does not perform a required specific physical gesture, entry is denied unless the potential entrant scans a badge comprising a unique identifier into the badge reader.

13. The method as in claim 11 wherein the controlled entry point comprises at least a microphone and a badge reader, and if a potential entrant does not perform a required specific physical gesture, entry is denied unless the potential entrant both scans a badge comprising a unique identifier in the badge reader and speaks a required phrase such that it is received by one or more microphones.

14. The method as in claim 11 wherein the controlled entry point comprises at least a microphone, and if a potential entrant does not perform a required specific physical gesture, entry is denied unless the potential entrant speaks a required phrase such that it is received by one or more microphones.

15. The method as in claim 11 wherein the facial recognition module at the controlled entry point comprises a plurality of microphones.

16. The method as in claim 11 wherein if a potential entrant does perform a required specific physical gesture, facial recognition is performed, and if the potential entrant is recognized as a permitted entrant, entry of the potential entrant is permitted without requiring the potential entrant to scan a badge.

17. The method as in claim 11 wherein if a potential entrant does perform a required specific physical gesture, facial recognition is performed, and if the potential entrant is recognized as a permitted entrant, entry of the potential entrant is permitted without requiring the potential entrant to provide an additional form of identification.

18. The method as in claim 11 wherein the facial recognition module comprises a plurality of visible light sensors.

19. The method as in claim 11 wherein if a potential entrant does not perform a required specific physical gesture, access is denied unless the potential entrant enters a specific alphanumeric code into a keypad or a touchpad.

20. The method as in claim 11 wherein the facial recognition module comprises at least an infrared light sensor.
